(19) United States
(12) Patent Application Publication
(10) Pub. No.: US 2007/0009818 A1
(43) Pub. Date: Jan. 11, 2007

(54) Electrophotographic photoreceptor and method of preparing the photoreceptor, and image forming method, image forming apparatus and process cartridge therefor using the photoreceptor

(76) Inventors: Yoshiki Yanagawa, Numazu-shi (JP); Yoshiaki Kawasaki, Susono-shi (JP); Tetsuro Suzuki, Fuji-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/480,517

(22) Filed: Jul. 5, 2006

(30) Foreign Application Priority Data
Jul. 14, 2005 (JP) 2005-205998
Jul. 6, 2005 (JP) 2005-198071
Jul. 7, 2005 (JP) 2005-198531

(51) Int. Cl. G03G 5/047

(52) U.S. Cl. 430/58.05; 430/111.4; 430/79; 430/78; 430/73; 430/133; 430/126; 430/58.4; 430/58.7; 430/58.55

(57) ABSTRACT

An electrophotographic photoreceptor, including at lest an electroconductive substrate and a photosensitive layer including at least a tri- or more functional radical polymerizing monomer having no charge transport structure and a monofunctional radical polymerizing compound having a charge transport structure, wherein the photosensitive layer includes radical polymerizing functional groups in an amount of from 2.55×10²¹ to 7.50×10²¹ in 1 g of solid contents thereof, and has a peel strength not less than 0.1 N/mm when measured by the SAICAS method.

### BACKGROUND OF THE INVENTION

1. Field of the Invention

The present invention relates to an electrophotographic photoreceptor and a method of preparing the photoreceptor, and to an image forming method, an image forming apparatus and a process cartridge therefor using the photoreceptor.

2. Discusstion of the Background

Recently, organic photoreceptors (OPCs) have been widely used instead of inorganic photoreceptors for copiers, facsimiles, laser printers and their complex machines because of their good performances and advantages. Specific examples of the reasons include (1) optical properties such as a wide range of light absorbing wavelength and a large amount of absorbing light; (2) electrical properties such as high sensitivity and stable chargeability; (3) choice of the materials; (4) good manufacturability; (5) low cost; (6) non-toxicity, etc.

On the other hand, as image forming apparatuses become smaller, photoreceptors have smaller diameters recently. In addition, photoreceptors are required to have high durability as image forming apparatuses produce images at a higher speed and are free from maintenance. In this respect, the organic photoreceptor typically has a soft surface layer mainly formed from a low-molecular-weight charge transport material and an inactive polymer, and therefore the organic photoreceptor typically has a drawback of being mechanically abraded with an image developer and a cleaner with ease when repeated used in the electrophotographic process. In addition, as toner particles has smaller particle diameters due to requirements for high-quality images, cleaning blades need to have higher rubber hardness and higher contact pressure for the purpose of increasing cleanability, and which also accelerates abrading photoreceptors. Such abrasions of photoreceptors deteriorate electrical properties thereof such as sensitivities and chargeabilities, and cause abnormal images such as image density deterioration and background fouling. When a photoreceptor is locally abraded, images having black stripes due to defective cleaning are produced. At present, photoreceptors are exchanged because of these abrasions and damages.

Therefore, it is indispensable to decrease the abrasion amount of the organic photoreceptor so as to have high durability. This is the most pressing issue to solve in this field.

As methods of improving the abrasion resistance of a photoreceptor, (1) Japanese Laid-Open Patent Publication No. 56-48637 discloses a photoreceptor using a hardening binder in its surface layer; (2) Japanese Laid-Open Patent Publication No. 64-1728 discloses a photoreceptor using charge transport polymer material; and (3) Japanese Laid-Open Patent Publication No. 4-281461 discloses a photoreceptor having a surface layer wherein an inorganic filler is dispersed. The photoreceptor using a hardening binder of (1) tends to increase a residual potential and decrease image density because of a poor solubility of the binder with a charge transport material and impurities such as a polymerization initiator and an unreacted residual group. The photoreceptor using charge transport polymer material of (2) and the photoreceptor having a surface layer wherein an inorganic filler is dispersed of (3) have abrasion resistance to some extent, but which is not fully satisfactory. Further, the photoreceptor having a surface layer wherein an inorganic filler is dispersed of (3) tends to increase a residual potential and decrease image density because of a trap present on the surface of the inorganic filler. Any of the photoreceptors of (1) to (3) does not have fully satisfactory integrated durability such as electrical durability and mechanical durability.

To improve the abrasion resistance of the photoreceptor of (1), Japanese Patent No. 3262488 discloses a photoreceptor including hardened urethane acrylate. However, although disclosing that the photosensitive layer includes the hardened urethane acrylate, Japanese Patent No. 3262488 only discloses that a charge transport material may be included therein and does not disclose specific examples thereof. When a low-molecular-weight charge transport material is simply included in a photosensitive layer, the low-molecular-weight charge transport material is not soluble with the hardened urethane acrylate and the low-molecular-weight charge transport material separates out, and which causes deterioration of mechanical strength of the resultant photoreceptor such as a crack. In addition, Japanese Patent No. 3262488 discloses that a polycarbonate resin is included in the photosensitive layer to improve the solubility. However, a content of the hardened urethane acrylate decreases, resulting in insufficient abrasion resistance of the photoreceptor. A photoreceptor not including a charge transport material in its surface layer, which is thin against deterioration of potential of the irradiated part, has a short life. In addition, the charged potential thereof has poor stability against environment.

As an abrasion resistance technology of a photosensitive layer in place of these technologies, Japanese Patent No. 3194392 discloses a method of forming a charge transport layer using a coating liquid formed from a monomer having a carbon-carbon double bond, a charge transport material having a carbon-carbon double bond and a binder resin. The binder resin includes a binder resin having a carbon-carbon double bond and a reactivity with the charge transport material, and a binder resin having neither a carbon-carbon double bond nor a reactivity with the charge transport material. The photoreceptor has good abrasion resistance and electrical properties. However, when a binder resin not having a reactivity with a charge transport material, such as an acrylic polymer, a styrene polymer, an acrylic styrene copolymer, a polyester resin, a polycarbonate resin and an epoxy resin, a bonding amount between the monomer having a carbon-carbon double bond and the charge transport material having a carbon-carbon double bond decreases, resulting in insufficient crosslink density of the photosensitive layer. Further, since the binder resin itself does not have toughness, the resultant photosensitive layer does not have satisfactory abrasion resistance.

Japanese Laid-Open Patent Publication No. 2000-66425 discloses a photosensitive layer including a hardened positive hole transport compound having two or more chain polymerizing functional groups in the same molecule. However, since the photosensitive layer includes a bulky positive hole transport material having two or more chain polymerizing functional groups, a distortion appears in the hardened compound and an internal stress increases to cause a roughness and a crack of the surface layer, resulting in insufficient durability of the resultant photoreceptor.

Japanese Laid-Open Patent Publications Nos. 2004-302450, 2004-302451 and 2004-302452 disclose a crosslinked charge transport layer in which a tri-or more functional radical polymerizing monomer having no charge transport structure and a monofunctional radical polymerizing compound having a charge transport structure are hardened, wherein the monofunctional radical polymerizing compound having a charge transport structure improves mechanical and electrical durability of the layer and prevents the layer from being cracked. However, when the crosslinked surface layer is formed, an acrylic monomer having many acrylic functional groups are hardened for the purpose of high abrasion resistance. Since the hardened acrylic material has a large volume contraction, the surface layer insufficiently adheres to the lower photosensitive layer. When such a photoreceptor is used in an image forming apparatus wherein a large mechanical stress is applied thereto, the crosslinked surface layer separates from the photosensitive layer, resulting in inability of maintaining sufficient abrasion resistance for long periods.

Japanese Laid-Open Patent Publications Nos. 2001-183857 and 2001-183858 disclose a method of preparing a coating liquid for a photoreceptor including a structural unit having charge transportability, capable of forming a resin layer in combination with an organopolysiloxane resin, in its crosslinked surface layer. The coating liquid includes many polymerizing functional groups per unit weight and can form a harder crosslinked surface layer. However, the volume contraction of the hardening materials is so noticeable that the crosslinked surface layer less adhered to the lower layer. Namely, the crosslinked surface layer tends to separate from the photosensitive layer, resulting in inability of maintaining sufficient abrasion resistance for long periods. Further, in terms of electrostatic stability, the crosslinked surface layer cannot be thickened, resulting in inability of realizing satisfactory abrasion resistance.

Because of these reasons, a need exists for a photoreceptor having s good durability and stable electrical properties, and produces high-quality images for long periods.

### SUMMARY OF THE INVENTION

Accordingly, an object of the present invention is to provide a photoreceptor having good durability and stable electrical properties, and produces high-quality images for long periods

Another object of the present invention is to provide a method of preparing the photoreceptor.

A further object of the present invention is to provide an image forming method using the photoreceptor.

Another object of the present invention is to provide an image forming apparatus using the photoreceptor.

A further object of the present invention is to provide a process cartridge therefor, using the photoreceptor.

These objects and other objects of the present invention, either individually or collectively, have been satisfied by the discovery of an electrophotographic photoreceptor, comprising:

an electroconductive substrate, and a photosensitive layer, including at least:
a tri- or more functional radical polymerizing monomer having no charge transport structure, and
a monofunctional radical polymerizing compound having a charge transport structure;

wherein the photosensitive layer includes radical polymerizing functional groups in an amount of from 2.55×10²¹ to 7.50×10²¹ in 1 g of solid contents thereof, and has a peel strength not less than 0.1 N/mm when measured by the SAICAS method.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGS. 1A and 1B are schematic views illustrating cross-sections of a first embodiment of the electrophotographic photoreceptor of the present invention;

FIG. 2A and 2B are schematic views illustrating cross-sections of a second embodiment of the electrophotographic photoreceptor of the present invention;

FIG. 3 is a schematic view illustrating an embodiment of the image forming apparatus of the present invention;

FIG. 4 is a schematic view illustrating an embodiment of the process cartridge of the present invention;

FIG. 5 is a schematic view illustrating a cross-section of a fourth embodiment of the electrophotographic photoreceptor of the present invention;

FIG. 6 is a schematic view illustrating a cross-section of a fifth embodiment of the electrophotographic photoreceptor of the present invention;

FIG. 7 is a X-ray diffraction spectrum of the titanylphthalocyanine crystal for use in Examples of the present invention;

FIG. 8 is a cross-sectional SEM photograph of the electrophotographic photoreceptor in Example 17; and

FIG. 9 is a cross-sectional SEM photograph of the electrophotographic photoreceptor in Comparative Example 13.

### DETAILED DESCRIPTION OF THE PREFERRED EMBODIMENTS

The present invention provides a photoreceptor having good durability and stable electrical properties, and produces high-quality images for long periods.

The photoreceptor of the present invention includes a tri- or more functional radical polymerizing monomer in its surface layer, which develops a three-dimensional network, and therefore the surface layer becomes a very hard crosslinked layer having high crosslink density and high abrasion resistance. Meanwhile, when only a monomer having less radical polymerizing functional groups is used, the crosslinkage therein becomes poor and the crosslinked surface layer does not have a noticeable abrasion resistance. When a polymer material is included therein, the development of the three-dimensional network is impaired and the crosslinkage therein deteriorates, resulting in less abrasion resistance than that of the present invention. Further, the polymer material has poor compatibility with a hardened material produced by a reaction between the polymer material and the radical polymerizing constituents, i.e., the radical polymerizing monomer and the radical polymerizing compound having a charge transportable structure, resulting in a layer separation causing a local abrasion and a damage on the surface.

The crosslinked surface layer of the present invention including the tri- or more functional radical polymerizing monomer having no charge transport structure and the monofunctional radical polymerizing compound having a charge transport structure, which are hardened at the same time in a short time to form a crosslinked bonding having high hardness, has improved durability. Further, an improvement of the hardening speed can form a smooth surface layer and good cleanability thereof can be maintained for long periods. Further, a uniform crosslinked film with less distortion can be formed therein. In addition, including the monofunctional radical polymerizing compound having a charge transport structure, the crosslinked layer has stable electrical properties for long periods. When the crosslinked surface layer includes a low-molecular-weight charge transport material not having a functional group, the low-molecular-weight charge transport material separates out and becomes clouded, and mechanical strength of the crosslinked surface layer deteriorates. When the crosslinked surface layer includes a bi- or more functional charge transport compound, the charge transport structure is so bulky that an internal stress in the crosslinked surface layer becomes high, resulting in frequent occurrence of crack and damage thereof. Further, an intermediate structure (a cation radical) when transporting a charge cannot stably be maintained, resulting in deterioration of sensitivity due to a trapped charge and increase of residual potential. The deterioration of these electrical properties causes deterioration of the resultant image density and thinning of letter images. Therefore, the present invention provides a photoreceptor having improved abrasion resistance and stable electrical properties for long periods without being cracked, and producing high-quality images for long periods.

The crosslinked surface layer of the present invention, including radical polymerizing functional groups in an amount of from 2.55×10²¹ to 7.50×10²¹ in 1 g of solid contents thereof has higher crosslink density. Namely, the three-dimensional network therein is highly developed, and the crosslinked surface layer has noticeably high abrasion resistance, having high hardness and elasticity.

The number of the radical polymerizing functional groups in 1 g of the solid contents can be determined as follows:

(1) weight/molecular weight=mol;

(2) mol×Avogadro's number (6.02×10²³ mol¹)=the number of molecule;

(3) the number of molecule×the number of functional group per molecule=the number of functional groups; and

(4) a total sum of the number of functional groups of all materials having radical polymerizing functional groups is divided by total weight of the solid contents to determine the number of the radical polymerizing functional groups in 1 g of the solid contents.

Further, the crosslinked surface layer of the present invention, having a peel strength not less than 0.1 N/mm when measured by the SAICAS method, has sufficient adhesiveness and does not separate from the lower layer.

Next, the crosslinked surface layer coating liquid of the present invention will be explained.

Specific examples of the tri- or more fuuctional radical polymerizing monomer having no charge transport structure include a radical polymerizing monomers having three or more radical polymerizing fuuctional groups such as an acryloyloxy group and a methacryloyloxy group.

A compound having three or more acryloyloxy groups can be prepared by, e.g., subjecting a compound having three or more hydroxyl groups and an acrylic acid (salt), a halide acrylate or an ester acrylate to an ester reaction or an ester exchange reaction. A compound having three or more methacryloyloxy groups can similarly be prepared as well. The radical polymerizing functional groups of a monomer having three or more radical polymerizing functional groups may be the same or different from one another.

Specific examples of the tri- or more functional radical polymerizing monomer having no charge transport structure include the following materials, but are not limited thereto.

Namely, trimethylolpropanetriacrylate (TMPTA), trimethylolpropanetrimethacrylate, HPA-modified trimethylolpropanetriacrylate, EO-modified trimethylolpropanetriacrylate, PO-modified trimethylolpropanetriacrylate, caprolactone-modified trimethylolpropanetriacrylate, HPA-modified trimethylolpropanetrimethacrylate, pentaerythritoltriacrylate, pentaerythritoltetraacrylate (PETTA), glyceroltriacrylate, ECH-modified glyceroltriacrylate, EO-modified glyceroltriacrylate, PO-modified glyceroltriacrylate, tris(acryloxyethyl)isocyanurate, dipentaerythritolhexaacrylate (DPHA), caprolactone-modified dipentaerythritolhexaacrylate, dipentaerythritolhydroxypentaacrylate, alkyl-modified dipentaerythritolpentaacrylate, alkyl-modified dipentaerythritoltetraacrylate, alkyl-modified dipentaerythritoltriacrylate, dimethylolpropanetetraacrylate (DTMPTA), pentaerythritolethoxytetraacrylate, 2,2,5,5-tetrahydroxymethylcyclopentanonetetraacrylate, etc. are available. These can be used alone or in combination. The modified monomers have lower viscosity so as to easily be handled.

The tri- or more fuctional radical polymerizing monomer having no charge transport structure for use in the present invention preferably has a ratio of the molecular weight to the number of functional groups (molecular weight/number of functional groups) in the monomer not greater than 250. When greater than 250, the resultant crosslinked surface layer is soft and the abrasion resistance thereof slightly deteriorates. Therefore, the HPA, EO or PO-modified monomers having extremely long modified groups are not preferably used alone.

The crosslinked surface layer preferably includes the tri- or more functional radical polymerizing monomer having no charge transport structure in an amount of from 20 to 80% by weight, and more preferably from 30 to 70% by weight. When less than 20% by weight, a three-dimensional crosslinked bonding density of the crosslinked surface layer is insufficient, and the abrasion resistance thereof does not remarkably improve more than a layer including a conventional thermoplastic resin. When greater than 80% by weight, a content of a charge transport compound lowers and electrical properties of the resultant photoreceptor deteriorates.

The monofunctional radical polymerizing compound having a charge transport structure for use in the present invention represents a compound having a positive hole transport structure such as triarylamine, hydrazone, pyrazoline and carbazole or an electron transport structure such as condensed polycyclic quinone, diphenoquinone, a cyano group and an electron attractive aromatic ring having a nitro group, and radical polymerizing functional groups. Any radical polymerizing functional groups can be used, provided they have a carbon-carbon double bonding and capable of radically polymerizing. Specific examples of the radical polymerizing functional groups include 1-substituted ethylene functional groups, 1,1-substituted ethylene functional groups, etc. Among these radical polymerizing function groups, the acryloyloxy groups and methacryloyloxy groups are effectively used. In addition, a triarylamine structure is effectively used as the charge transport structure.

Further, when a compound having the following formula (1) or (2), electrical properties such as sensitivity and residual potential are preferably maintained: 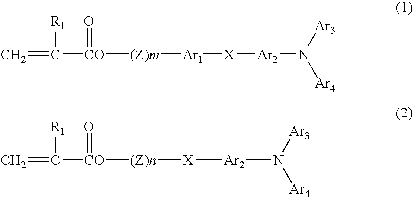
wherein R₁ represents a hydrogen atom, a halogen atom, a substituted or an unsubstituted alkyl group, a substituted or an unsubstituted aralkyl group, a substituted or an unsubstituted aryl group, a cyano group, a nitro group, an alkoxy group, —COOR₂ wherein R₂ represents a hydrogen atom, a halogen atom, a substituted or an unsubstituted alkyl group, a substituted or an unsubstituted aralkyl group and a substituted or an unsubstituted aryl group and a halogenated carbonyl group or CONR₃R₄ wherein R₃ and R₄ independently represent a hydrogen atom, a halogen atom, a substituted or an unsubstituted alkyl group, a substituted or an unsubstituted aralkyl group and a substituted or an unsubstituted aryl group; Ar₁ and Ar₂ independently represent a substituted or an unsubstituted arylene group; Ar₃ and Ar₄ independently represent a substituted or an unsubstituted aryl group; X represents a single bond, a substituted or an unsubstituted alkylene group, a substituted or an unsubstituted cycloalkylene group, a substituted or an unsubstituted alkyleneether group, an oxygen atom, a sulfur atom and vinylene group; Z represents a substituted or an unsubstituted alkylene group, a substituted or an unsubstituted alkyleneether group and alkyleneoxycarbonyl group; and m and n represent 0 and an integer of from 1 to 3.

In the formulae (1) and (2), among substituted groups of R₁, the alkyl groups include methyl groups, ethyl groups, propyl groups, butyl groups, etc.; the aryl groups include phenyl groups, naphtyl groups, etc.; aralkyl groups include benzyl groups, phenethyl groups, naphthylmethyl groups, etc.; and alkoxy groups include methoxy groups, ethoxy groups, propoxy groups, etc.

These may be substituted by alkyl groups such as halogen atoms, nitro groups, cyano groups, methyl groups and ethyl groups; alkoxy groups such as methoxy groups and ethoxy groups; aryloxy groups such as phenoxy groups; aryl groups such as phenyl groups and naphthyl groups; aralkyl groups such as benzyl groups and phenethyl groups.

The substituted group of R₁ is preferably a hydrogen atom and a methyl group.

Ar₃ and Ar₄ independently represent a substituted or an unsubstituted aryl group, and specific examples thereof include condensed polycyclic hydrocarbon groups, non-condensed cyclic hydrocarbon groups and heterocyclic groups.

The condensed polycyclic hydrocarbon group is preferably a group having 18 or less carbon atoms forming a ring such as a fentanyl group, a indenyl group, a naphthyl group, an azulenyl group, a heptalenyl group, a biphenylenyl group, an As-indacenyl group, a fluorenyl group, an acenaphthylenyl group, a praadenyl group, an acenaphthenyl group, a phenalenyl group, a phenantolyl group, an anthryl group, a fluoranthenyl group, an acephenantolylenyl group, an aceanthrylenyl group, a triphenylel group, a pyrenyl group, a crycenyl group and a naphthacenyl group.

Specific examples of the non-condensed cyclic hydrocarbon groups and heterocyclic groups include monovalent groups of monocyclic hydrocarbon compounds such as benzene, diphenylether, polyethylenediphenylether, diphenylthioether, and diphenylsulfone; monovalent groups of non-condnesed hydrocarbon compounds such as biphenyl, polyphenyl, diphenylalkane, diphenylalkene, diphenylalkine, triphenylmethane, distyrylbenzene, 1,1-diphenylcycloalkane, polyphenylalkane and polyphenylalkene; and monovalent groups of ring gathering hydrocarbon compounds such as 9,9-diphenylfluorene.

Specific examples of the heterocyclic groups include monovalent groups such as carbazole, dibenzofuran, dibenzothiophene, oxadiazole and thiadiazole.

Specific examples of the substituted or unsubstituted aryl group represented by Ar3 and Ar4 include the following groups:

(1) a halogen atom, a cyano group and a nitro group;

(2) a straight or a branched-chain alkyl group having 1 to 12, preferably from 1 to 8, and more preferably from 1 to 4 carbon atoms, and these alkyl groups may further include a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkyl groups include methyl groups, ethyl groups, n-butyl groups, i-propyl groups, t-butyl groups, s-butyl groups, n-propyl groups, trifluoromethyl groups, 2-hydroxyethyl groups, 2-ethoxyethyl groups, 2-cyanoethyl groups, 2-methocyethyl groups, benzyl groups, 4-chlorobenzyl groups, 4-methylbenzyl groups, 4-phenylbenzyl groups, etc. (3) alkoxy groups (—OR₂) wherein R₂ represents an alkyl group specified in (2). Specific examples thereof include methoxy groups, ethoxy groups, n-propoxy groups, i-propoxy groups, t-butoxy groups, s-butoxy groups, i-butoxy groups, 2-hydroxyethoxy groups, benzyloxy groups, trifluoromethoxy groups, etc.

(4) aryloxy groups, and specific examples of the aryl groups include phenyl groups and naphthyl groups. These aryl group may include an alkoxy group having 1 to 4 carbon atoms, an alkyl group having 1 to 4 carbon atoms or a halogen atom as a substituent. Specific examples of the aryloxy groups include phenoxy groups, 1-naphthyloxy groups, 2-naphthyloxy groups, 4-methoxyphenoxy groups, 4-methylphenoxy groups, etc.

(5) alkyl mercapto groups or aryl mercapto groups such as methylthio groups, ethylthio groups, phenylthio groups and p-methylphenylthio groups. 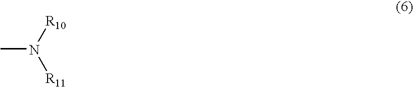
wherein R₁₀ and R₁₁ independently represent a hydrogen atom, an alkyl groups specified in (2) and an aryl group, and specific examples of the aryl groups include phenyl groups, biphenyl groups and naphthyl groups, and these may include an alkoxy group having 1 to 4 carbon atoms, an alkyl group having 1 to 4 carbon atoms or a halogen atom as a substituent, and R₁₀ and R₁₁ may form a ring together. Specific examples of the groups having this formula include amino groups, diethylamino groups, N-methyl-N-phenylamino groups, N,N-diphenylamino groups, N-N-di(tolyl)amino groups, dibenzylamino groups, piperidino groups, morpholino groups, pyrrolidino groups, etc.

(7) a methylenedioxy group, an alkylenedioxy group such as a methylenedithio group or an alkylenedithio group.

(8) a substituted or an unsubstituted styryl group, a substituted or an unsubstituted β-phenylstyryl group, a diphenylaminophenyl group, a ditolylaminophenyl group, etc.

The arylene group represented by Ar₁ and Ar₂ are derivative divalent groups from the aryl groups represented by Ar₃ and Ar₄.

The above-mentioned X represents a single bond, a substituted or an unsubstituted alkylene group, a substituted or an unsubstituted cycloalkylene group, a substituted or an unsubstituted alkyleneether group, an oxygen atom, a sulfur atom and vinylene group.

The substituted or unsubstituted alkylene group is a straight or a branched-chain alkylene group having 1 to 12, preferably from 1 to 8, and more preferably from 1 to 4 carbon atoms, and these alkylene groups may further includes a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkylene groups include methylene groups, ethylene groups, n-butylene groups, i-propylene groups, t-butylene groups, s-butylene groups, n-propylene groups, trifluoromethylene groups, 2-hydroxyethylene groups, 2- ethoxyethylene groups, 2-cyanoethylene groups, 2-methocyethylene groups, benzylidene groups, phenylethylene groups, 4-chlorophenylethylene groups, 4-methylphenylethylene groups, 4-biphenylethylene groups, etc.

The substituted or unsubstituted cycloalkylene group is a cyclic alkylene group having 5 to 7 carbon atoms, and these alkylene groups may include a fluorine atom, a hydroxyl group, a cyano group, an alkoxy group having 1 to 4 carbon atoms.

Specific examples thereof include cyclohexylidine groups, cyclohexylene groups and 3,3-dimethylcyclohexylidine groups, etc.

Specific examples of the substituted or unsubstituted alkyleneether groups include ethylene oxy, propylene oxy, ethylene glycol, propylene glycol, diethylene glycol, tetraethylene glycol and tripropylene glycol. The alkylene group of the alkyleneether group may include a substituent such as a hydroxyl group, a methyl group and an ethyl group.

The vinylene group has the following formula: 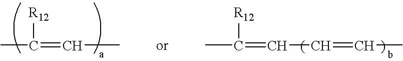
wherein R₁₂ represents a hydrogen atom, an alkyl group (same as those specified in (2)), an aryl group (same as those represented by Ar₃ and Ar₄); a represents 1 or 2; and b represents 1, 2 or 3. Z represents a substituted or an unsubstituted alkylene group, a substituted or an unsubstituted divalent alkyleneether group and a divalent alkyleneoxycarbonyl group. Specific examples of the substituted or unsubstituted alkylene group include those of X. Specific examples of the substituted or unsubstituted divalent alkyleneether group include those of X. Specific examples of the divalent alkyleneoxycarbonyl group include caprolactone-modified groups.

In addition, the monofunctional radical polymerizing compound having a charge transport structure of the present invention is more preferably a compound having the following formula (3): 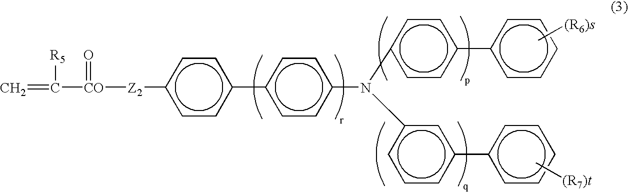
wherein o, p and q independently represent 0 or 1; R₅ represents a hydrogen atom or a methyl group; each of R6 and R₇ represents a substituent besides a hydrogen atom and an alkyl group having 1 to 6 carbon atoms, and may be different from each other when having plural carbon atoms; s and t represent 0 or an integer of from 1 to 3; Za represents a single bond, a methylene group, ethylene group,

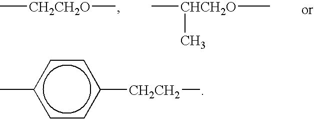

The compound having the formula (3) is preferably a compound having a methyl group or an ethyl group as a substituent of R₆ and R₇.

The monofunctional radical polymerizing compound having a charge transport structure of the formulae (1), (2) and particularly (3) for use in the present invention does not become an end structure because a double bonding between the carbons is polymerized while opened to the both sides, and is built in a chain polymer. In a crosslinked polymer polymerized with a radical polymerizing monomer having three or more functional groups, the compound is present in a main chain and in a crosslinked chain between the main chains (the crosslinked chain includes an intermolecular crosslinked chain between a polymer and another polymer and an intramolecular crosslinked chain wherein a portion having a folded main chain and another portion originally from the monomer, which is polymerized with a position apart therefrom in the main chain are polymerized). Even when the compound is present in a main chain or a crosslinked chain, a triarylamine structure suspending from the chain has at least three aryl groups radially located from a nitrogen atom, is not directly bonded with the chain and suspends through a carbonyl group or the like, and is sterically and flexibly fixed although bulky. The triarylamine structures can spatially be located so as to be moderately adjacent to one another in a polymer, and has less structural distortion in a molecule. Therefore, it is supposed that the monofunctional radical polymerizing compound having a charge transport structure in a surface layer of an electrophotographic photoreceptor can have an intramolecular structure wherein blocking of a charge transport route is comparatively prevented.

Specific examples of the monofunctional radical polymerizing compound having a charge transport structure include compounds having the following formulae, but are not limited thereto.

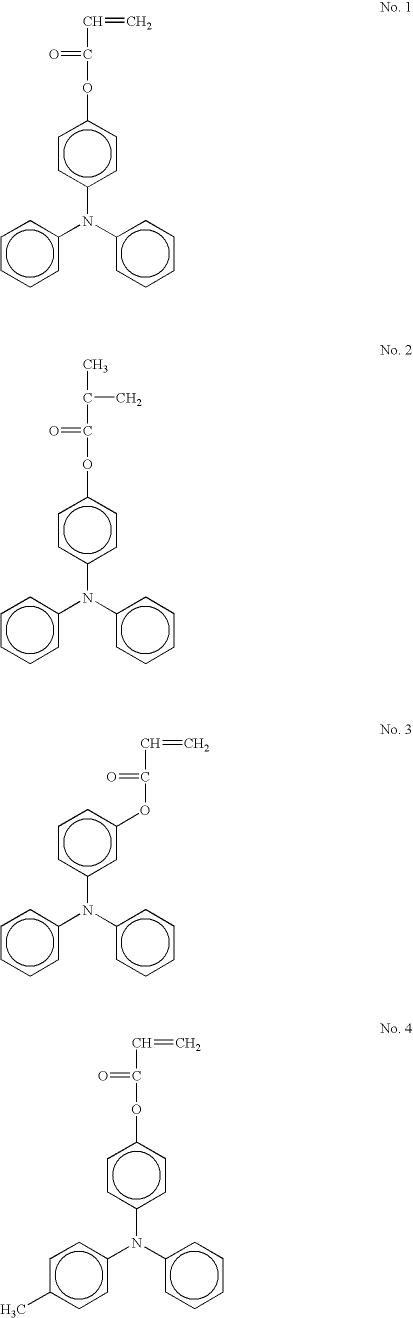

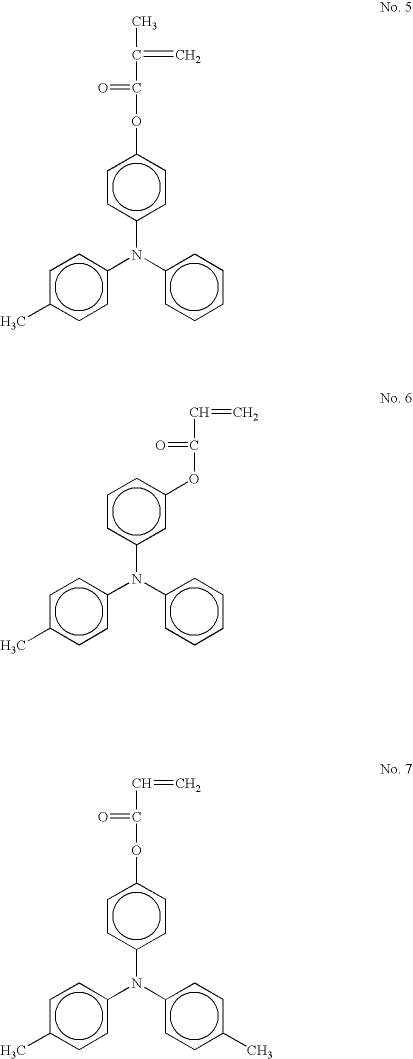

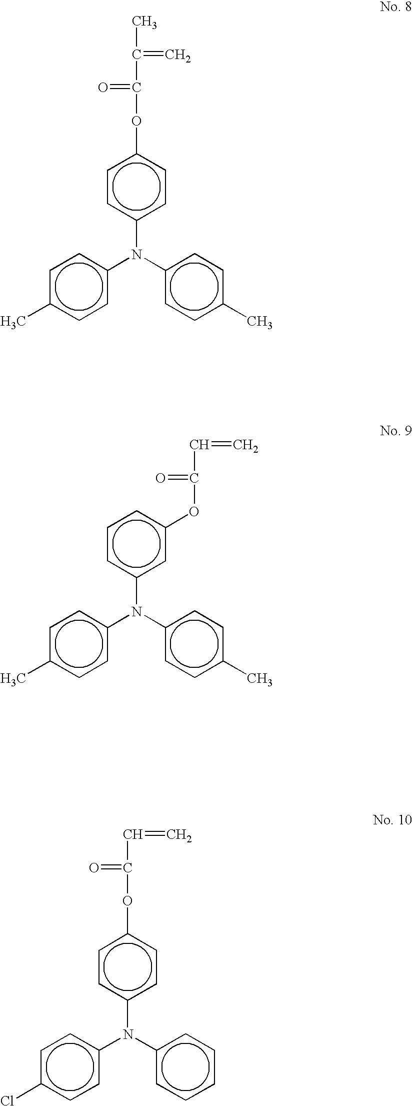

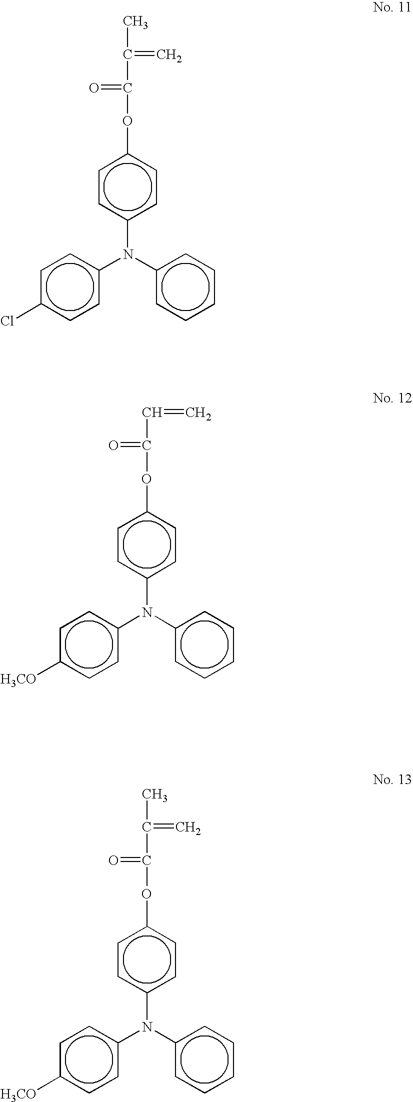

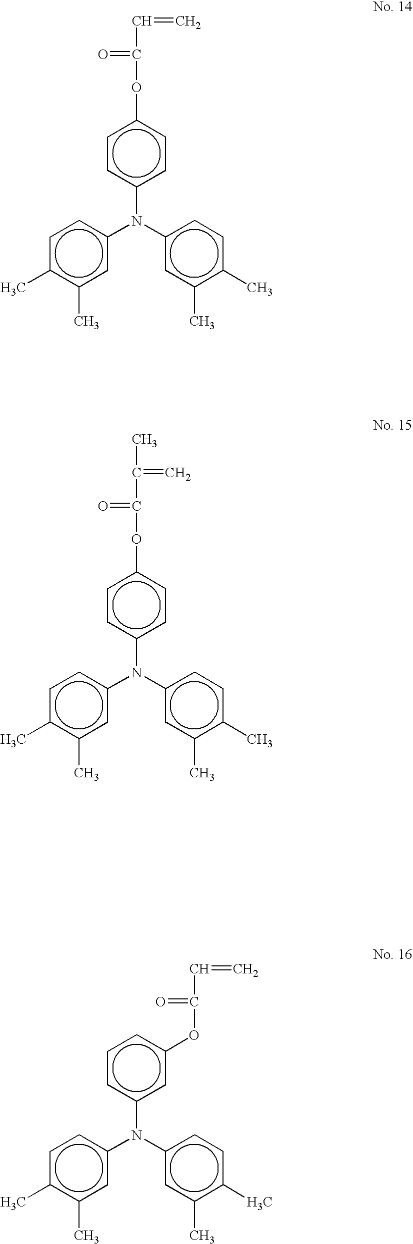

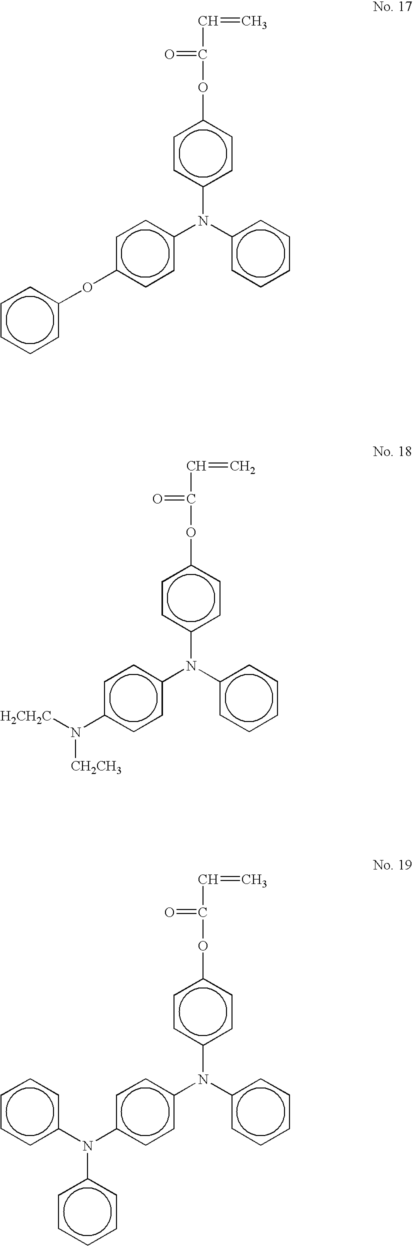

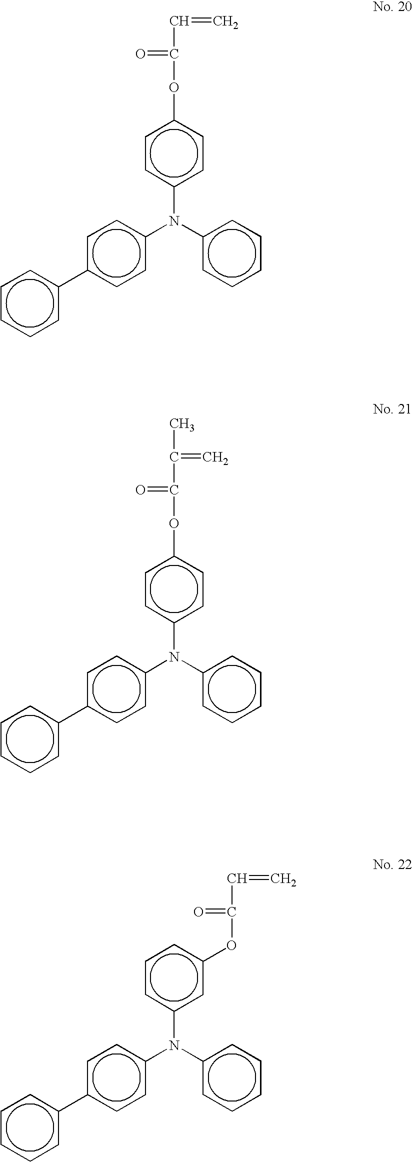

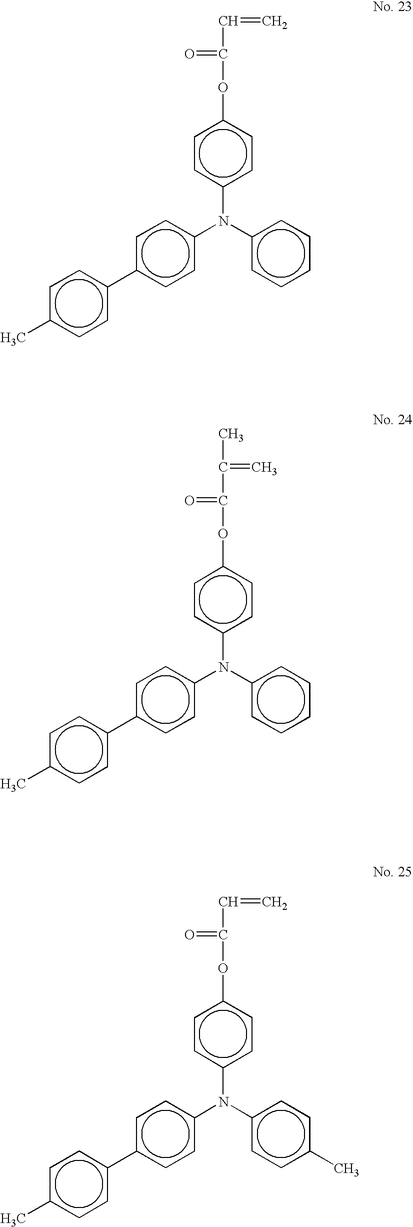

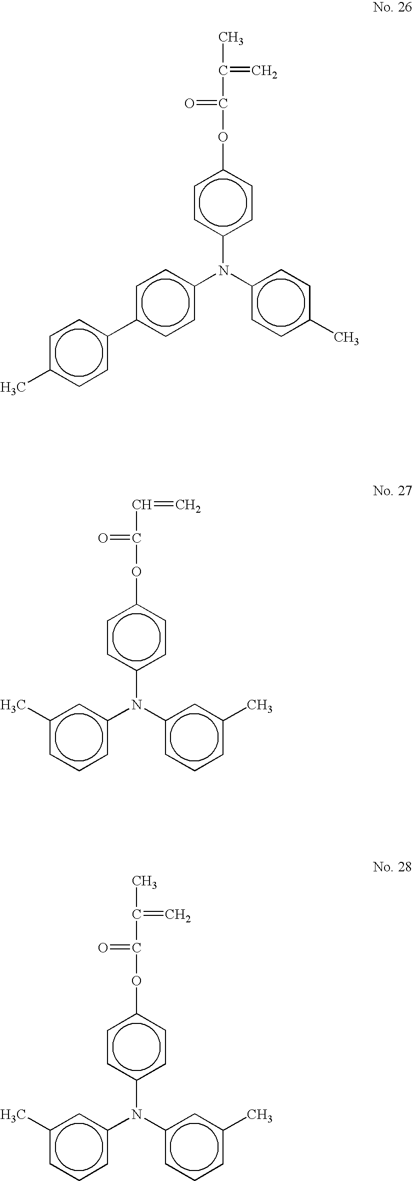

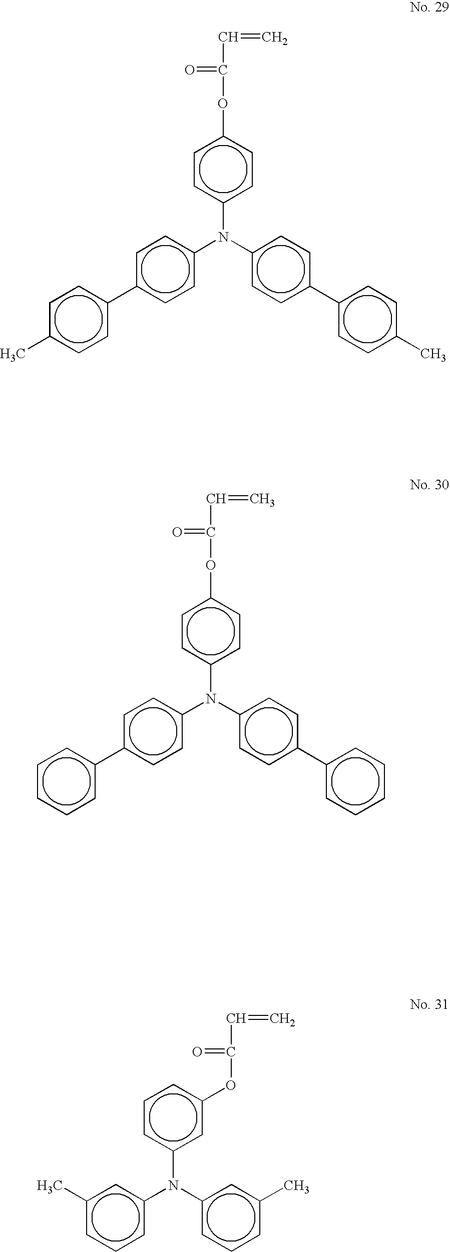

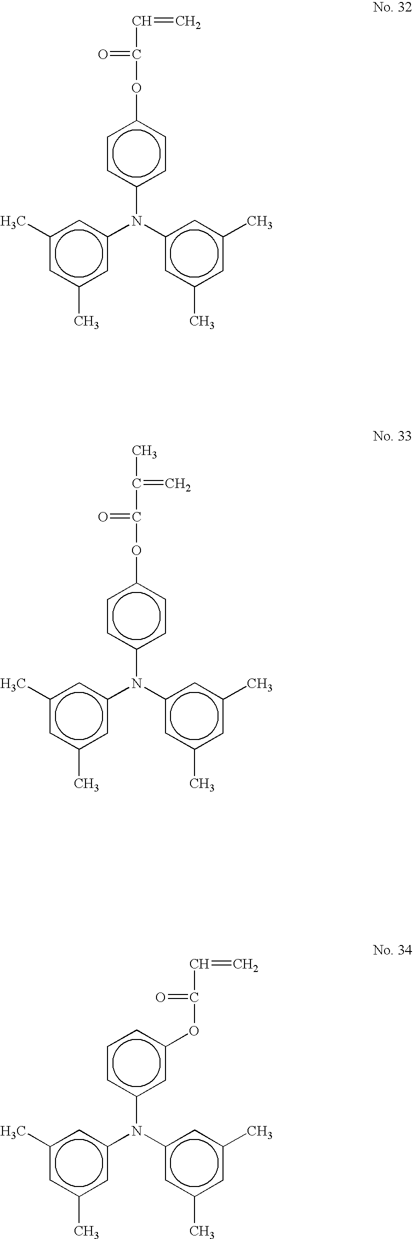

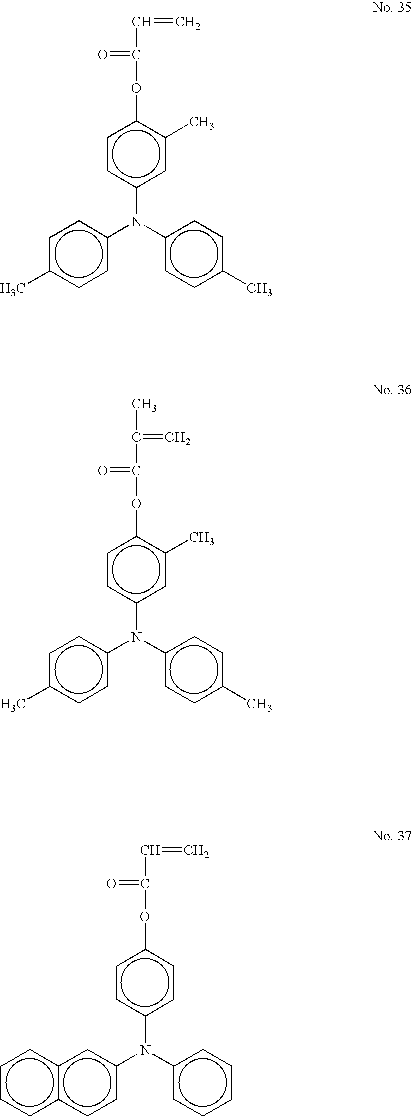

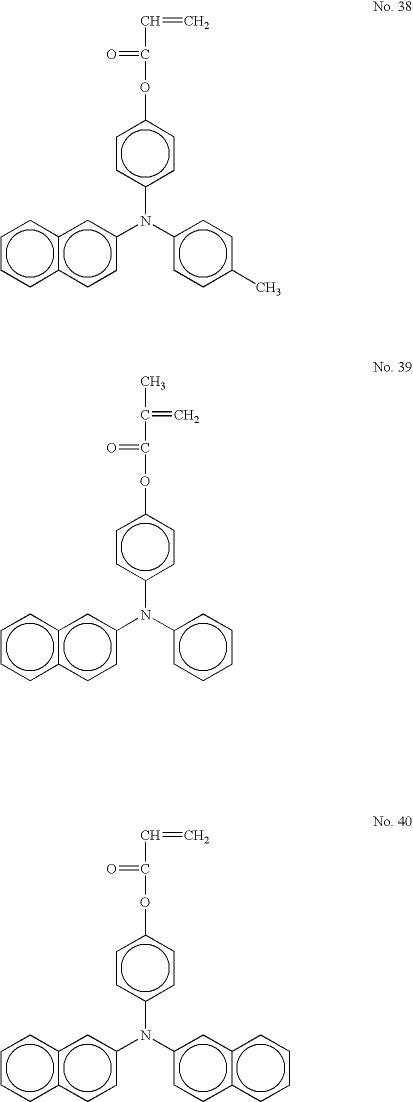

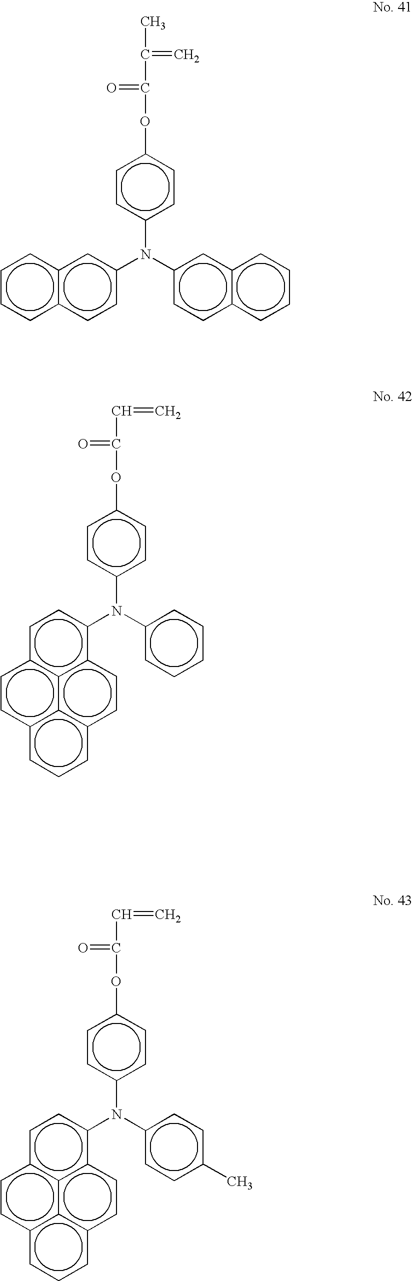

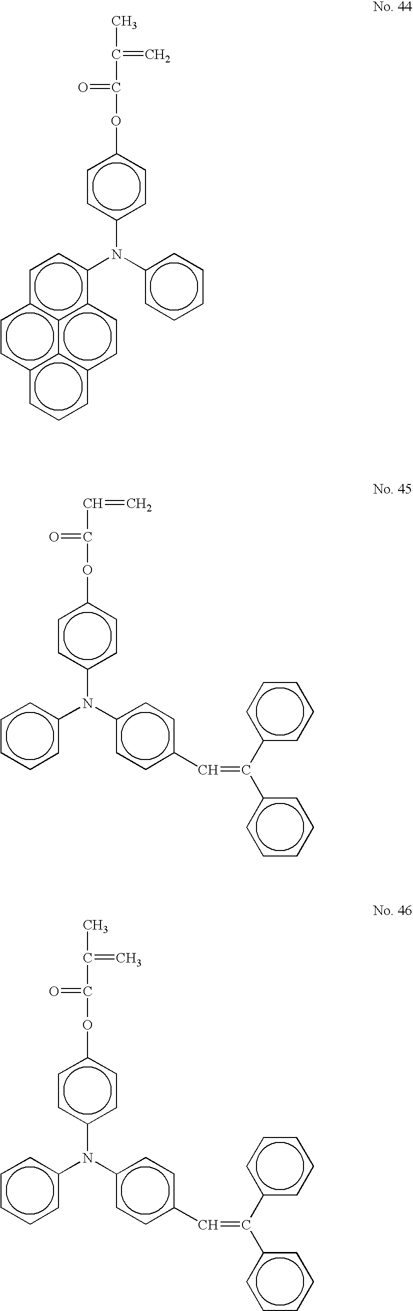

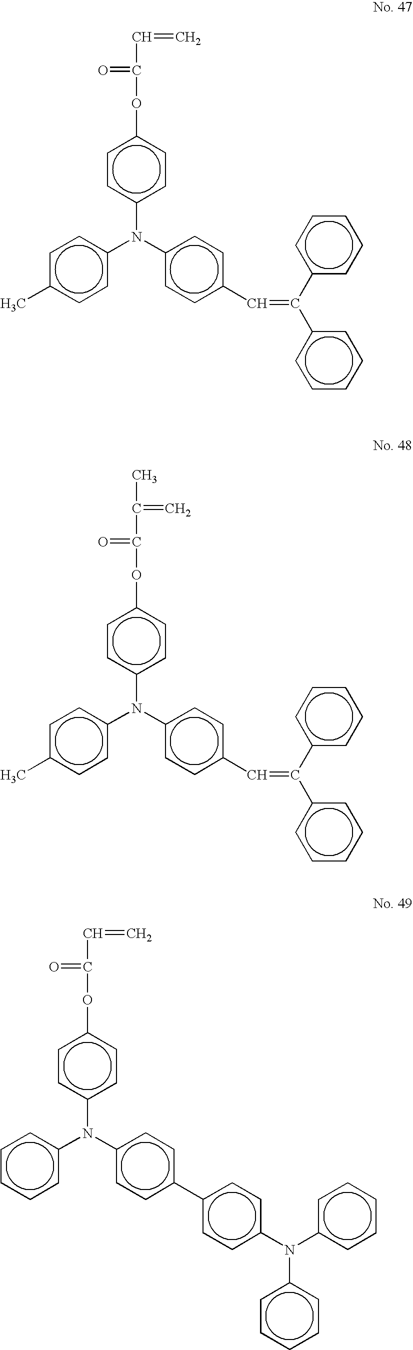

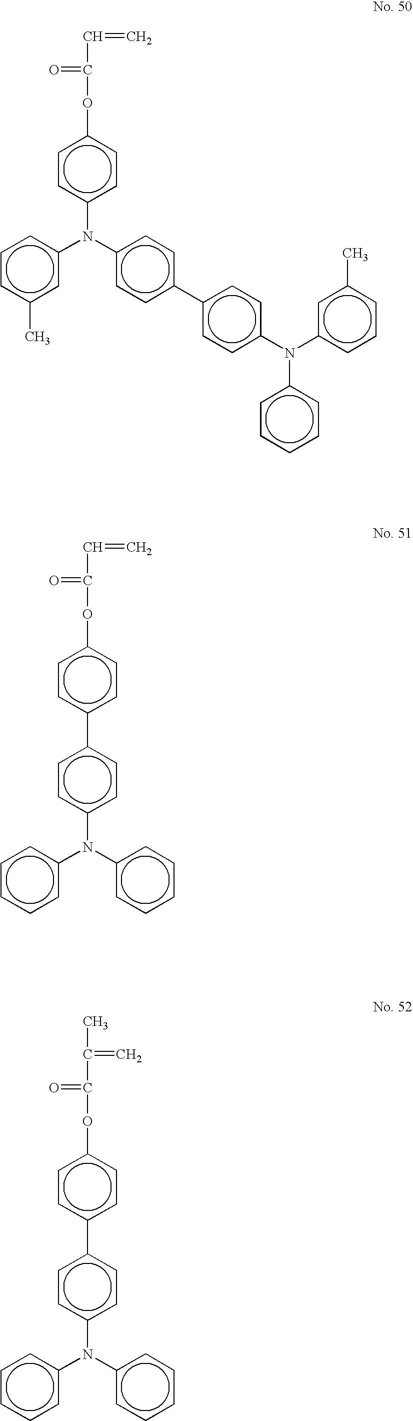

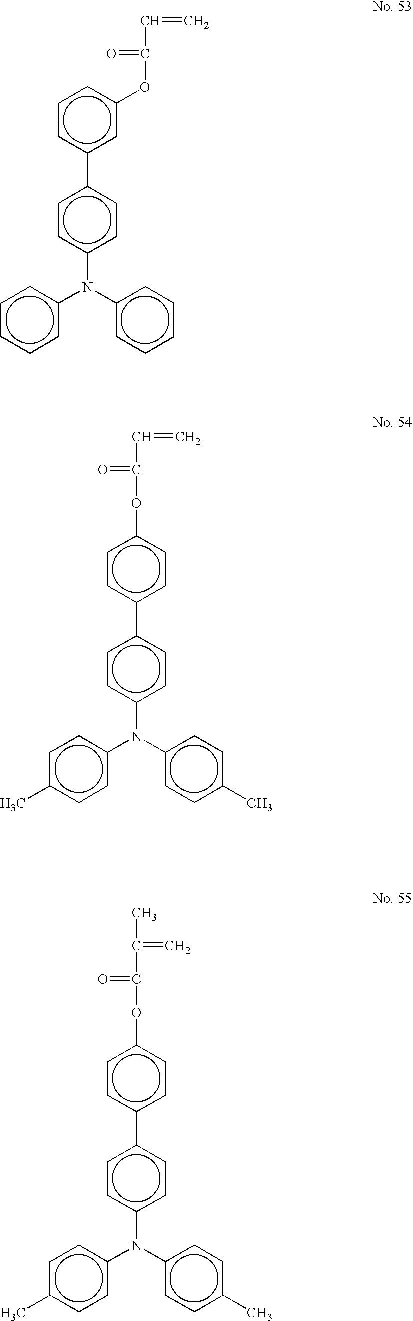

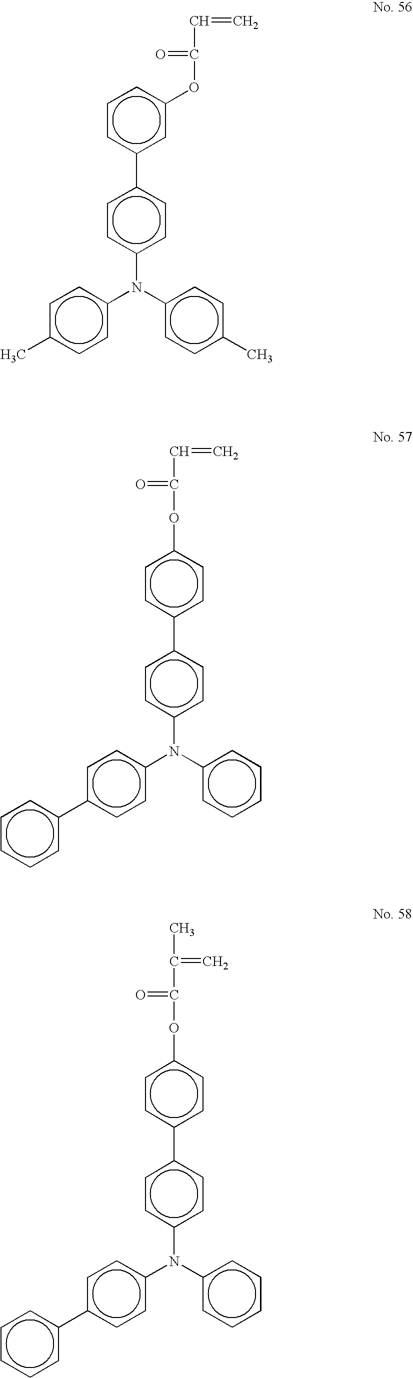

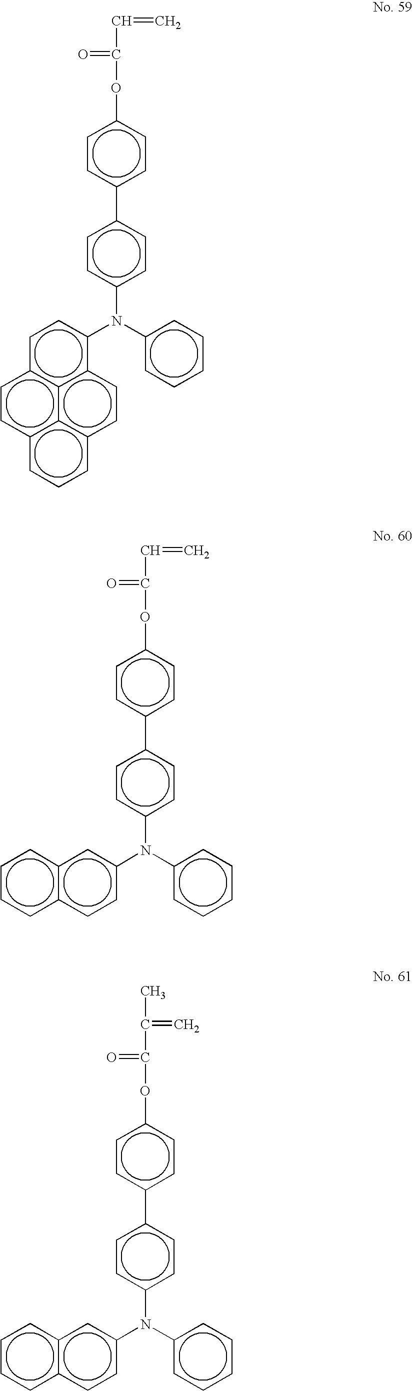

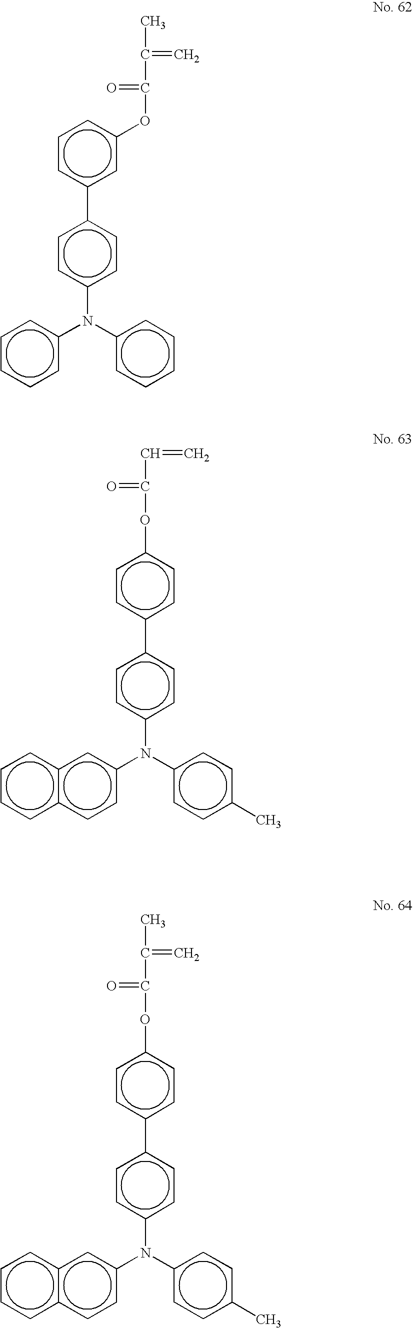

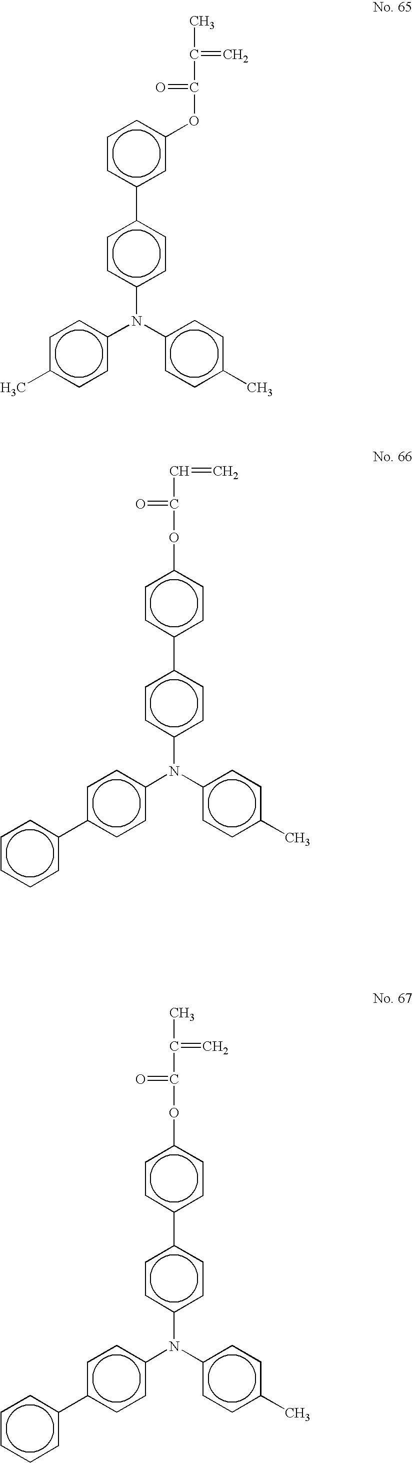

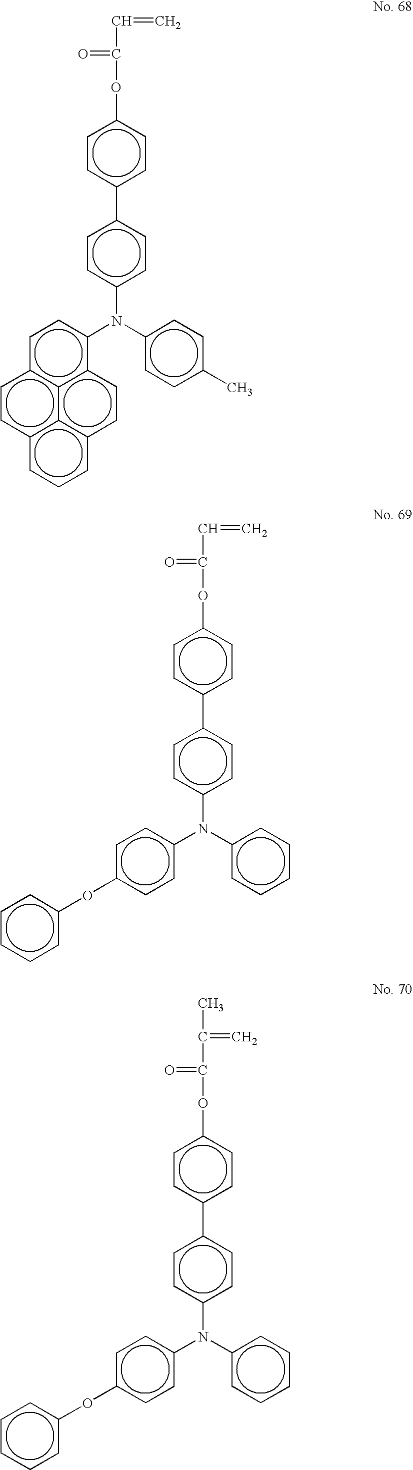

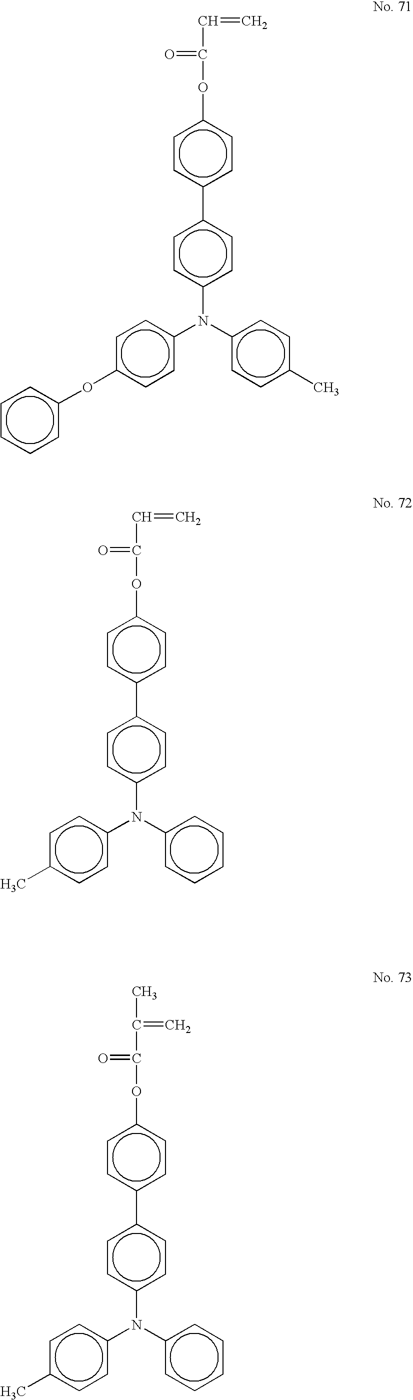

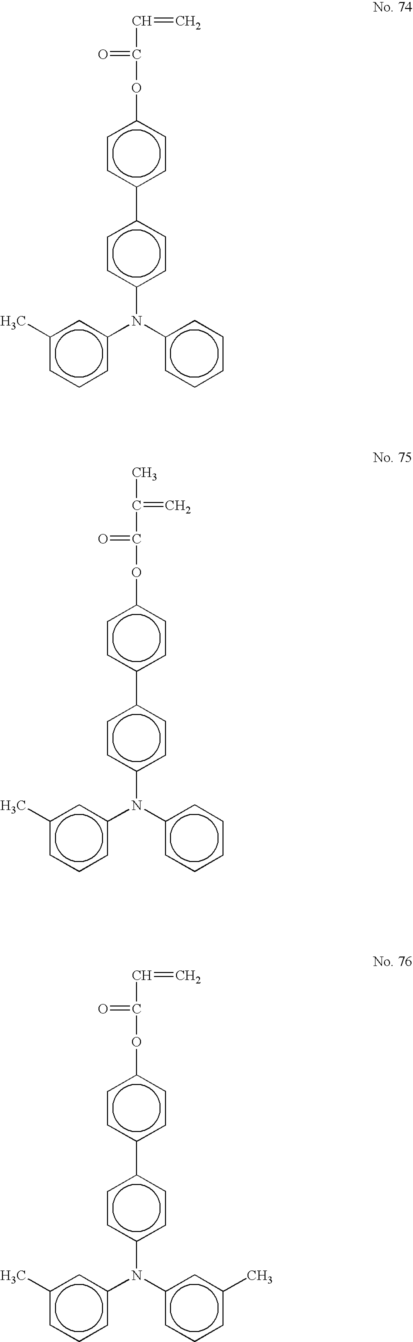

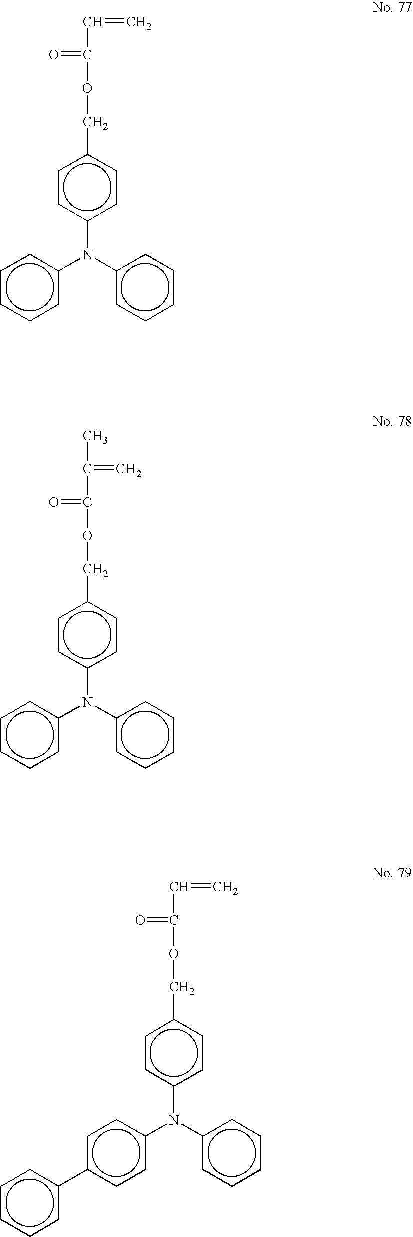

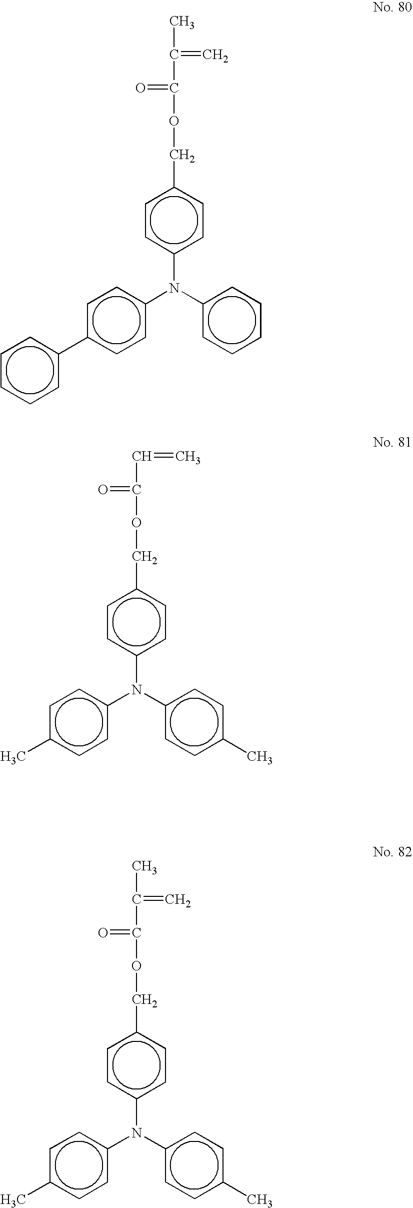

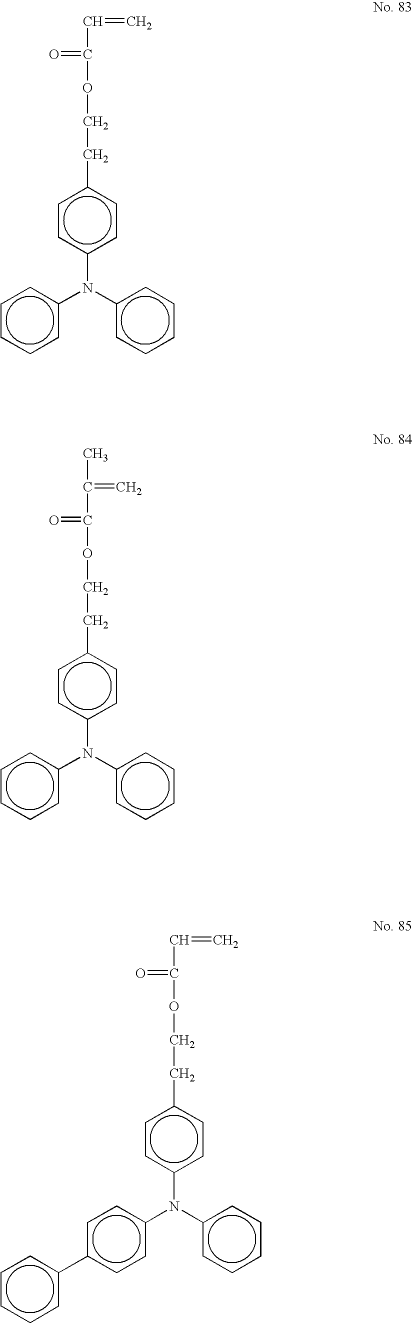

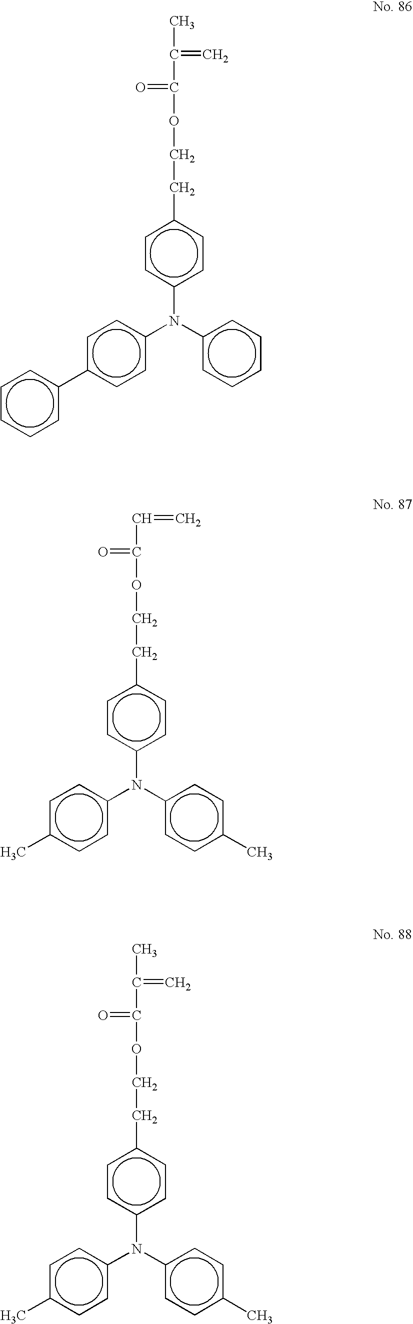

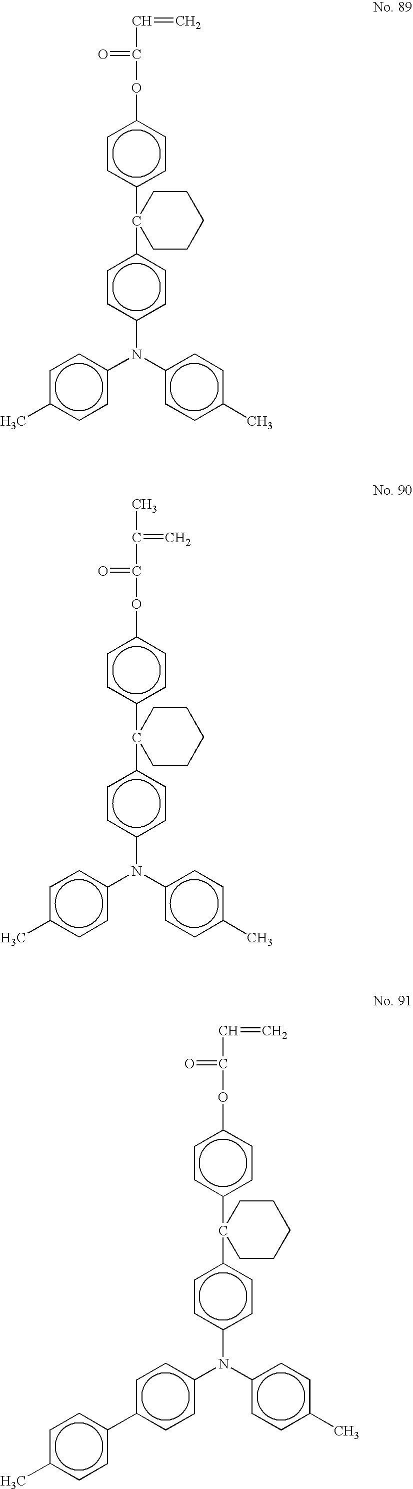

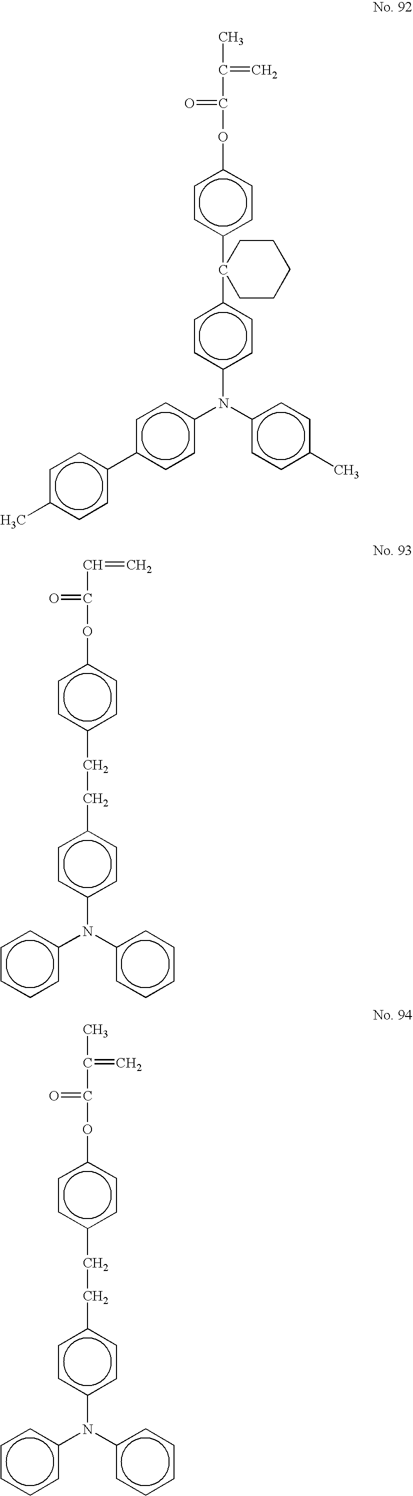

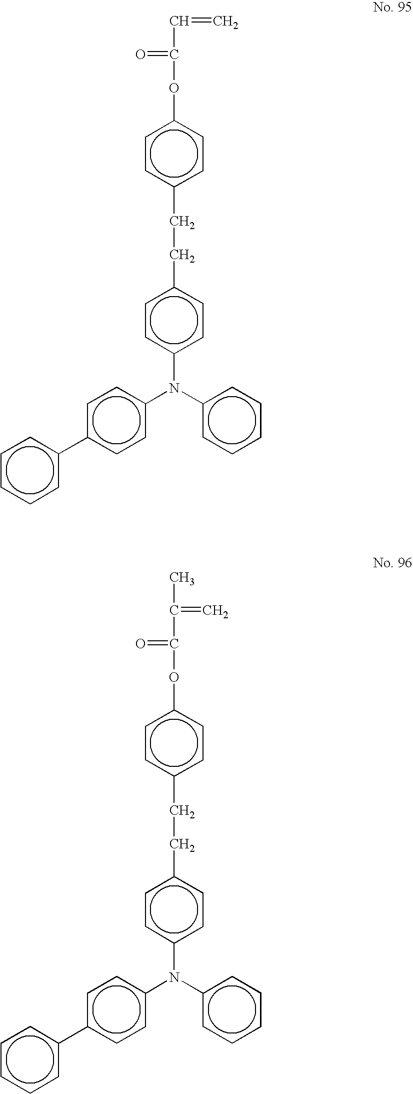

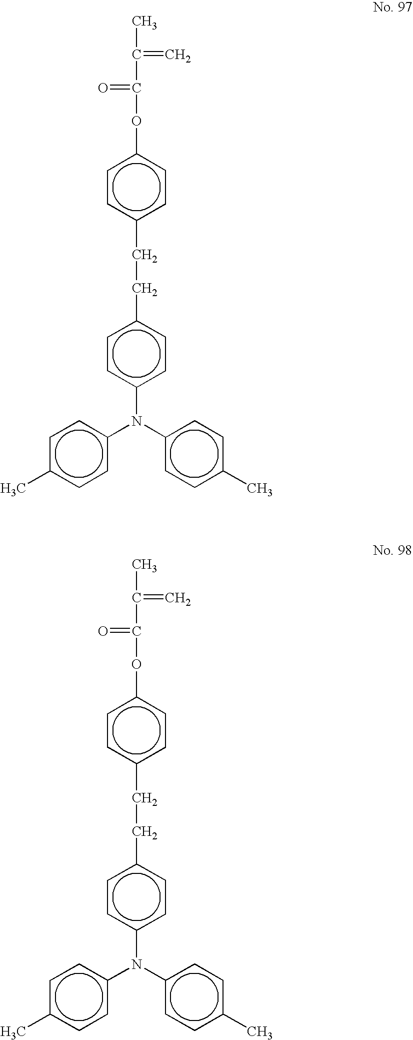

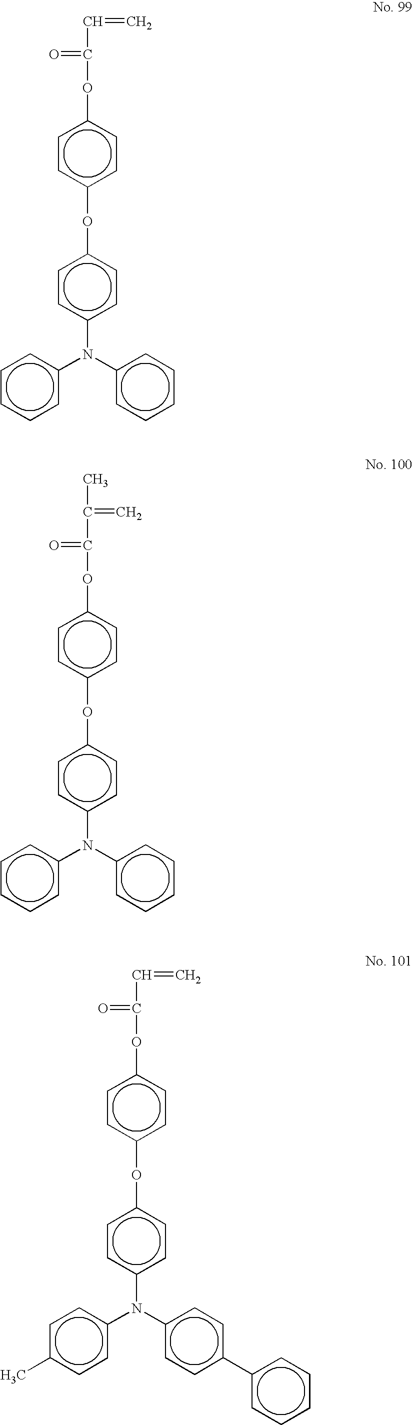

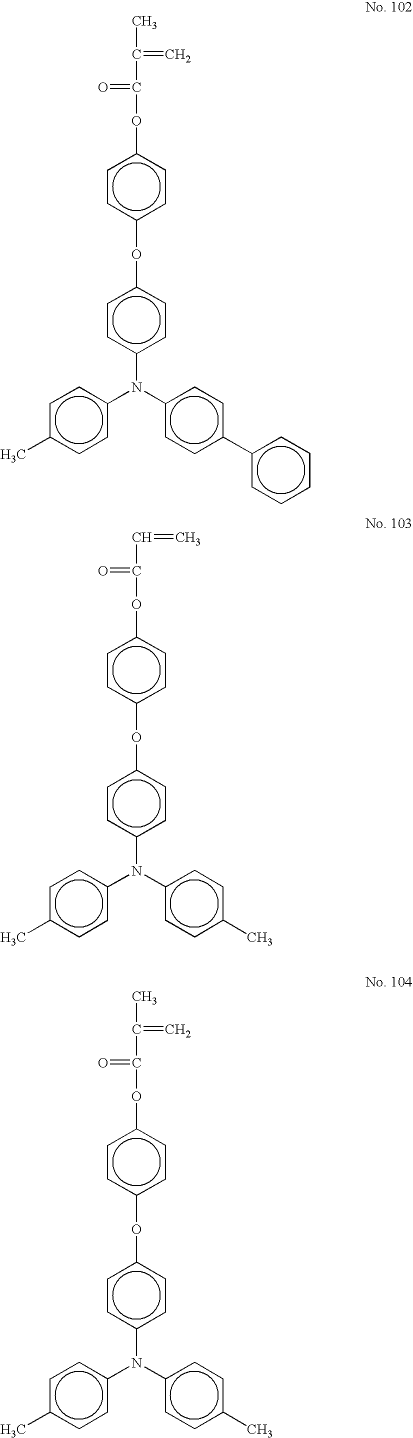

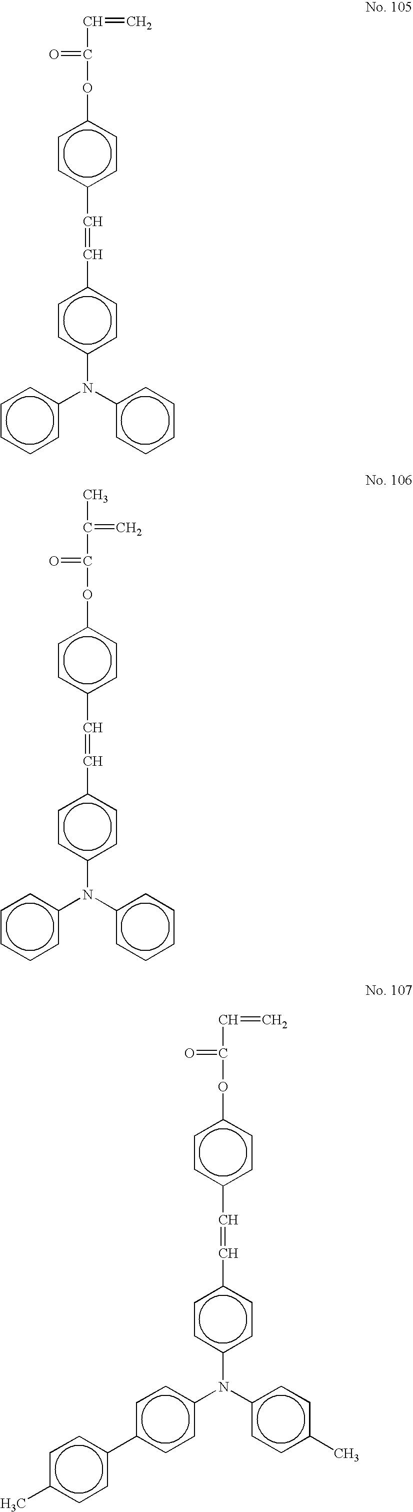

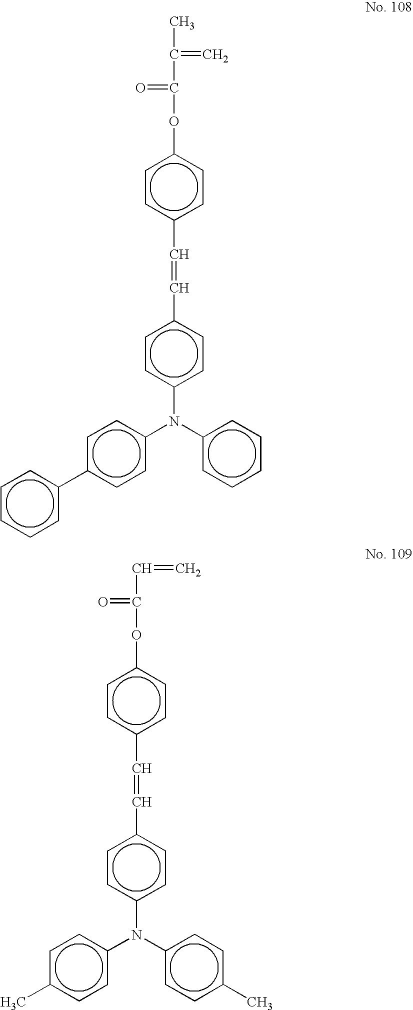

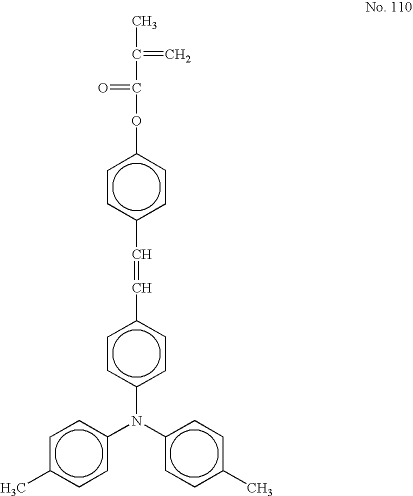

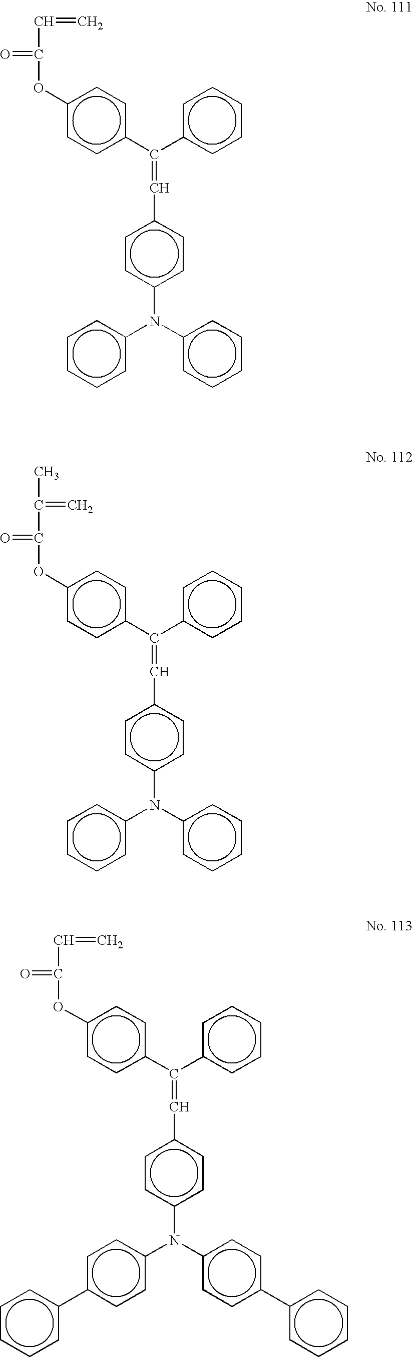

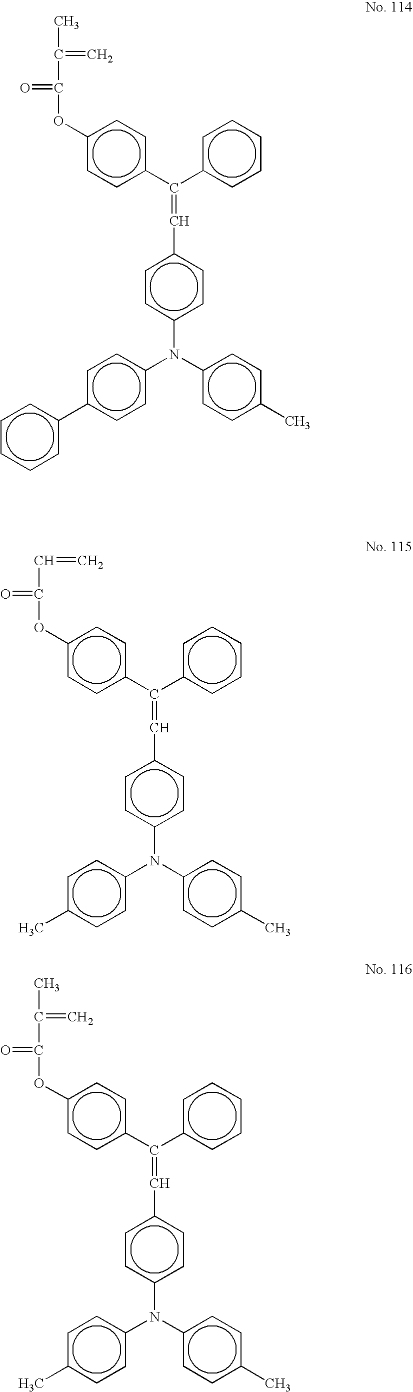

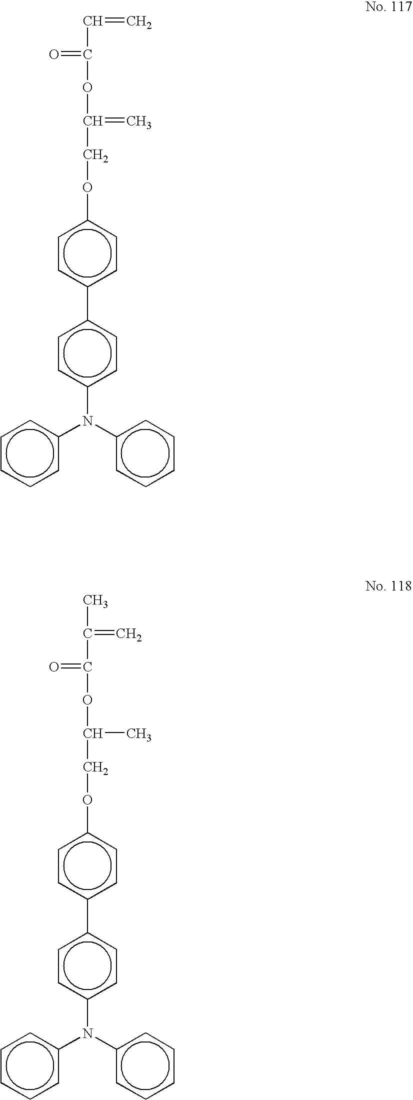

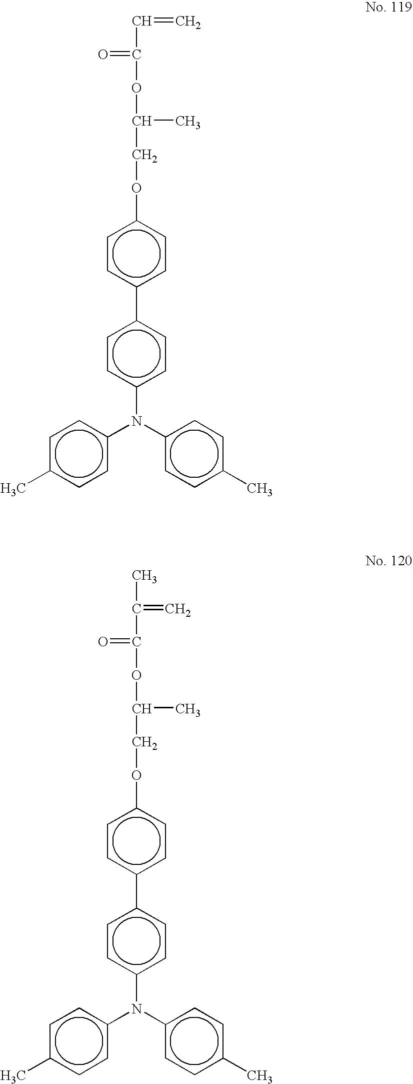

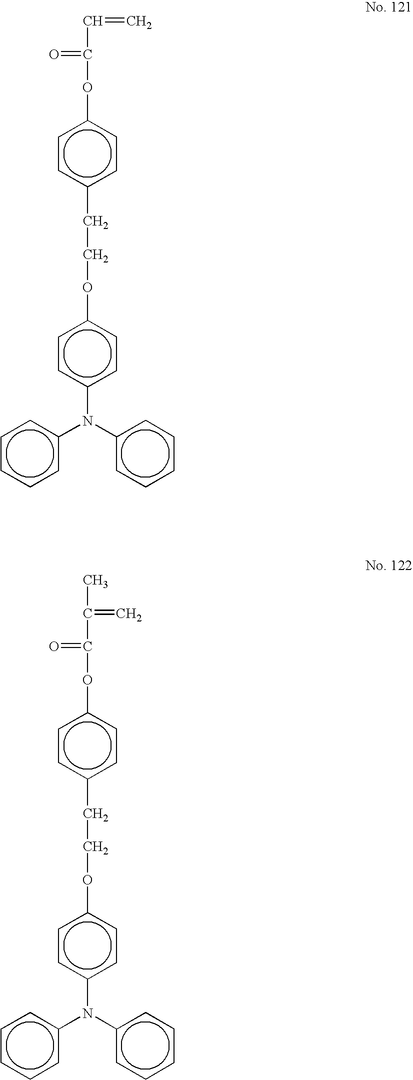

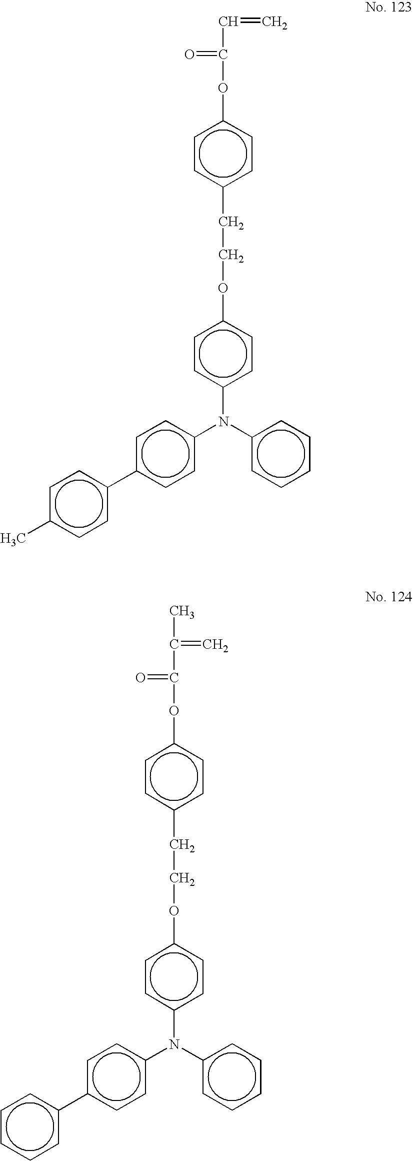

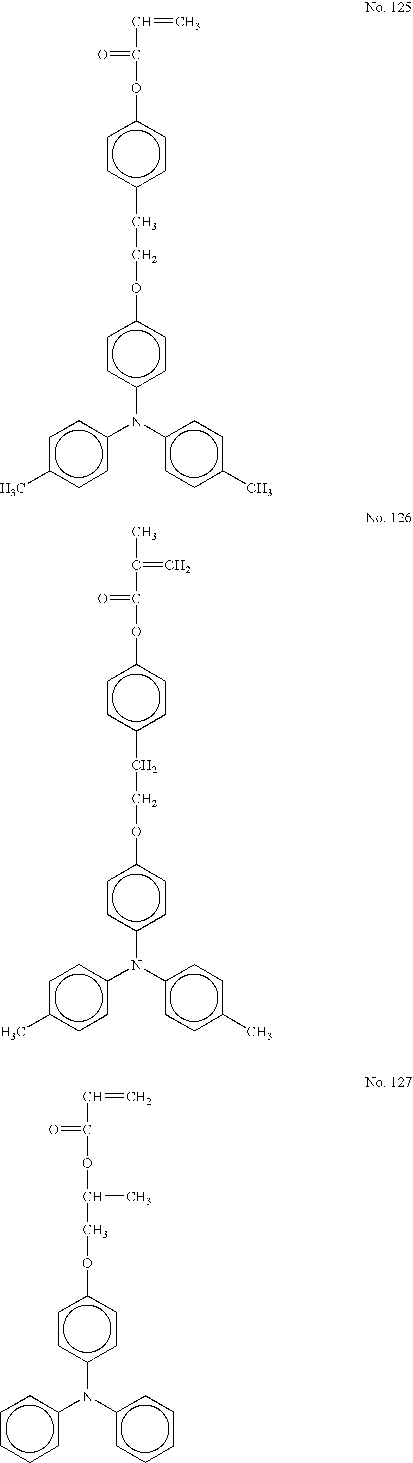

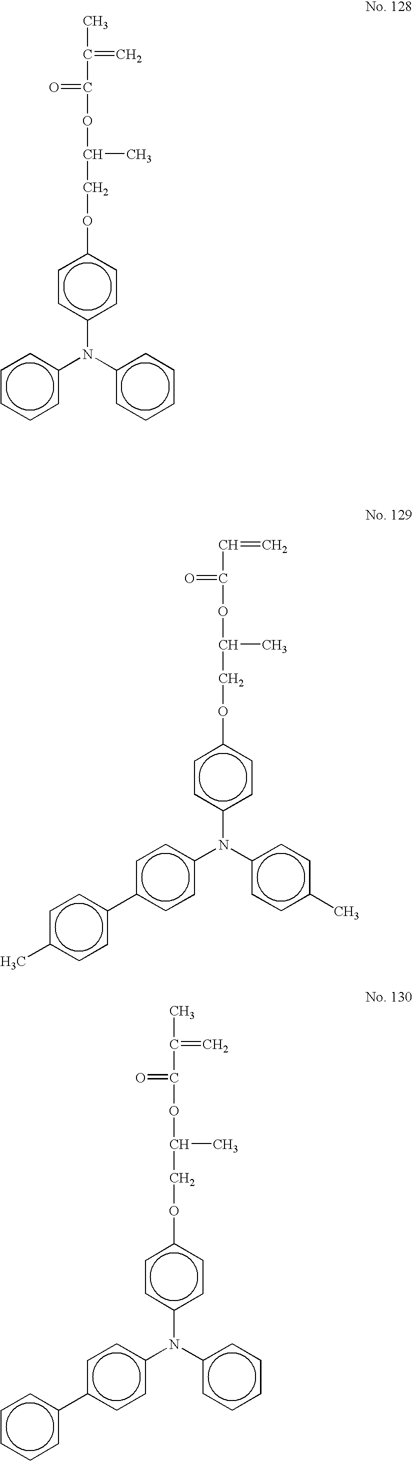

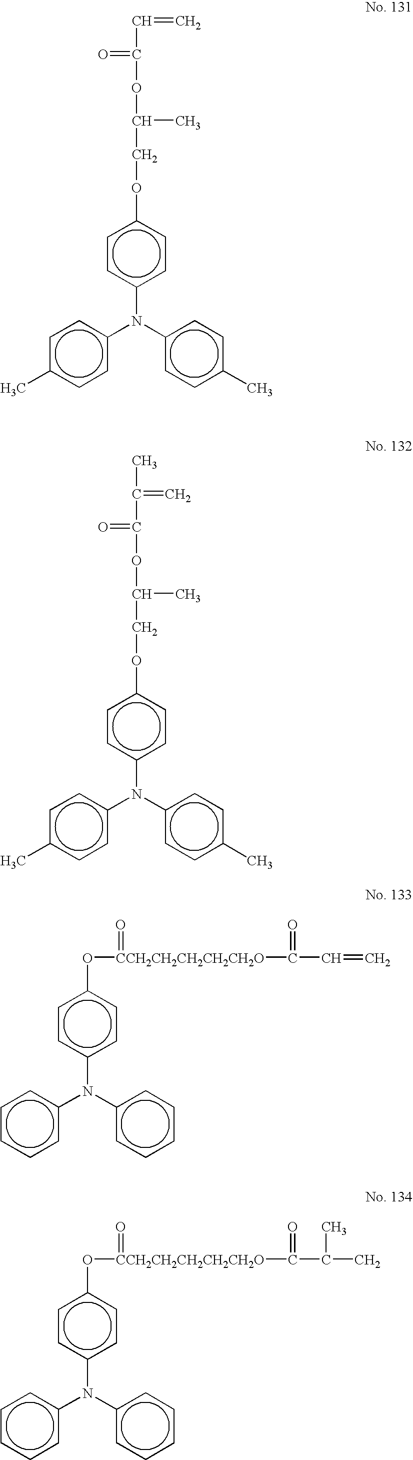

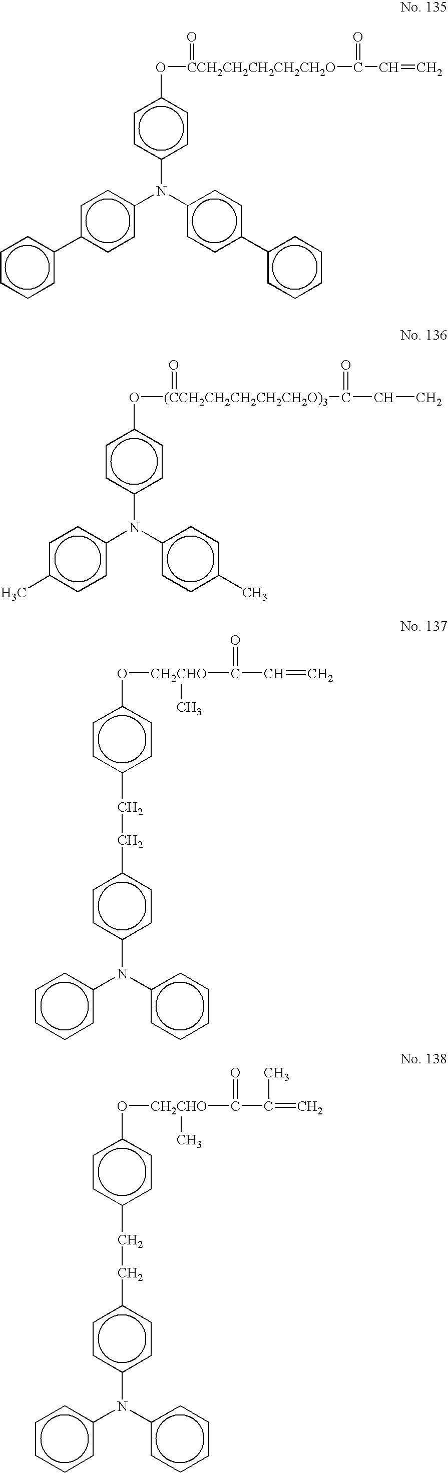

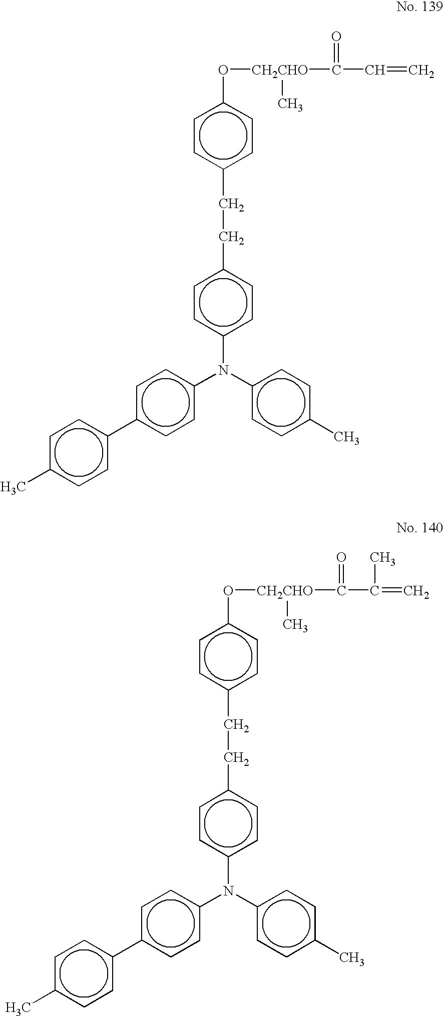

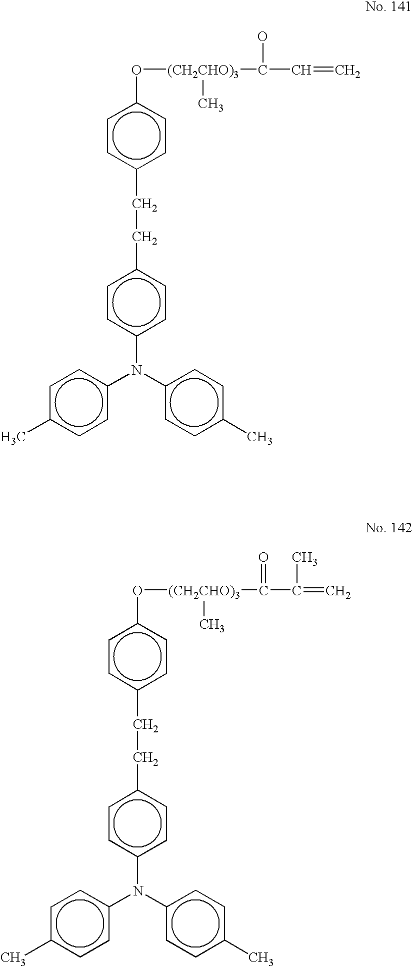

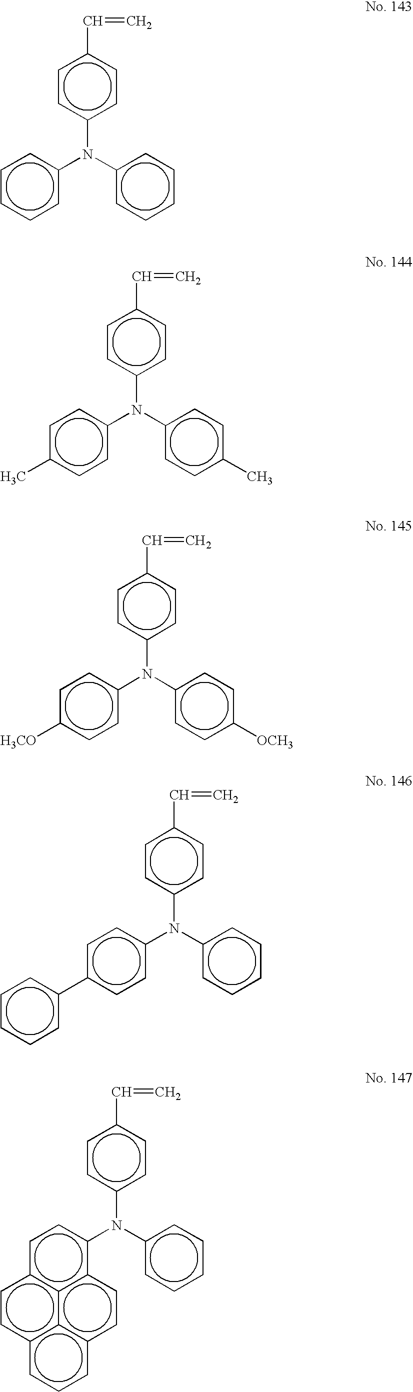

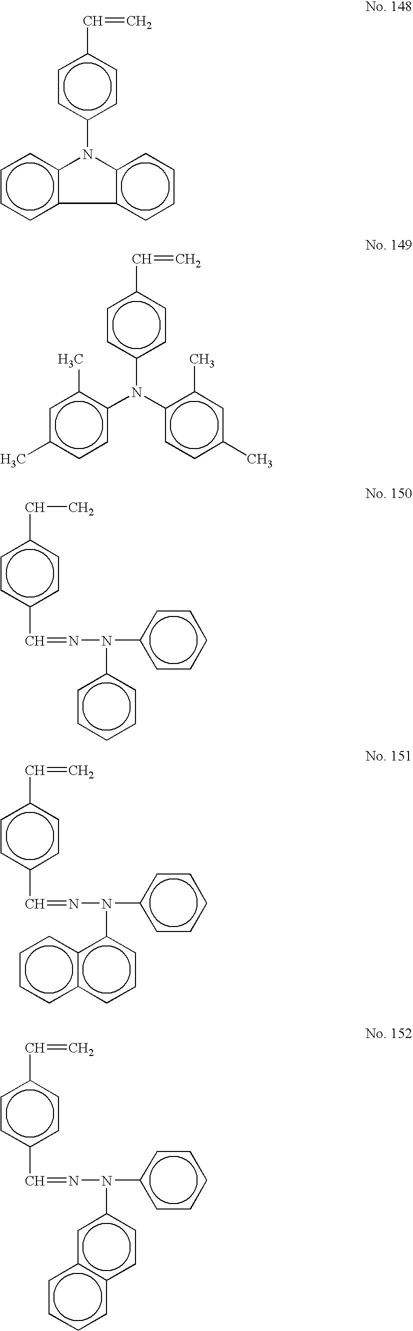

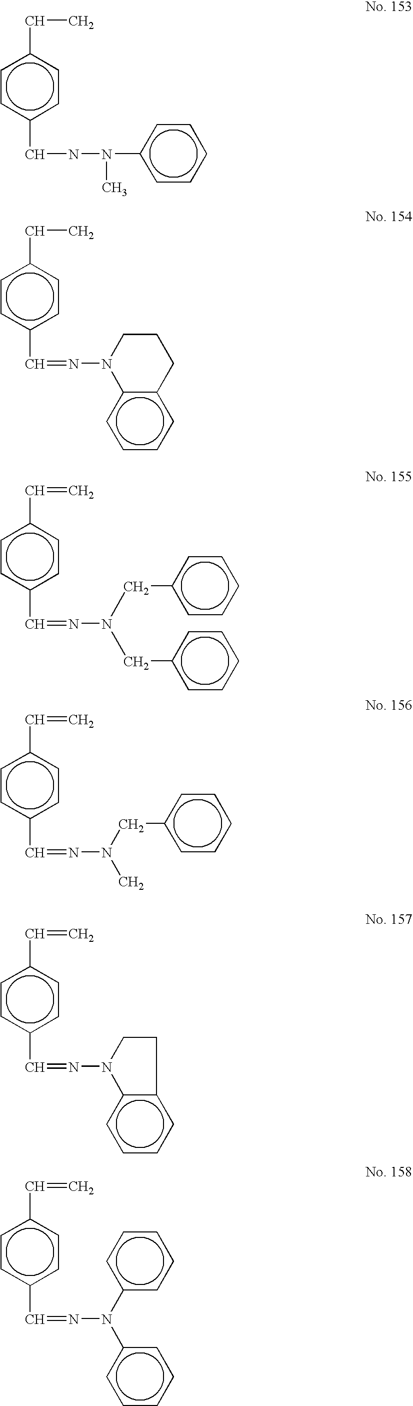

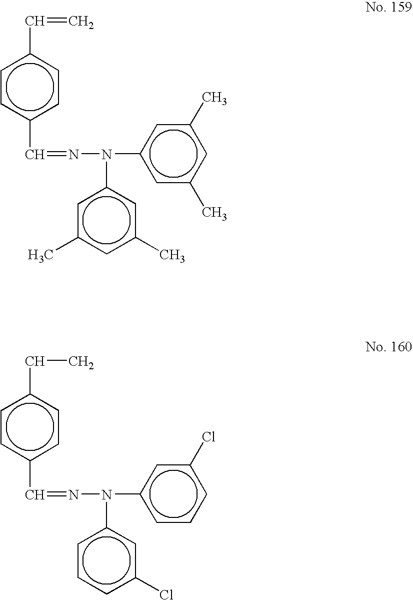

Further, in the present invention, a specific (meth)acrylic acid ester compound having the following formula (4) is preferably used as the monofuctional radical polymerizing compound having a charge transport structure as well:
B₁—Ar₅CH═CH—Ar₆—B₂ (4)
wherein Ar₅ represents a substituted or an unsubstituted monovalent group or bivalent group formed of an aromatic hydrocarbon skeleton. Specific examples of the monovalent group or bivalent group formed of an aromatic hydrocarbon skeleton include monovalent or bivalent groups such as benzene, naphthalene, phenanthrene, biphenyl and 1,2,3,4-tetrahydronaphthalene.

Specific examples of substituents of the aromatic hydrocarbon skeleton include an alkyl group having 1 to 12 carbon atoms, an alkoxy group having 1 to 12 carbon atoms, a benzyl group and a halogen atom. The alkyl group and alkoxy group may further have a halogen atom or a phenyl group as a substituent.

Ar⁶ represents a monovalent group or a bivalent group formed of an aromatic hydrocarbon skeleton or heterocyclic compound skeleton having one or more tertiary amino group. The aromatic hydrocarbon skeleton having a tertiary amino group has the following formula (A): 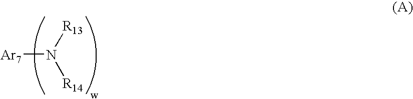
wherein R₁₃ and R₁₄ represent an acyl group, a substituted or an unsubstituted alkyl group, a substituted or an unsubstituted aryl group or a substituted or an unsubstituted alkenyl group; Ar⁷ represents an aryl group; and h represents an integer of from 1 to 3.

Specific examples of the acyl group include an acetyl group, a propionyl group, benzoyl group, etc. Specific examples of the substituted or unsubstituted alkyl group include an alkyl group having 1 to 12 carbon atoms. Specific examples of the substituted or unsubstituted aryl group include a phenyl group, a naphthyl group, a biphenylyl group, a terphenylyl group, pyrenyl group, a fluorenyl group, 9,9-dimethyl- fluorenyl group, azulenyl group, an anthryl group, a triphenylenyl group, a chrysenyl group and groups having the following formulae: 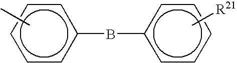
wherein B represents —O—, —S—, —SO—, —SO₂—, —CO— and the following bivalent groups; and R₂₁, represents a hydrogen atom, an alkyl group having 1 to 12 carbon atoms, an alkoxy group, a halogen atom, the above-mentioned substituted or unsubstituted aryl groups, an amino group, a nitro group and a cyano group; 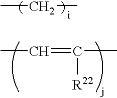
wherein R₂₂ represents a hydrogen atom, an alkyl group having 1 to 12 carbon atoms and the above-mentioned substituted or unsubstituted aryl groups; i represents an integer of from 1 to 12; and j represents an integer of from 1 to 3.

Specific examples of the alkoxy group include a methoxy group, an ethoxy group, a n-propoxy group, an i-propoxy group, a n-butoxy group, an i-butoxy group, a s-butoxy group, a t-butoxy group, a 2-hydroxyethoxy group, 2-cyanoethoxy group, a benzyloxy group, a 4-methylbenzyloxy group, a trifluoromethoxy group, etc.

Specific examples of the halogen atom include a fluorine atom, a chlorine atom, a bromine atom and an iodine atom.

Specific examples of the amino group include a diphenylamino group, a ditolylamino group, a dibenzylamino group, a 4-methylbenzyl group, etc.

Specific examples of the aryl group include a phenyl group, a naphthyl group, a biphenylyl group, a terphenylyl group, pyrenyl group, a fluorenyl group, 9,9-dimethyl-fluorenyl group, azulenyl group, an anthryl group, a triphenylenyl group and a chrysenyl group.

Ar⁷, R₁₃ and R₁₄ may have an alkyl group having 1 to 12 carbon atoms, an alkoxy group and a halogen atom as a substituent.

Specific examples of the heterocyclic compound skeleton having one or more tertiary amino group include heterocyclic compounds having an amine structure such as pyrrole, pyrazole, imidazole, triazole, dioxazole, indole, isoindole, indoline, benzimidazole, benzotriazole, benzoisoxadine, carbazole and phenoxadine. These may have an alkyl group having 1 to 12 carbon atoms, an alkoxy group and a halogen atom as a substituent.

At least B₁ or B₂ is a hydrogen atom, and the other is an acryloyloxy group; a methacryloyloxy group; a vinyl group; an alkyl group having an acryloyloxy group, a methacryloyloxy group or a vinyl group; or an alkoxy group having an acryloyloxy group, a methacryloyloxy group or a vinyl group.

The (meth)acrylic acid ester compound having formula (4) is preferably a compound having the following formula (5): 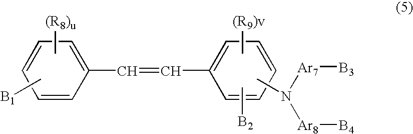
wherein R₈ and R₉ represent a substituted or an unsubstituted alkyl group, a substituted or an unsubstituted alkoxy group and a halogen atom; and Ar₇ and Ar₈ represent a substituted or an unsubstituted aryl group or arylene group, and a substituted or an unsubstituted benzyl group; B₁ to B₄ are the same groups as B₁ and B₂ in the formula (1), and only one of them is present; u represents 0 or an integer of from 1 to 5; and v represents 0 or an integer of from 1 to 4.

The (meth)acrylic acid ester compound having formula (5) has the following characteristics. The (meth)acrylic acid ester compound is a tertiary amine compound having a developed stilbene conjugate structure. Such a charge transport compound having a developed conjugate structure very much improves charge injection at an interface of the crosslinked layer. Further, even when fixed between crosslinked bond, intermolecular interactions are difficult to impair and has good charge transportability. Having a highly radical-polymerizing acryloyloxy group or a methacryloyloxy group, the ester(meth)acrylic acid ester compound quickly gelates when radical-polymerized and does not have an excessive crosslink distortion. The double-bonding of the stilbene conjugate structure partially participates in the polymerization, and less polymerizes than the acryloyloxy group or methacryloyloxy group, which causes a time difference in the crosslinking reaction and the strain is not maximized. In addition, the double-bonding participating in the polymerization can increase the number of crosslinking reactions per a molecular weight, resulting in higher crosslink density. Further, the double-bonding can control the polymerization with the crosslinking conditions, and can easily form a most suitable crosslinked film. Such a reaction can be performed with the ester(meth)acrylate compound of the present invention, but cannot be performed with e.g., an a-phenylstilbene double bonding.

The charge transport compound having a radical polymerizing functional group and formula (4), particularly formula (5), can form a highly-crosslinked film maintaining good electrical properties without being cracked, which prevents particulate materials such as silica from sticking to a photoreceptor and decreases defective white-spotted images.

Specific examples of the charge transport compound having a radical polymerizing functional group and formula (4) include compounds having the following formulae Nos. I to XVII, but are not limited thereto.

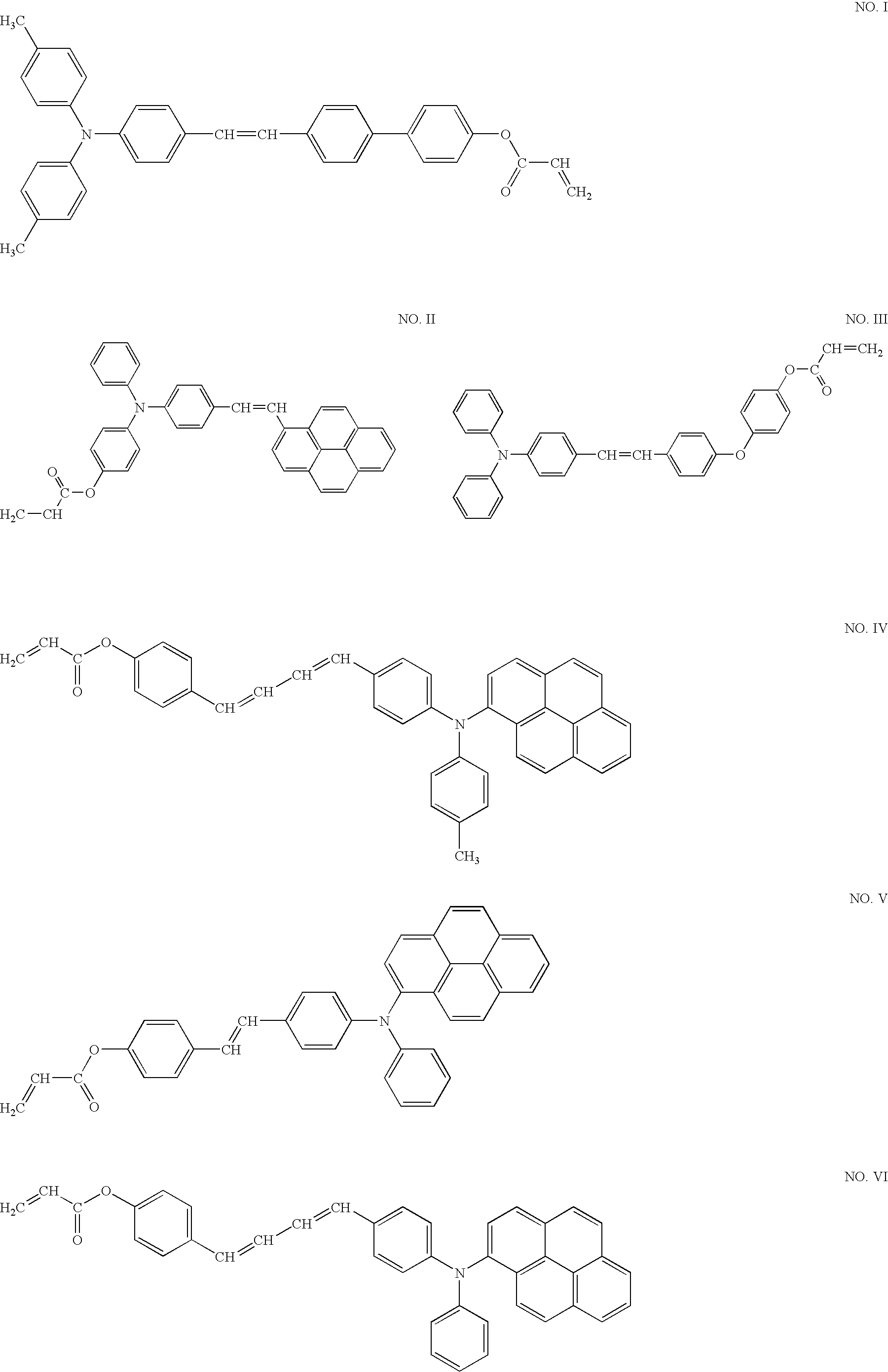

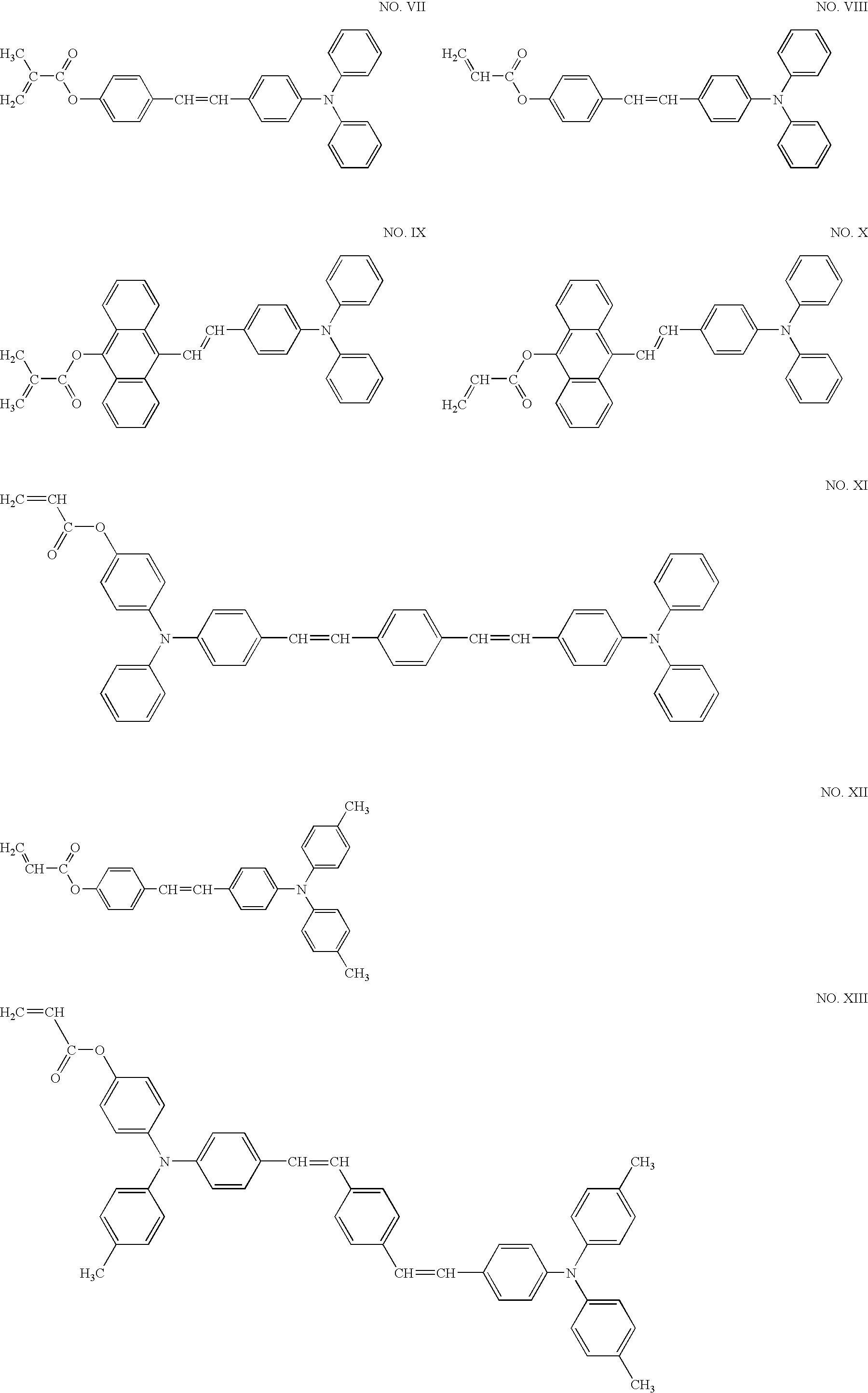

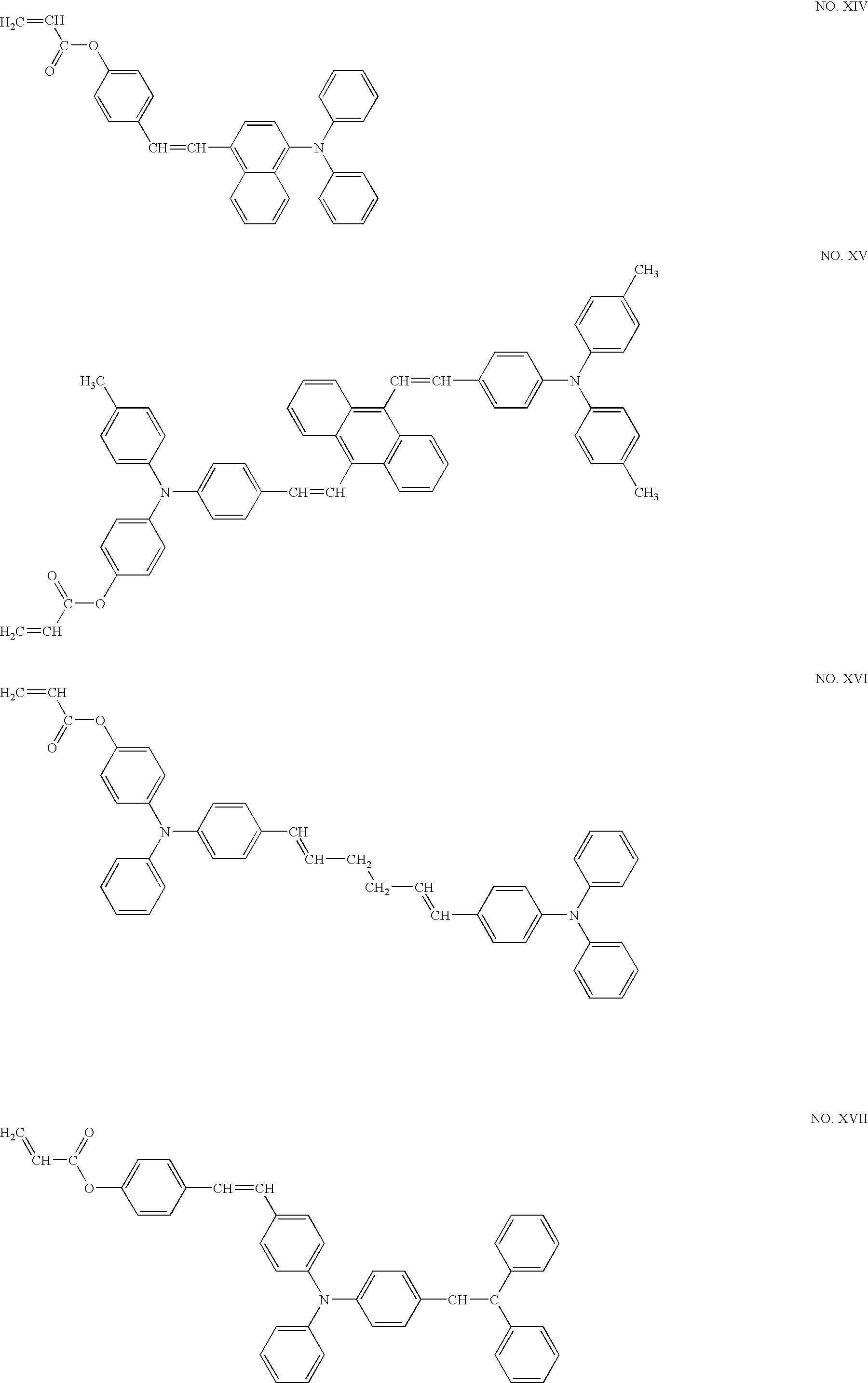

The monofunctional radical polymerizing compound having a charge transporting structure for use in the present invention is essential for imparting a charge transportability to the crosslinked surface layer, and is preferably included therein in an mount of 20 to 80% by weight, and more preferably from 30 to 70% by weight based on total weight thereof. When less than 20% by weight, the crosslinked surface layer cannot maintain the charge transportability, a sensitivity of the resultant photoreceptor deteriorates and a residual potential thereof increases in repeated use. When greater than 80% by weight, a content of the tri- or more functional monomer having no charge transport structure decreases and the crosslinked density deteriorates, and therefore the resultant photoreceptor does not have a high abrasion resistance. Although it depends on a required abrasion resistance and electrical properties, in consideration of a balance therebetween, a content of the monofunctional radical polymerizing compound having a charge transport structure is most preferably from 30 to 70% by weight.

The crosslinked surface layer of the present invention has a peel strength not less than 0.1 N/mm. The peel strength is measure by cutting and peeling at an ultralow-velocity the surface with a single crystal diamond cutting blade having a knife angle of 60°, a rake angle of 20° and a grinding undercut angle of 10°. Specifically, a horizontal force, a perpendicular force and a perpendicular displacement applied to the cutting blade are measured, and the peel strength is determined as a horizontal force applied to the width of the cutting blade. The peel strength is measured at constant temperature and humidity. In the present invention, the peel strength is measured at 22° C. and 55% Rh.

In the present invention, SAICAS DN-20 from DAIPLA WINTES Co., Ltd., having a cutting blade 0.5 mm wide. Any apparatus having similar capability thereto can be used. In the present invention, a photoreceptor of the present invention is properly cut on an aluminum cylinder. The crosslinked surface layer having a peel strength not less than 0.1 N/mm has sufficient adhesiveness to the lower layer without peeling.

A solvent having a saturated vapor pressure not greater than 100 mm Hg/25° C. is preferably used in the present invention in terms of improving the adhesiveness of the crosslinked surface layer. Such a solvent decreases a de-solvent amount when coating the crosslinked surface layer and the surface of the lower layer swells or slightly dissolves. Accordingly, it is supposed that an area having continuity is formed near an interface therebetween, which has no quick physical change. Therefore, the crosslinked surface layer has sufficient adhesiveness. In addition, in the present invention, a solvent slightly present in the crosslinked surface layer promotes the radical reaction therein, resulting in improved uniform hardness thereof. The solvent having a saturated vapor pressure not greater than 100 mm Hg/25° C. does not locally accumulate an internal stress in the crosslinked surface layer and constructs a uniform crosslinked surface layer without distortion. The solvent more preferably has a saturated vapor pressure not greater than 50 mm Hg/25° C., and furthermore preferably has that not greater than 20 mm Hg/25° C. in terms of an amount of the residual solvent in the crosslinked surface layer when formed.

The solvent preferably has a boiling point of from 60 to 150° C. because of being able to form a good interface between the crosslinked surface layer and the lower layer, resulting in sufficient adhesiveness thereof. In consideration of a de-solvent process such as drying by heating, the solvent more preferably has a boiling point of from 100 to 130° C. Further, the solvent preferably has a solubility parameter of from 8.5 to 11.0, and more preferably from 9.0 to 9.7 because of having higher affinity with polycarbonate which is a main component of the lower layer, resulting in sufficient adhesiveness thereof.

Specific examples of the solvent include hydrocarbons such as heptane, octane, trimethylpentane, isooctane, nonane, 2,2,5-trimethylhexane, decane, benzene, toluene, xylene, ethylbenzene, isopropylbenzene, styrene, ethylcyclohexanone and cyclohexanone; alcohols such as methanol, ethanol, 1-propanol, 2-propanol, 1-butanol, 2-butanol, isobutylalcohol, tert-butylalcohol, 1-penatnol, 2-pentanol, 3-pentanol, 2-methyl-1-butanol, tert-pentylalcohol, 3-methyl-1-butanol, 3-methyl-2-butanol, neopentylalcohol, 1-hexanol, 2-methyl-1-pentanol, 4-methyl-2-pentanol, 2-ethyl-1-butanol, 3-heptanol, allylalcohol, propalgyl alcohol, benzylalcohol, cyclohexanol, 1,2-ethanodiol and 1,2-propanediol; phenols such as phenol and cresol; ethers such as dipropylether, diisopropylether, dibutylether, butylvinylether, benzylethylether, dioxane, anisole, phenetol and 1,2-epoxybutane; acetals such as acetal, 1,2-dimethoxyethane and 1,2-diethoxyethane; ketones such as methyl ethyl ketone, 2-penatnone, 2-hexanone, 2-heptanone, diisobutylketone, methyloxide, cyclohexanone, methylcyclohexanone, 4-methyl-2-pentanone, acetylacetone and acetonylacetone; esters such as ethylacetate, propylacetate, butylacetate, pentylacetate, 3-methoxybutylacetate, diethylcarbonate and 2-methoxyethylacetate; halogens such as chlorobenzene; sulfuric compounds such as tetrahydrothiophene; compounds having plural functional groups such as 2-methoxyethanol, 2-ethoxyethanol, furfurylalcohol, tetrahydrofurfurylalcohol, 1-methoxy-2-propanol, 1-ethoxy-2-propanol, diacetonealcohol, furfural, 2-methoxyethylacetate, 2-ethoxyethylacetate, propyleneglycolpropylether and propyleneglycol- 1-monomethylether-2-acetate; etc. Among these solvents, butylacetate, chlorobenzene, acetylacetone, xylene, 2-methoxyethylacetate, propyleneglycol-1-monomethylether-2-acetate and cyclohexanone are preferably used in terms of the adhesiveness. These solvents can be used alone or in combination.

The dilution rate of the solvent is determined as desired according to the solubility of constituents, the coating method and the thickness of a layer. However, the solid contents of the coating liquid is preferably not greater than 25% by weight, and more preferably from 3 to 15% by weight in terms of maintaining an amount of the residual solvent in the crosslinked surface layer when formed and giving the sufficient adhesiveness thereof.

The crosslinked surface layer of the present invention is formed by preparing a solution (coating liquid) including at least a tri- or more functional radical polymerizing monomer having no charge transport structure and a monofunctional radical polymerizing compound having a charge transport structure, coating and drying the solution, and polymerizing and hardening (crosslinking) the solution. Besides these, the coating liquid can include a monofunctional and bifunctional radical polymerizing monomer, a functional monomer and a radical polymerizing oligomer as well to control a viscosity of the surface layer when coated, reduce a stress of thereof, impart a low surface free energy thereto and reduce friction coefficient thereof. Known radical polymerizing monomers and oligomers can be used.

Specific examples of the monofunctional radical monomer include 2-ethylhexylacrylate, 2-hydroxyethylacrylate, 2-hydroxypropylacrylate, tetrahydrofurfurylacrylate, 2-ethylhexylcarbitolacrylate, 3-methoxybutylacrylate, benzylacrylate, cyclohexylacrylate, isoamylacrylate, isobutylacrylate, methoxytriethyleneglycolacrylate, phenoxytetraethyleneglycolacrylate, cetylacrylate, isostearylacrylate, stearylacrylate, styrene monomer, etc.

Specific examples of the bifunctional radical monomer include 1,3-butanediolacrylate, 1,4-butanedioldiacrylate, 1,4-butanedioldimethacrylate, 1,6-hexanedioldiacrylate, 1,6-hexanedioldimethacrylate, diethyleneglycoldiacrylate, neopentylglycoldiacrylate, EO-modified bisphenol A diacrylate, EO-modified bisphenol F diacrylate, etc.

Specific examples of the functional monomers include octafluoropentylacrylate, 2-perfluorooctylethylacrylate, 2-perfluorooctylethylmethacrylate, 2-perfluoroisononyl-ethylacrylate, etc., wherein a fluorine atom is substituted; vinyl monomers having a polysiloxane group having a siloxane repeat unit of from 20 to 70 disclosed in Japanese Patent Publications Nos. 5-60503 and 6-45770, such as acryloylpolydimethylsiloxaneethyl, methacryloylpolydimethylsiloxaneethyl, acryloylpolydimethylsiloxanepropyl, acryloylpolydimethylsiloxanebutyl and diacryloylpolydimethylsiloxanediethyl; acrylate; and methacrylate.

Specific examples of the radical polymerizing oligomer includes epoxyacrylate oligomers, urethaneacrylate oligomers and polyetseracrylate oligomers.

However, when the crosslinked surface layer includes a large amount of the radical polymerizing monomer and radical polymerizing oligomer having one or two functional groups, the three-dimensional crosslinked bonding density thereof substantially deteriorates, resulting in deterioration of the abrasion resistance thereof. Therefore, the surface layer of the present invention preferably includes the monomers and oligomers in an amount not greater than 50 parts by weight, and more preferably not greater than 30 parts by weight per 100 parts by weight of the radical polymerizing monomer having three or more functional groups.

The crosslinked surface layer of the present invention is formed by preparing a solution (coating liquid) including at least a tri- or more functional radical polymerizing monomer having no charge transport structure and a monofunctional radical polymerizing compound having a charge transport structure, coating and drying the solution, and polymerizing and hardening (crosslinking) the solution. The coating liquid may optionally a polymerization initiator such as a heat polymerization initiator and a photo polymerization initiator to effectively proceed the crosslinking reaction.

Specific examples of the heat polymerization initiator include peroxide initiators such as 2,5-dimethylhexane-2,5-dihydrooxide, dicumylperoxide, benzoylperoxide, t-butylcumyl-peroxide, 2,5-dimethyl-2,5-di(peroxybenzoyl)hexyne-3, di-t-butylbeloxide, t-butylhydro-beloxide, cumenehydobeloxide and lauroylperoxide; and azo initiators such as azobisisobutylnitrile, azobiscyclohexanecarbonitrile, azobisisomethylbutyrate, azobisisobutylamidinehydorchloride and 4,4′-azobis-4-cyanovaleric acid.

Specific examples of the photo polymerization initiator include acetone or ketal photo polymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino- 1-(4-molpholinophenyl)butanone- 1 ,2-hydroxy-2-methyl-1-phenylpropane-1-one and 1-phenyl- 1,2-propanedion-2-(o-ethoxycarbonyl)oxime; benzoinether photo polymerization initiators such as benzoin, benzoinmethylether, benzoinethylether, benzoinisobutylether and benzoinisopropylether; benzophenone photo polymerization initiators such as benzophenone, 4-hydroxybenzophenone, o-benzoyl-methylbenzoate, 2-benzoylnaphthalene, 4-benzoylviphenyl, 4-benzoylphenylether, acrylated benzophenone and 1,4-benzoylbenzene; thioxanthone photo polymerization initiators such as 2-isopropylthioxanthone, 2-chlorothioxanthone, 2,4-dimethylthioxanthone, 2,4-diethylthioxanthone and 2,4-dichlorothioxanthone; and other photo polymerization initiators such as ethylanthraquinone, 2,4,6-trimethylbenzoyldiphenylphosphineoxide, 2,4,6-trimethylbenzoyldiphenylethoxyphosphineoxide, bis(2,4,6-trimethyl-benzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds and imidazole compounds. Further, a material having a photo polymerizing effect can be used alone or in combination with the above-mentioned photo polymerization initiators. Specific examples of the materials include triethanolamine, methyldiethanol amine, 4-dimethylaminoethylbenzoate, 4-dimethylaminoisoamylbenzoate, ethyl(2-dimethylamino)benzoate and 4,4-dimethylaminobenzophenone.

These polymerization initiators can be used alone or in combination. The crosslinked surface layer of the present invention preferably includes the polymerization initiators in an amount of 0.5 to 40 parts by weight, and more preferably from 1 to 20 parts by weight per 100 parts by weight of the radical polymerizing compounds.

Further, the coating liquid may optionally include various additives such as plasticizers (to soften a stress and improve adhesiveness thereof), leveling agents and low-molecular-weight charge transport materials without a radical reactivity. Known additives can be used, and specific examples of the plasticizers include plasticizers such as dibutylphthalate and dioctylphthalate used in typical resins. The content thereof is preferably not greater than 20% by weight, and more preferably not greater than 10% based on total weight of solid contents of the coating liquid. Specific examples of the leveling agents include silicone oil such as dimethylsilicone oil and methylphenylsilicone oil; and polymers and oligomers having a perfluoroalkyl group in the side chain. The content thereof is preferably not greater than 3% by weight.

The crosslinked surface layer can be coated by a dip coating method, a spray coating method, a bead coating method, a ring coating method, etc. The spray coating method is preferably used because of being able to control an amount of the residual solvent in the crosslinked surface layer when formed.

In the present invention, after the coating liquid is coated to form a layer, an external energy is applied thereto for hardening the layer to form the crosslinked surface layer. The external energy includes a heat, a light and a radiation. A heat energy is applied to the layer from the coated side or from the substrate using air, a gaseous body such as nitrogen, a steam, a variety of heating media, infrared or an electromagnetic wave. The heating temperature is preferably from 100 to 170° C. When less than 100° C., the reaction is slow in speed and is not completely finished. When greater than 170° C., the reaction nonuniformly proceeds and a large distortion appears in the crosslinked surface layer. To uniformly proceed the hardening reaction, after heated at comparatively a low temperature less than 100° C., the reaction is effectively completed at not less than 100° C. Specific examples of the light energy include UV irradiators such as high pressure mercury lamps and metal halide lamps having an emission wavelength of UV light; and a visible light source adaptable to absorption wavelength of the radical polymerizing compounds and photo polymerization initiators. An irradiation light amount is preferably from 50 to 1,000 mW/cm². When less than 50 mW/cm², the hardening reaction takes time. When greater than 1,000 mW/cm², the reaction nonuniformly proceeds and the crosslinked surface layer has a large surface roughness. The radiation energy includes a radiation energy using an electron beam. Among these energies, the heat and light energies are effectively used because of their simple reaction speed controls and simple apparatuses.

Since the crosslinked surface layer of the present invention has a different thickness depending on a layer structure of a photoreceptor using the crosslinked surface layer, the thickness will be explained according to the following explanations of the layer structures.

The electrophotographic photoreceptor for use in the present invention will be explained, referring to the drawings.

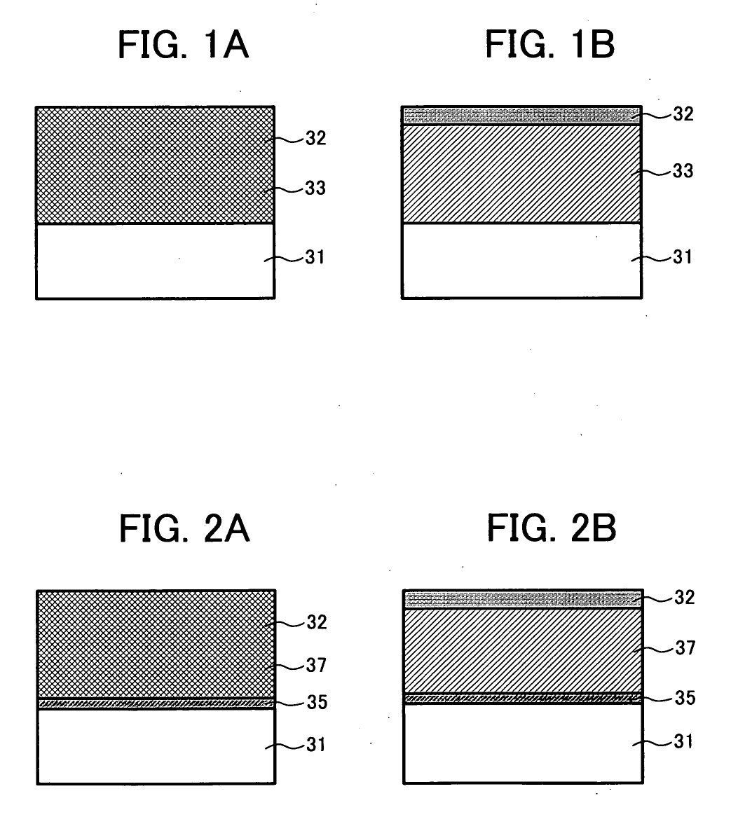

FIGS. 1A and 1B are cross-sectional views of embodiments of layers of the electrophotographic photoreceptor of the present invention, which is a single-layered photoreceptor formed of a photosensitive layer (33) having both a charge generation function and charge transport function and overlying an electroconductive substrate (31). In FIG. 1A, the photosensitive layer is wholly crosslinked and hardened to form a crosslinked surface layer. In FIG. 1B, a crosslinked surface layer (32) is formed on a surface of the photosensitive layer (33).

FIGS. 2A and 2B are cross-sectional views of other embodiments of layers of the electrophotographic photoreceptor of the present invention, which is a multilayered photoreceptor formed of a charge generation layer (35) having a charge generation function and a charge transport layer (37) having a charge transport function, and which are overlying an electroconductive substrate (31). In FIG. 2A, the charge transport layer (37) is wholly crosslinked and hardened to form a crosslinked surface layer. In FIG. 2B, a crosslinked surface layer (32) is formed on a surface of the charge transport layer (37).

Suitable materials for use as the electroconductive substrate (31) include materials having a volume resistance not greater than 10¹⁰Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is deposited or sputtered. In addition, a plate of a metal such as aluminum, aluminum alloys, nickel and stainless steel and a metal cylinder, which is prepared by tubing a metal such as the metals mentioned above by a method such as impact ironing or direct ironing, and then treating the surface of the tube by cutting, super finishing, polishing and the like treatments, can also be used as the substrate. Further, endless belts of a metal such as nickel and stainless steel, which have been disclosed in Japanese Laid-Open Patent Publication No. 52-36016, can also be used as the substrate (31).

Furthermore, substrates, in which a coating liquid including a binder resin and an electroconductive powder is coated on the supporters mentioned above, can be used as the substrate (31).

Specific examples of such an electroconductive powder include carbon black, acetylene black, powders of metals such as aluminum, nickel, iron, Nichrome, copper, zinc, silver and the like, and metal oxides such as electroconductive tin oxides, ITO and the like. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like resins. Such an electroconductive layer can be formed by coating a coating liquid in which an electroconductive powder and a binder resin are dispersed in a solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and TEFLON (registered trademark), with an electroconductive material, can also be preferably used as the substrate (31).

Next, the photosensitive layer will be explained. The photosensitive layer may be a single-layered or a multilayered. The multilayered photosensitive layer is formed of a charge generation layer having a charge generation function and a charge transport layer having a charge transport function. The single-layered photosensitive layer is a layer having both the charge generation function and charge transport function.

Hereinafter, the multilayered photosensitive layer and single-layered photosensitive layer will be explained respectively.

The charge generation layer (CGL) (35) is mainly formed of a charge generation material, and optionally includes a binder resin. Suitable charge generation materials include inorganic materials and organic materials.

Specific examples of the inorganic charge generation materials include crystalline selenium, amorphous selenium, selenium-tellurium alloys, selenium-tellurium-halogen alloys and selenium-arsenic alloys.

Specific examples of the organic charge generation materials include known materials, for example, phthalocyanine pigments such as metal phthalocyanine and metal-free phthalocyanine, azulenium pigments, squaric acid methine pigments, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone pigments, polycyclic quinone pigments, quinoneimine pigments, diphenyl methane pigments, triphenyl methane pigments, benzoquinone pigments, naphthoquinone pigments, cyanine pigments, azomethine pigments, indigoid pigments, bisbenzimidazole pigments and the like materials.

Among these pigments, a phthalocyanine pigment, particularly titanylphthalocyanine having a crystal form comprising main peaks of Bragg (20) at 9.6±0.2°, 24.0±0.2° and 27.2±0.2° in a X-ray diffraction spectrum when irradiated with Cu-Kα ray is effectively used.

These charge generation materials can be used alone or in combination.

Specific examples of the binder resin optionally used in the CGL (35) include polyamide resins, polyurethane resins, epoxy resins, polyketone resins, polycarbonate resins, silicone resins, acrylic resins, polyvinyl butyral resins, polyvinyl formal resins, polyvinyl ketone resins, polystyrene resins, poly-N-vinylcarbazole resins, polyacrylamide resins, and the like resins. These resins can be used alone or in combination. In addition, a charge transport polymer material can also be used as the binder resin in the CGL besides the above-mentioned binder resins. Specific examples thereof include polymer materials such as polycarbonate resins, polyester resins, polyurethane resins, polyether resins, polysiloxane resins and acrylic resins having an arylamine skeleton, a benzidine skeleton, a hydrazone skeleton, a carbazole skeleton, a stilbene skeleton, a pyrazoline skeleton, etc.; and polymer materials having polysilane skeleton.

Specific examples of the former polymer materials include charge transport polymer materials disclosed in Japanese Laid-Open Patent Publications Nos. 01-001728, 01-009964, 01-013061, 01-019049, 01-241559, 04-011627, 04-175337, 04-183719, 04-225014, 04-230767, 04-320420, 05-232727, 05-310904, 06-234838, 06-234839, 06-234840, 06-234839, 06-234840, 06-234841, 06-236051, 06-295077, 07-056374, 08-176293, 08-208820, 08-211640, 08-253568, 08-269183, 09-062019, 09-043883, 09-71642, 09-87376, 09-104746, 09-110974, 09-110976, 09-157378, 09-221544, 09-227669, 09-235367, 09-241369, 09-268226, 09-272735, 09-302084, 09-302085, 09-328539, etc.

Specific examples of the latter polymer materials include polysilylene polymers disclosed in Japanese Laid-Open Patent Publications Nos. 63-285552, 05-19497, 05-70595, 10-73944, etc.

The CGL (35) also can include a low-molecular-weight charge transport material.

The low-molecular-weight charge transport materials include positive hole transport materials and electron transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, diphenoquinone derivatives, etc. These electron transport materials can be used alone or in combination.

Specific examples of the positive hole transport materials include electron donating materials such as oxazole derivatives, oxadiazole derivatives, imidazole derivatives, monoarylamines derivatives, diarylamine derivatives, triarylamine derivatives, stilbene derivatives, a-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, and other known materials. These positive hole transport materials can be used alone or in combination.

Suitable methods for forming the charge generation layer (35) are broadly classified into a vacuum thin film forming method and a solvent dispersion casting method.

Specific examples of the former vacuum thin film forming method include a vacuum evaporation method, a glow discharge decomposition method, an ion plating method, a sputtering method, a reaction sputtering method, CVD (chemical vapor deposition) methods, etc. A layer of the above-mentioned inorganic and organic materials can be formed by these methods.

The casting method for forming the charge generation layer typically includes the following steps:

(1) preparing a coating liquid by mixing one or more inorganic or organic charge generation materials mentioned above with a solvent such as tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate, butyl acetate, etc., optionally with a binder resin and a leveling agent such as a dimethylsilicone oil and methylphenyl silicone oil, and then dispersing the materials with a ball mill, an attritor, a sand mill, beads mill, etc. to prepare a CGL coating liquid;

(2) coating the CGL coating liquid, which is diluted if necessary, on a substrate by a method such as dip coating, spray coating, bead coating and ring coating; and

(3) drying the coated liquid to form a CGL.

The thickness of the CGL is preferably from about 0.01 to about 5 μm, and more preferably from about 0.05 to about 2 μm.

The charge transport layer (CTL) (37) is a layer having a charge transportability, and the crosslinked surface layer (32) of the present invention is effectively used as a CTL. When the crosslinked surface layer (32) is a whole CTL (37), as mentioned above, after a coating liquid including the tri- or more functional radical polymerizing monomer having no charge transporting structure and the monofunctional radical polymerizing compound having a charge transport structure (hereinafter referred to as radical polymerizing compositions) of the present invention is coated on the CGL (35) and is optionally dried to form a coated layer thereon, and an external energy is applied thereto to harden the coated layer to form the crosslinked surface layer.

The crosslinked surface layer preferably has a thickness of from 10 to 30 μm, and more preferably from 10 to 25 μm. When thinner than 10 μm, a sufficient charged potential cannot be maintained. When thicker than 30 μm, a contraction in volume thereof when hardened tends to cause a separation thereof from a lower layer.

When the crosslinked surface layer is formed on a surface of the CTL (37) as shown in FIG. 2B, the CTL (37) is formed by coating a CGL (35) with a coating liquid wherein a charge transport material having a charge transportability and a binder resin are dispersed in a proper solvent to form a coated layer thereon, and drying the coated layer. The crosslinked surface layer is formed by coating the CGL with a coating liquid including the above-mentioned radical polymerizing compositions of the present invention to form a coated layer thereon, and crosslinking and hardening the coated layer with an external energy.

Specific examples of the charge transport materials include electron transport materials, positive hole transport materials and charge transport polymer materials used in the CGL (35). Particularly, the charge transport polymer materials are effectively used to reduce a solution of a lower layer when a surface layer is coated thereon.

The CTL preferably include the charge transport material in an amount of from 20 to 300 parts by weight, and more preferably from 40 to 150 parts by weight per 100 parts by weight of the binder resin. However, the charge transport polymer material can be used alone or in combination with the binder resin.

Specific examples of the binder resins include thermoplastic or thermosetting resins such as a polystyrene resin, a styrene-acrylonitrile copolymer, a styrene-butadiene copolymer, a styrene-maleic anhydride copolymer, a polyester resin, a polyvinylchloride resin, a vinylchloride-vinylacetate copolymer, a polyvinylacetate resin, a polyvinylidenechloride resin, a polyarylate resin, a phenoxy resin, a polycarbonate resin, a cellulose acetate resin, an ethylcellulose resin, a polyvinylbutyral resin, a polyvinylformal resin, a polyvinyltoluene resin, a poly-N-vinylcarbazole resin, an acrylic resin, a silicone resin, an epoxy resin, a melamine resin, a urethane resin, a phenol resin and an alkyd resin.

Specific examples of a solvent used for coating the CTL (37) shown in FIG. 2B include the solvents used for coating the CGL, and particularly the solvents solving the charge transport material and binder resin well are preferably used. These solvents can be used alone or in combination. The CTL can be formed by the same coating methods used for coating the CGL (35).

The CTL (37) shown in FIG. 2B may optionally include a plasticizer and a leveling agent.

Specific examples of the plasticizers include plasticizers for typical resins, such as dibutylphthalate and dioctylphthalate, and a content thereof is preferably from 0 to 30 parts by weight per 100 parts by weight of the binder resin.

Specific examples of the leveling agents include silicone oil such as dimethyl silicone oil and methylphenyl silicone oil; and polymers or oligomers having a perfluoroalkyl group in the side chain, and a content thereof is preferably from 0 to 1 part by weight per 100 parts by weight of the binder resin.

The CTL (37) shown in FIG. 2B preferably has a thickness of from 5 to 40 μm, and more preferably from 10 to 30 μm.

When the crosslinked surface layer (32) shown in FIG. 2B overlies the CTL (37), as mentioned in the method of forming a crosslinked surface layer, a coating liquid including the radical polymerizing compositions of the present invention is coated on the CTL and optionally dried to form a coated layer thereon, and an external energy is applied thereto to harden the coated layer to form the crosslinked surface layer thereon. The crosslinked surface layer preferably has a thickness of from 1 to 20 μm, and more preferably from 2 to 10 μm. When thinner than 1 μm, uneven thickness thereof causes uneven durability thereof. When thicker than 20 μm, a total thickness of the CTL (37) and crosslinked surface layer (32) is so thick that charges are scattered, resulting in deterioration of image reproducibility of the resultant photoreceptor. In addition, the crosslinked surface layer of the present invention is more preferably formed by in order of coating, irradiating (crosslinking) and drying than coating, drying and irradiating (crosslinking). This is partly because a solvent decreases when drying is prior to irradiating (crosslinking) and the viscosity increases to prevent the crosslinking reaction, and partly because a polymerization initiator possibly sublimes when dried.

As shown in FIG. 1A, the single-layered photosensitive layer has both a charge generation function and a charge transport function, and the crosslinked surface layer having a charge transporting structure and including a charge generation material having a charge generating function of the present invention is effectively used as a single-layered photosensitive layer. As mentioned in the casting method of forming the CGL (35), a charge generation material is dispersed in a coating liquid including the radical polymerizing compositions, and the coating liquid is coated on an electroconductive substrate and optionally dried to form a coated layer thereon, then a hardening reaction is performed in the coated layer with an external energy to form the crosslinked surface layer. The charge generation material may previously be dispersed in a solvent to prepare a dispersion, and the dispersion may be added into the coating liquid for forming the crosslinked surface layer. The crosslinked surface layer preferably has a thickness of from 10 to 30 μm, and more preferably from 10 to 25 μm. When thinner than 10 μm, a sufficient charged potential cannot be maintained. When thicker than 30 μm, a contraction in volume thereof when hardened tends to cause a separation thereof from an undercoat layer.

As shown in FIG. 1B, when the crosslinked surface layer overlies a single-layered photosensitive layer (33), as mentioned in the method of forming a crosslinked surface layer, a coating liquid including the radical polymerizing compositions of the present invention and a binder resin is coated on the photosensitive layer and optionally dried to form a coated layer thereon, and an external energy is applied thereto to harden the coated layer to form the crosslinked surface layer thereon. The crosslinked surface layer preferably has a thickness of from 1 to 20 μm, and more preferably from 2 to 10 μm. When thinner than 1 μm, uneven thickness thereof causes uneven durability thereof.

The single-layered photosensitive layer preferably includes a charge generation material in an amount of from 1 to 30% by weight, a binder resin of from 20 to 80% by weight and a charge transport material of from 10 to 70 parts by weight based on total weight thereof.

The photoreceptor of the present invention can have an intermediate layer between a crosslinked surface layer and a photosensitive layer when the crosslinked surface layer overlies the layer. The intermediate layer prevents components of the lower photosensitive layer from mixing in the crosslinked surface layer to avoid a hardening reaction inhibition and concavities and convexities thereof. In addition, the intermediate layer can improve the adhesiveness between the crosslinked surface layer and photosensitive layer.

The intermediate layer includes a resin as a main component. Specific examples of the resin include polyamides, alcohol-soluble nylons, water-soluble polyvinyl butyral, polyvinyl butyral, polyvinyl alcohol, etc. The intermediate layer can be formed by one of the above-mentioned known coating methods. The intermediate layer preferably has a thickness of from 0.05 to 2 μm.

The photoreceptor of the present invention may have an undercoat between the substrate (31) and photosensitive layer. The undercoat layer includes a resin as a main component. Since a photosensitive layer is typically formed on the undercoat layer by coating a liquid including an organic solvent, the resin in the undercoat layer preferably has good resistance to general organic solvents. Specific examples of such resins include water-soluble resins such as polyvinyl alcohol resins, casein and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like. The undercoat layer may include a fine powder of metal oxides such as titanium oxide, silica, alumina, zirconium oxide, tin oxide and indium oxide to prevent occurrence of moire in the recorded images and to decrease residual potential of the photoreceptor.

The undercoat layer can also be formed by coating a coating liquid using a proper solvent and a proper coating method similarly to those for use in formation of the photosensitive layer mentioned above. The undercoat layer may be formed using a silane coupling agent, titanium coupling agent or a chromium coupling agent. In addition, a layer of aluminum oxide which is formed by an anodic oxidation method and a layer of an organic compound such as polyparaxylylene (parylene) or an inorganic compound such as SiO, SnO₂, TiO₂, ITO or CeO₂ which is formed by a vacuum evaporation method is also preferably used as the undercoat layer. Besides these materials, known materials can be used. The thickness of the undercoat layer is preferably from 0 to 5 μm.

In the present invention, an antioxidant can be included in each of the layers, i.e., the crosslinked surface layer, charge generation layer, charge transport layer, undercoat layer and intermediate layer to improve the stability to withstand environmental conditions, namely to avoid decrease of photosensitivity and increase of residual potential.

Each of the layers preferably includes the antioxidant in an amount of from 0.01 to 10% by weight based on total weight thereof.

Specific examples of the antioxidant for use in the present invention include the following compound.

(1) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, tocophenol compounds, etc.

(2) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

(3) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

(4) Organic Sulfur-Containing Compounds

Dilauryl-3,3′-thiodipropionate, distearyl-3,3′-thiodipropionate, ditetradecyl-3,3′-thiodipropionate, etc.

(5) Organic Phosphorus-Containing Compounds

Triphenylphosphine, tri(nonylphenyl)phosphine, tri(dinonylphenyl)phosphine, tricresylphosphine, tri(2,4-dibutylphenoxy)phosphine, etc.

These compounds are known as antioxidants for rubbers, plastics, fats, etc., and marketed products thereof can easily be obtained.

In the layer composition shown in FIG. 2, an adhesive layer may be formed between the crosslinked surface layer and the photosensitive layer.

The adhesive layer preferably includes a radical polymerizing compound having a viscosity of from 1 to 20 mPa·s at 25° C. and no charge transport structure because of preventing the separation and abrasion of the surface layer and improving the durability thereof.

When means for improving the adhesiveness is not formed therebetween, the surface layer contracts when a three-dimensional network is developed therein and has a very large inner stress. Therefore, when the surface layer is internally abraded, the surface layer has a crack and separates from the photosensitive layer, resulting in quick abrasion.

The adhesive layer improves the adhesiveness between the surface layer and the photosensitive layer, which is lowered due to the highly-hardened surface layer. The adhesive layer is formed by coating a coating liquid including the binder resin, the tri- or more functional radical polymerizing monomer having no charge transport structure and a radical polymerizing compound having a viscosity of from 1 to 20 mPa·s at 25° C. and no charge transport structure, and optionally the monofunctional radical polymerizing compound having a charge transport structure used in the above-mentioned photosensitive layer on a photosensitive layer; coating the surface layer coating liquid; and hardening both of the coating liquids with light energy.

Specific examples of solvents for preparing the coating liquid include alcohols such as methanol, ethanol, propanol and butanol; ketones such as acetone, methyl ethyl ketone, methyl isobutyl ketone and cyclohexanone; esters such as ethyl acetate and butyl acetate; ethers such as tetrahydrofuran, dioxane and propylether; halogens such as dichloromethane, dichloroethane, trichloroethane and chlorobenzene; aromatics such as benzene, toluene and xylene; and Cellosolves such as methyl Cellosolve, ethyl Cellosolve and Cellosolve acetate. These solvents can be used alone or in combination.

The mechanism of combining the surface layer and the photosensitive layer of the adhesive layer of the present invention is not clarified, but is thought to be as follows.

The adhesive layer of the present invention is formed by with a coating liquid including a radical polymerizing compound having a low viscosity and no charge transport structure. Namely, the radical polymerizing compound having a low viscosity is a kind of solvents, and when adhering to the surface of a CTL, the radical polymerizing compound migrates in the CTL while dissolving the CTL. Meanwhile, the surface layer includes a tri- or more functional radical polymerizing monomer having no charge transport structure to have abrasion resistance. The tri- or more functional radical polymerizing monomer has high viscosity and does not sufficiently permeates the CTL. However, when crosslinked with the adhesive layer migrating in the CTL, an anchor effect into the CTL is obtained and the surface layer is thought to be firmly bonded with the CTL.

When the radical polymerizing compound has a viscosity less than 1 mPa·s at 25° C., the fluidity thereof is so high that the adhesive layer is not uniformly formed, resulting in nonuniform adhesiveness. When higher than 20 mPa·s, the radical polymerizing compound does not migrates in the CTL, resulting in insufficient adhesive strength.

The radical polymerizing compound is preferably bifunctional. When monofunctional, the bonding site is so few that the adhesive capability is insufficient. When tri- or more functional, the viscosity is so high that the radical polymerizing compound does not sufficiently permeates the CTL, resulting in insufficient adhesiveness.

Specific examples of the radical polymerizing compound having a viscosity of from 1 to 20 mPa·s at 25° C. and no charge transport structure include 1,6-hexanedioldiacrylate, 2-(2-ethoxyethoxy)ethylacrylate, tetrahydrofurfurylacrylate, laurylacrylate, 2-phenoxyethylacrylate, isodecylacrylate, isooctylacrylate, tridecylacrylate, 1,3-butanediolacrylate, 1,4-butanediolacrylate, tetraethyleneglycoldiacrylate, triethyleneglycoldiacrylate, propoxylated neopentylglycoldiacrylate, ethoxylated neopentylglycoldiacrylate, tetrahydrofurfurylmethacrylate, cyclohexylmethacrylate, isodecylmethacrylate, laurylmethacrylate, 2-phenoxyethylmethacrylate, tridecylmethacrylate, triethyleneglycoldimethacrylate, ethyleneglycoldimethacrylate, tetraethyleneglycoldimethacrylate, 1,4-butanediolmethacrylate, diethyleneglycoldimethacrylate, 1,6-hexanedioldimethacrylate, neopentylglycoldimethacrylate, 1,3-butyleneglycoldimethacrylate, etc. These can be used alone or in combination.

The adhesive layer preferably includes the monofunctional radical polymerizing compound having a charge transport structure in an mount of from 20 to 80% by weight, and more preferably from 30 to 70% by weight in terms of having charge transportability. When less than 20% by weight, the adhesive layer does not maintain charge transportability, resulting in deterioration of the sensitivity due to repeated use and of electrical properties such as increase of the residual potential of the resultant photoreceptor. When greater than 80% by weight, the radical polymerizing compound having no charge transport structure decreases, resulting in deterioration of the adhesive strength.

When the adhesive layer is formed (crosslinked), a polymerization initiator used in the surface layer may optionally be used in the adhesive layer as well to efficiently proceed the crosslinking reaction. The polymerization initiators can be used alone or in combination. The content thereof is preferably is preferably from 0.5 to parts by weight, and more preferably from 1 to 20 parts by weight per 100 parts by weight of the radical polymerizing compounds.

The adhesive layer is preferably present between the surface layer and the photosensitive layer without an interface. As a SEM cross-sectional photograph of the photoreceptor mentioned later in Example shows, binder resins included in each layer are non-uniformly soluble with each other and interfaces among the layers are not apparently identified.

FIG. 5 is a schematic view illustrating a cross-section of a fourth embodiment of the electrophotographic photoreceptor of the present invention, which is a single-layered photoreceptor including a photosensitive layer 233 having both charge generatability and charge transportability on a substrate 231. Numeral 238 is an adhesive layer and 239 is a surface layer.

FIG. 6 is a schematic view illustrating a cross-section of a fifth embodiment of the electrophotographic photoreceptor of the present invention, which is a multilayered photoreceptor including a charge generatable CGL 235 and a charge transportable CTL 237 on a substrate 231. Numeral 238 is an adhesive layer and 239 is a surface layer.

The adhesive layer preferably includes at least a binder resin and a tri- or more functional radical polymerizing monomer having no charge transport structure. Besides, a monofunctional or a bifunctional radical polymerizing compound having a charge transport structure can also be used.

Specific examples of the binder resins include thermoplastic or thermosetting resins such as a polystyrene resin, a styrene-acrylonitrile copolymer, a styrene-butadiene copolymer, a styrene-maleic anhydride copolymer, a polyester resin, a polyvinylchloride resin, a vinylchloride-vinylacetate copolymer, a polyvinylacetate resin, a polyvinylidenechloride resin, a polyarylate resin, a phenoxy resin, a polycarbonate resin, a cellulose acetate resin, an ethylcellulose resin, a polyvinylbutyral resin, a polyvinylformal resin, a polyvinyltoluene resin, a poly-N-vinylcarbazole resin, an acrylic resin, a silicone resin, an epoxy resin, a melamine resin, a urethane resin, a phenol resin and an alkyd resin. These can be used. alone or in combination. Among these resins, in terms of compatibility with the binder resin in the photosensitive layer, the same binder resin used therein is preferably used. Particularly, a polycarbonate resin is preferably used.

The mixing ratio (binder resin/radical polymerizing compound) of the binder resin to the radical polymerizing compounds in the adhesive layer is preferably from 90/10 to 10/90, and more preferably from 70/30 to 30/70. When the mixing ratio of the binder resin is too high, the binder resin migrates into the surface layer and the hardness thereof lowers, resulting in quicker abrasion thereof. When too low, the surface layer tends to separate from the adhesive layer.

The adhesive layer is formed by a dip coating method, a spray coating method, a ring coating method, a roll coating method, a nozzle coating method, a screen printing method, etc. The spray coating method and the ring coating method are preferably used in terms of stability of formation and quality.

The adhesive layer preferably has a thickness of from 0.05 to 5 μm, and more preferably from 0.1 to 3 μm. When less than 0.05 μm, the surface layer possibly separates from the photosensitive layer. When thicker than 5 μm, the surface potential of the photoreceptor after irradiated increases, resulting in deterioration of image density.

Next, the image forming method and image forming apparatus of the present invention will be explained in detail, referring to the drawings.

The image forming method and image forming apparatus of the present invention include a photoreceptor having a smooth transporting crosslinked surface layer having a low surface energy, wherein the photoreceptor is charged and irradiated with a light including image information to form an electrostatic latent image thereon; the electrostatic latent image is developed to form a toner image; the toner image is transferred onto an image bearer (transfer sheet) and fixed thereon; and a surface of the photoreceptor is cleaned.

The process is not limited thereto in such a method as to directly transfer an electrostatic latent image onto a transfer sheet and develop the electrostatic latent image thereon.

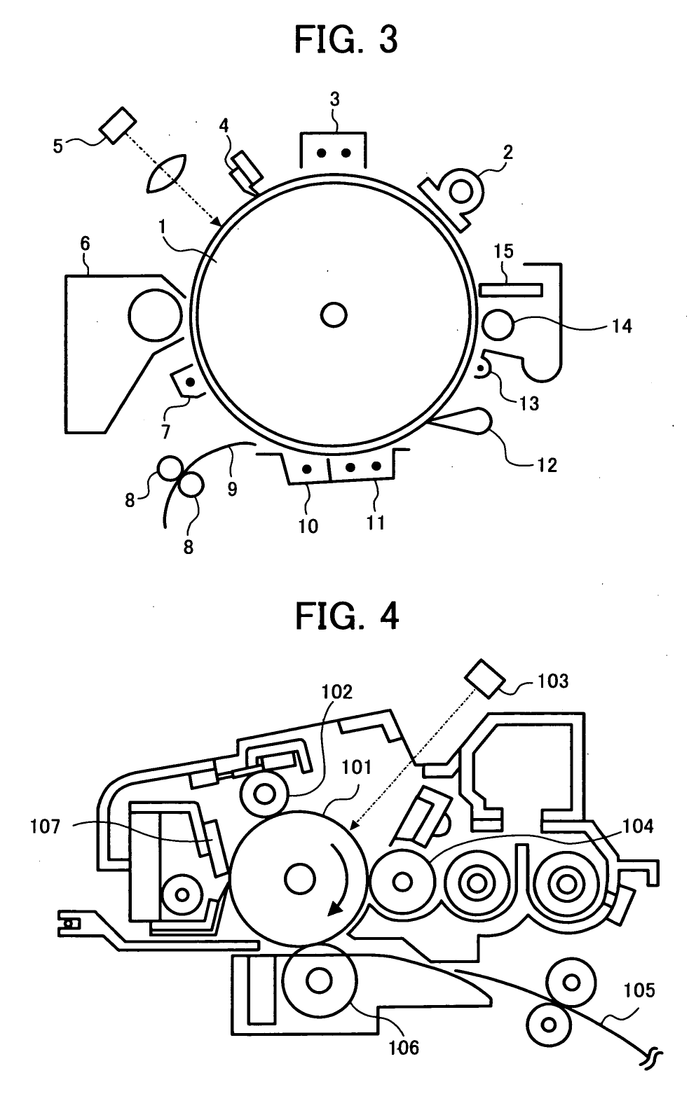

FIG. 3 is a schematic view illustrating a partial cross-section of an embodiment of the image forming apparatus of the present invention. A charger (3) is used to uniformly charge a photoreceptor (1). Specific examples of the charger include known chargers such as corotron devices, scorotron device, solid state chargers, needle electrode devices, roller charging devices and electroconductive brush devices.

Contact chargers or non-contact chargers can be used in the present invention. The contact chargers include a charging roller, a charging brush, a charging blade, etc. directly contacting a photoreceptor. The non-contact chargers include, e.g., a charging roller located close to a photoreceptor with a gap not longer than 200 μm therebetween. When the gap is too long, the photoreceptor is not stably charged. When too short, the charging member, e.g., a charging roller is contaminated with a toner remaining on the photoreceptor. Therefore, the gap preferably has a length of from 10 to 200 μm, and more preferably from 10 to 100 μm.

Next, an irradiator (5) including image information is used to form an electrostatic latent image on the photoreceptor (1). Suitable light sources thereof include typical light emitters such as fluorescent lamps, tungsten lamps, halogen lamps, mercury lamps, sodium lamps, light emitting diodes (LEDs), laser diodes (LDs), light sources using electroluminescence (EL), etc. In addition, to obtain light having a desired wave length range, filters such as sharp-cut filters, band pass filters, near-infrared cutting filters, dichroic filters, interference filters and color temperature converting filters can be used.

Next, a developing unit (6) is used to visualize an electrostatic latent image formed on the photoreceptor (1).

The developing methods include a one-component developing method and a two-component developing method using a dry toner; and a wet developing method using a wet toner. When the photoreceptor positively or negatively charged is exposed to a light including image information, an electrostatic latent image having a positive or negative charge is formed on the photoreceptor. When the latent image having a positive charge is developed with a toner having a negative charge, a positive image can be obtained. In contrast, when the latent image having a positive charge is developed with a toner having a positive charge, a negative image can be obtained.

Next, a transfer charger (10) is used to transfer a toner image visualized on the photoreceptor onto a transfer sheet (9). A pre-transfer charger (7) may be used to perform the transfer better. Suitable transferers include a transferer charger, an electrostatic transferer using a bias roller, an adhesion transferer, a mechanical transferer using a pressure and a magnetic transferee. The above-mentioned chargers can be used for the electrostatic transferee.

Next, a separation charger (11) and a separation pick (12) are used to separate the transfer sheet (9) from the photoreceptor (1). Other separation means include an electrostatic absorption induction separator, a side-edge belt separator, a tip grip conveyor, a curvature separator, etc. The above-mentioned chargers can be used for the separation charger (11).

Next, a fur brush (14) and a cleaning blade (15) are used to remove a toner left on the photoreceptor after transferred therefrom. A pre-cleaning charger (13) may be used to perform the cleaning more effectively. Other cleaners include a web cleaner, a magnet brush cleaner, etc., and these cleaners can be used alone or in combination.

Next, a discharger is optionally used to remove a latent image in the photoreceptor. The discharger includes a discharge lamp (2) and a discharger, and the above-mentioned light sources and chargers can be used respectively.

Reference number 4 in FIG. 3 refers to an eraser trimming unnecessary parts of an electrostatic latent image. Reference number 8 is a pair of resist rollers sandwiching a receiving material.

Known means can be used for other an original reading process, a paper feeding process, a fixing process, a paper delivering process, etc.

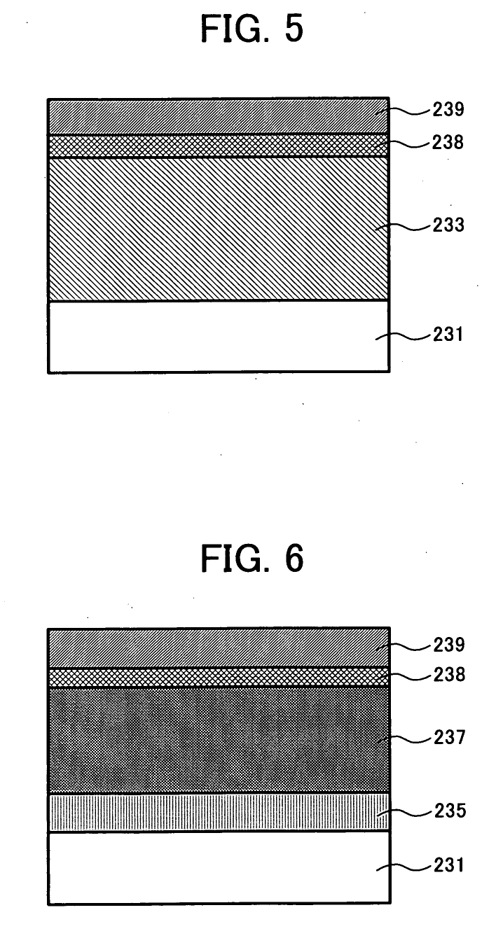

The above-mentioned image forming unit may be fixedly set in a copier, a facsimile or a printer. However, the image forming unit may be detachably set therein as a process cartridge. FIG. 4 is a schematic view illustrating a cross-section of an embodiment of the process cartridge for the image forming apparatus of the present invention.

The process cartridge means an image forming unit (or device) which includes a photoreceptor (101) and at least one of a charger (102), an image developer (104), a transferer (106), a cleaner (107) and a discharger (not shown).

While the photoreceptor (101) rotates in a direction indicated by an arrow, the photoreceptor (101) is charged by the charger (102) and irradiated by an irradiator (103) to form an electrostatic latent image relevant to a light including image information thereon. The electrostatic latent image is developed by the image developer (104) with a toner to form a form a toner image, and the toner image is transferred by the transferer (106) onto a transfer sheet (105) to be printed out. Next, a surface of the photoreceptor after the toner image is transferred is cleaned by the cleaner (107), discharged by a discharger (not shown) and these processes are repeated again.

As is apparent from the explanations mentioned above, the electrophotographic photoreceptor of the present invention can widely be used in electrophotography applied fields such as a laser beam printer, a CRT printer, a LED printer, a liquid crystal printer and a laser engraving.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Synthesis Example of a Monofunctional Radical Polymerizing Compound Having a Charge Transport Structure

The compound having a charge transporting structure of the present invention is synthesized by, e.g., a method disclosed in Japanese Patent No. 3164426. The following method is one of the examples thereof.

(1) Synthesis of a Hydroxy Group Substituted Triarylamine Compound Having the Following Formula B

113.85 g (0.3 mol) of a methoxy group substituted triarylamine compound having the formula A, 138 g (0.92 mol) of sodium iodide and 240 ml of sulfolane were mixed to prepare a mixture. The mixture was heated to have a temperature of 60° C. in a nitrogen stream. 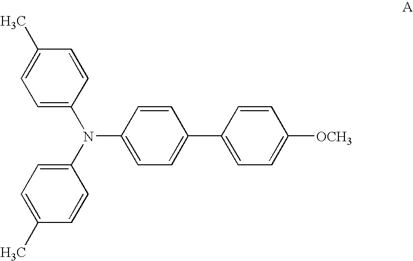
99 g (0.91 mol) of trimethylchlorosilane were dropped therein for 1 hr and the mixture was stirred for 4 hrs at about 60° C. About 1.5 L of toluene were added thereto and the mixture was cooled to have a room temperature, and repeatedly washed with water and an aqueous solution of sodium carbonate. Then, a solvent removed therefrom and refined by a column chromatographic process using silica gel as an absorption medium, and toluene and ethyl acetate (20-to-1) as a developing solvent. Cyclohexane was added to the thus prepared buff yellow oil to separate a crystal out. Thus, 88.1 g (yield of 80.4%) of a white crystal having the following formula B and a melting point of from 64.0 to 66.0° C. was prepared.

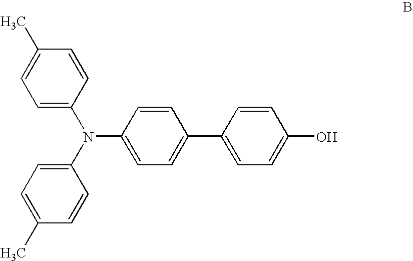

Elemental Analysis Value (%)

| | C | H | N |
|---|---|---|---|
| Found value | 85.06 | 6.41 | 3.73 |
| Calculated value | 85.44 | 6.34 | 3.83 |

(2) A triarylamino Group Substituted Acrylate Compound Compound No. 54 in Table 1)

82.9 g (0.227 mol) of the hydroxy group substituted triarylamine compound having the formula B prepared in (1) were dissolved in 400 ml of tetrahydrofuran to prepare a mixture, and an aqueous solution of sodium hydrate formed of 12.4g of NaOH and 100 mil of water was dropped therein in a nitrogen stream. The mixture was cooled to have a temperature of 5° C., and 25.2 g (0.272 mol) of chloride acrylate was dropped therein for 40 min. Then, the mixture was stirred at 5° C. for 3 hrs. The mixture was put in water and extracted with toluene. The extracted liquid was repeatedly washed with water and an aqueous solution of sodium carbonate. Then, a solvent removed therefrom and refined by a column chromatographic process using silica gel as an absorption medium and toluene as a developing solvent. N-hexane was added to the thus prepared colorless oil to separate a crystal out. Thus, 80.73 g (yield of 84.8%) of a white crystal of the compound No. 54 having a melting point of from 117.5 to 119.0° C. was prepared.

Elemental Analysis Value (%)

| | C | H | N |
|---|---|---|---|
| Found value | 83.13 | 6.01 | 3.16 |
| Calculated value | 83.02 | 6.00 | 3.33 |

(3) Synthesis Example of an Acrylic Acid Ester Compound
(i) Preparation of diethyl 2-hydroxybenzylphosphonate

38.4 g of 2-hydroxybenzylalcohol from TOKYO KASEI KOGYO Co., Ltd. and 80 ml of o-xylene were put in a reaction reservoir having a mixer, a thermometer and a dropping funnel. Under a nitrogen stream, 62.8 g of triethyl phosphite were slowly dropped therein at 80° C. and the reaction therein is further performed for 1 hr at the same temperature. Then, the produced ethanol, o-xylene and unreacted triethyl phosphite were removed from the reaction by reduced-pressure distillation to prepare 66 g of 2-diethylhydroxy-benzylphosphonate at a yield of 90%, having a boiling point of 120.0° C./1.5 mm Hg.

(ii) Preparation of 2-hydroxy-4′-(di-para-tolylamino)stilbene

14.8 g of kalium-tert-butoxide and 50 ml of tetrahydrofuran were put in a reaction reservoir having a mixer, a thermometer and a dropping funnel. Under a nitrogen stream, a solution wherein 9.90 g of the diethyl 2-hydroxybenzylphosphonate and 5.44 g of 4-(di-para-tolylamino)benzaldehyde were dissolved in tetrahydrofuran was slowly dropped therein at a room temperature, and the reaction therein is further performed for 2 hrs at the same temperature. Then, water was added therein while cooling the reaction product with water, a hydrochloric acid solution having a normal concentration of 2 was added therein to acidify the reaction product, and the tetrahydrofuran was removed by an evaporator to extract a crude product with toluene. The toluene phase was washed with water, a sodium hydrogen carbonate solution and a saturated saline in this order, and magnesium sulfate was further added thereto to dehydrate the toluene phase. After filtered, the toluene was removed therefrom to prepare an oily crude product, and the oily crude product was further column-refined with silica gel to crystallize 5.09 g of 2-hydroxy-4′-(di-para-tolylamino)stilbene in hexane at a yield of 72%, having a boiling point of 136.0 to 138.0° C.

(iii) Preparation of 4′-(di-para-tolylamino)stilbene-2-ylacrylate

14.9 g of the 2-hydroxy-4′-(di-para-tolylamino)stilbene. 100 ml of tetrahydrofuran and 21.5 g of sodium hydrogen carbonate solution having a concentration of 12% were put in a reaction reservoir having a mixer, a thermometer and a dropping funnel. Under a nitrogen stream, 5.17 g of chloride acrylate was dropped therein for 30 min at 5° C., and the reaction therein is further performed for 3 hrs at the same temperature. The reaction liquid was put in water, extracted with toluene, condensed and column-refined with silica gel to prepare a crude product. The crude product was recrystallized with ethanol to prepare 13.5 g of a yellow needle crystal 4′-(di-para-tolylamino)stilbene-2-ylacrylate (Exemplified Compound No. 2) at a yield of 79.8%, having a boiling point of 104.1 to 105.2° C. The elemental analysis thereof is as follows.

Elemental Analysis Value (%)

| | C | H | N |
|---|---|---|---|
| Found value | 83.46 | 6.06 | 3.18 |
| Calculated value | 83.57 | 6.11 | 3.14 |

### Example 1

An undercoat coating liquid, a charge generation coating liquid and charge transport coating liquid, which have the following formulations, were coated and dried in this order on an aluminum cylinder having a diameter of 30 mm to form an undercoat layer 3.5 μm thick, a CGL 0.2 μm thick, a CTL 23 μm thick thereon.

| Undercoat layer coating liquid | |
|---|---|
| Alkyd resin(BEKKOZOL 1307-60-EL from Dainippon Ink & Chemicals, Inc.) | 6 |
| Melamine resin(SUPER BEKKAMIN G-821-60 from Dainippon Ink & Chemicals, Inc.) | 4 |
| Titanium dioxide powder | 40 |
| Methyl ethyl ketone | 50 |
| CGL coating liquid | |
| Polyvinyl butyral (XYHL from Union Carbide Corp.) | 0.5 |
| Cyclohexanone | 200 |
| Methyl ethyl ketone | 80 |
| Bisazo pigment having the following formula (I): | 2.5 |

| | |
|---|---|
| | (I) |
| 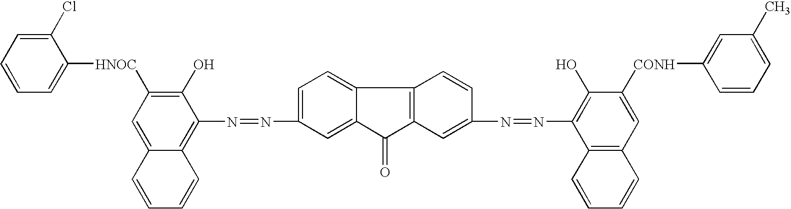 | |

| | |
|---|---|
| CTL coating liquid | |
| Bisphenol Z Polycarbonate(Panlite TS-2050 from TEIJIN CHEMICALS LTD.) | 10 |
| Tetrahydrofuran | 100 |
| 1% tetrahydrofuran solution of silicone oil(KF50-100CS from Shin-Etsu Chemical Industry Co., Ltd.) | 0.2 |
| Charge transport material having the following formula (II): | 7 |

| | |
|---|---|
| | (II) |
| 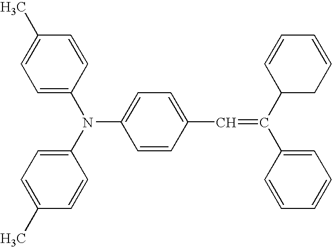 | |

The CTL was further coated with a crosslinked surface layer coating liquid having the following formulation by a spray coating method.

Crosslinked surface layer coating liquid

| | |
|---|---|
| Tri- or more functional | 10 |
| radical polymerizing monomer having | |
| no charge transport structure | |
| Trimethylolpropanetriacrylate | |
| having a molecular weight of 296 | |
| (KAYARAD TMPTA from NIPPON KAYAKU CO., LTD.) | |
| Monofunctional radical polymerizing compound | 10 |
| having a charge transport structure | |
| Acrylic acid ester triarylamine compound No. XII | |
| having a molecular weight of 445 and one functional group | |
| Photo polymerization initiator | 1 |
| 1-hydroxy-cyclohexyl-phenyl-ketone | |
| having a molecular weight of 204 and no functional group | |
| (IRGACURE 184 from CIBA SPECIALTY CHEMICALS) | |
| Butylacetate | 120 |
| having a boiling point of 126° C. and a saturated vapor | |
| pressure of 13 mm Hg/25° C. | |

Trimethylolpropanetriacrylate and acrylic acid ester triarylamine compound No. XII have radical polymerizing functional groups. The number of acrylic groups thereof are as follows.

(1) The number of acrylic groups of trimethylolpropanetriacrylate

10×6.02×10²³×3/296=6.10×10²²

(2) The number of acrylic groups of acrylic acid ester triarylamine compound No. XII

10×6.02×10^{23/445}=1.35×10²²

(3) Total number of acrylic groups is divided by total weight of solid contents to determine the number of radical polymerizing functional groups in 1 g thereof
(6.10×10²²+1.35×10²²)/(10+10+1)=3.55×10²¹

The coated layer was irradiated with a UV lamp system having a H bulb from FUSION at a lamp power of 200 W/cm and an irradiation intensity of 450 mW/cm² for 30 sec, and further dried at 130° C. for 30 min to form a crosslinked surface layer having a thickness of 5.0 μm. Thus, an electrophotographic photoreceptor was prepared.

### Example 2

The procedure for preparation of the electrophotographic photoreceptor in Example 1 was repeated to prepare an electrophotographic photoreceptor except for replacing 120 parts of butylacetate in the crosslinked surface layer coating liquid with 30 parts thereof and 90 parts of tetrahydrofuran.

### Example 3

The procedure for preparation of the electrophotographic photoreceptor in Example 2 was repeated to prepare an electrophotographic photoreceptor except for replacing butylacetate with cyclohexanone having a boiling point of 156° C. and a saturated vapor pressure of 3.95 mm Hg/25° C.

### Example 4

The procedure for preparation of the electrophotographic photoreceptor in Example 2 was repeated to prepare an electrophotographic photoreceptor except for replacing butylacetate with 2-propanol having a boiling point of 82° C. and a saturated vapor pressure of 32.4 mm Hg/25° C.

### Example 5

The procedure for preparation of the electrophotographic photoreceptor in Example 2 was repeated to prepare an electrophotographic photoreceptor except for replacing butylacetate with xylene having a solubility parameter of 8.8.

### Example 6

The procedure for preparation of the electrophotographic photoreceptor in Example 2 was repeated to prepare an electrophotographic photoreceptor except for replacing butylacetate with dioxane having a solubility parameter of 9.9.

### Example 7

The procedure for preparation of the electrophotographic photoreceptor in Example 2 was repeated to prepare an electrophotographic photoreceptor except for replacing butylacetate with chlorobenzene having a solubility parameter of 9.5.

### Example 8

The procedure for preparation of the electrophotographic photoreceptor in Example 1 was repeated to prepare an electrophotographic photoreceptor except for replacing 120 parts of butylacetate in the crosslinked surface layer coating liquid with 63 parts of cyclohexanone.

### Example 9

The procedure for preparation of the electrophotographic photoreceptor in Example 1 was repeated to prepare an electrophotographic photoreceptor except for replacing 120 parts of butylacetate in the crosslinked surface layer coating liquid with 399 parts thereof.

### Example 10

The procedure for preparation of the electrophotographic photoreceptor in Example 1 was repeated to prepare an electrophotographic photoreceptor except for replacing the monofunctional radical polymerizing compound having a charge transport structure in the crosslinked surface layer coating liquid with the acrylic acid ester triarylamine compound No. VII having a molecular weight of 431 and one functional group.

### Example 11

The procedure for preparation of the electrophotographic photoreceptor in Example 1 was repeated to prepare an electrophotographic photoreceptor except for replacing the monofunctional radical polymerizing compound having a charge transport structure in the crosslinked surface layer coating liquid with the acrylic acid ester triarylamine compound No. XV having a molecular weight of 828 and one functional group.

### Example 12

The procedure for preparation of the electrophotographic photoreceptor in Example 1 was repeated to prepare an electrophotographic photoreceptor except for replacing the monofunctional radical polymerizing compound having a charge transport structure in the crosslinked surface layer coating liquid with the triarylamine exemplified compound No. 54 having a molecular weight of 419 and one functional group.

### Example 13

The procedure for preparation of the electrophotographic photoreceptor in Example 1 was repeated to prepare an electrophotographic photoreceptor except for replacing the monofunctional radical polymerizing compound having a charge transport structure in the crosslinked surface layer coating liquid with the triarylamine exemplified compound No. 16 having a molecular weight of 371 and one functional group.

### Example 14

The procedure for preparation of the electrophotographic photoreceptor in Example 1 was repeated to prepare an electrophotographic photoreceptor except for replacing the monofunctional radical polymerizing compound having a charge transport structure in the crosslinked surface layer coating liquid with the triarylamine exemplified compound No. 24 having a molecular weight of 419 and one functional group.

### Example 15

The procedure for preparation of the electrophotographic photoreceptor in Example 2 was repeated to prepare an electrophotographic photoreceptor except for replacing 10 parts of the tri- or more functional radical polymerizing monomer having no charge transport structure KAYARAD TMPTA (trimethylolpropanetriacrylate) in the crosslinked surface layer coating liquid with 5 parts thereof and 5 parts of KAYARAD DPHA (dipentaerythritolhexaacrylate from NIPPON KAYAKU CO., LTD.) having an average molecular weight of 536 and 5.5 functional groups and the following formula: 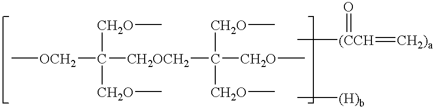
wherein a is 5 and b is 1, alternatively a is 6 and b is 0.

### Example 16

The procedure for preparation of the electrophotographic photoreceptor in Example 12 was repeated to prepare an electrophotographic photoreceptor except for replacing 10 parts of the tri- or more functional radical polymerizing monomer having no charge transport structure KAYARAD TMPTA (trimethylolpropanetriacrylate) in the crosslinked surface layer coating liquid with 5 parts thereof and 5 parts of KAYARAD DPCA-120 (dipentaerythritolhexaacrylate from NIPPON KAYAKU CO., LTD.) having an average molecular weight of 1,948 and 6 functional groups.

### Comparative Example 1

The procedure for preparation of the electrophotographic photoreceptor in Example 1 was repeated to prepare an electrophotographic photoreceptor except for replacing the tri- or more functional radical polymerizing monomer in the crosslinked surface layer coating liquid with KAYARAD FM-280 (PO-modified glycerolacrylate from NIPPON KAYAKU CO., LTD.) having an average molecular weight of 463 and 3 functional groups, wherein the number of acrylic groups in 1 g of the solid contents, i.e., the number of radical polymerizing functional groups was less than 2.5×10²¹.

### Comparative Example 2

The procedure for preparation of the electrophotographic photoreceptor in Example 1 was repeated to prepare an electrophotographic photoreceptor except for replacing the tri- or more functional radical polymerizing monomer in the crosslinked surface layer coating liquid with bifunctional 1,6-hexanedioldiacrylate having a molecular weight of 226 from Wako Pure Chemical Industries, Ltd., wherein no tri- or more functional radical polymerizing monomer was used.

### Comparative Example 3

The procedure for preparation of the electrophotographic photoreceptor in Example 1 was repeated to prepare an electrophotographic photoreceptor except for excluding monofunctional radical polymerizing compound having a charge transport structure and replacing 10 parts of the tri- or more functional radical polymerizing monomer in the crosslinked surface layer coating liquid with 20 parts of bifunctional polyethyleneglycoldiacrylate having a molecular weight of 308 from Shin-nakamura Chemical Corporation, wherein no monofunctional radical polymerizing compound having a charge transport structure was used.

### Comparative Example 4

The procedure for preparation of the electrophotographic photoreceptor in Example 1 was repeated to prepare an electrophotographic photoreceptor except for excluding monofunctional radical polymerizing compound having a charge transport structure and replacing 10 parts of the tri- or more functional radical polymerizing monomer in the crosslinked surface layer coating liquid with 20 parts of bifunctional neopentylglycoldiacrylate having a molecular weight of 212 from Shin-nakamura Chemical Corporation, wherein no monofunctional radical polymerizing compound having a charge transport structure was used.

### Comparative Example 5

The procedure for preparation of the electrophotographic photoreceptor in Example 1 was repeated to prepare an electrophotographic photoreceptor except for excluding the tri- or more functional radical polymerizing monomer and replacing 10 parts of the monofunctional radical polymerizing compound having a charge transport structure with 20 parts thereof.

### Comparative Example 6

The procedure for preparation of the electrophotographic photoreceptor in Example 1 was repeated to prepare an electrophotographic photoreceptor except for excluding the monofunctional radical polymerizing compound having a charge transport structure and replacing 10 parts of the tri- or more functional radical polymerizing monomer with 20 parts thereof.

### Comparative Example 7

The procedure for preparation of the electrophotographic photoreceptor in Example 1 was repeated to prepare an electrophotographic photoreceptor except for replacing the monofunctional radical polymerizing compound having a charge transport structure with the following material: 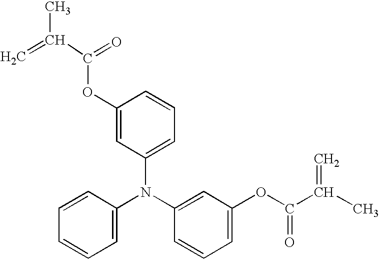
wherein no monofunctional radical polymerizing compound having a charge transport structure was used.

### Comparative Example 8

The procedure for preparation of the electrophotographic photoreceptor in Example 1 was repeated to prepare an electrophotographic photoreceptor except for replacing the monofunctional radical polymerizing compound having a charge transport structure with the following non-radical polymerizing material:

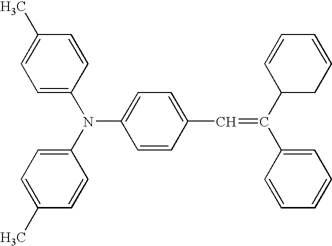

### Comparative Example 9

The procedure for preparation of the electrophotographic photoreceptor in Example 1 was repeated to prepare an electrophotographic photoreceptor except for not forming the crosslinked surface layer and changing the thickness of the CTL to 27 μm.

### Comparative Example 10

The procedure for preparation of the electrophotographic photoreceptor in Example 1 was repeated to prepare an electrophotographic photoreceptor except for forming the crosslinked surface layer having a thickness of 5 μm according to Example 4 in Japanese Laid-Open Patent Publication No. 2004-302451, wherein the monomer satisfies requirements, but does not satisfy the peel strength of the present invention.

### Comparative Example 11

The procedure for preparation of the electrophotographic photoreceptor in Example 1 was repeated to prepare an electrophotographic photoreceptor except for forming the crosslinked surface layer having a thickness of 5 μm according to Example 9 in Japanese Laid-Open Patent Publication No. 2004-302452, wherein the monomer satisfies requirements, but does not satisfy the peel strength of the present invention.

### Comparative Example 12

The procedure for preparation of the electrophotographic photoreceptor in Example 1 was repeated to prepare an electrophotographic photoreceptor except for forming the crosslinked surface layer having a thickness of 5 μm according to Example 1 in Japanese Laid-Open Patent Publication No. 2001-183858, which does not satisfy the number of radical polymerizing functional groups in 1 g of the solid contents and the peel strength of the present invention.

The evaluation test methods for the photoreceptors prepared in Examples and Comparative Examples are as follows.

<Peel Strength Test>

SAICAS DN-20 from DAIPLA WINTES Co., Ltd., having a cutting blade 0.5 mm wide was used at a horizontal cutting speed of 0.1 μm/sec and a vertical cutting speed of 0.01 μm/sec. The cutting depth was larger than the thickness of the crosslinked surface layer. The peel strength was determined by dividing the horizontal load of the cutting depth with the width of the cutting blade.

<Hardenability Test>

The hardenability of the crosslinked surface layer was evaluated by the solubility thereof in an organic solvent. A drop of tetrahydrofuran was put on the photoreceptor, and the change of the surface profile after naturally dried was visually observed. The surface was partially dissolved and had ring-shaped concavities and convexities or clouds when insufficiently hardened.

<Durability Test>

The crosslinked surface layer of the photoreceptor was abraded by 3.5 μm deep and 10 cm axially wide at a random position thereof with a wrapping film having a surface roughness of 0.3 μm from Sumitomo 3M Ltd. The photoreceptor was installed in a process cartridge, and the process cartridge was installed in a modified imagio MF2200 using a LD having a wavelength of 655 μm as a light source including image information and a cleaning blade having 1.5 times contact pressure from Ricoh Company, Ltd. The dark space (not abraded) potential thereof was set at 700 (−V), 30,000 A4 images were produced thereby to measure the thickness of the abraded part and evaluate image quality every 10,000 images. The initial dark space potential and irradiated part potential and those after 30,000 images were produced were measured. The thickness of the photoreceptor was measured by an eddy-current film thickness measurer from Fischer Instruments K.K.

<Crack Test>

A finger grease was adhered to the surface of the photoreceptor, and after left at 50° C. under a normal pressure for 3 days, the surface thereof was observed.

The peel strength and hardenability test results of the photoreceptors prepared in Examples 1 to 16 and Comparative Examples 1 to 12 are shown in Table 4.

TABLE 4

| | The number of | | |
|---|---|---|---|
| | radical | | |
| | polymerizing | Peel strength | |
| Photoreceptor | functional groups | (N/mm) | Hardenability |
| Example 1 | 3.55 × 10²¹ | 0.13 | Insoluble |
| Example 2 | ″ | 0.24 | Insoluble |
| Example 3 | ″ | 0.32 | Insoluble |
| Example 4 | ″ | 0.15 | Insoluble |
| Example 5 | ″ | 0.26 | Insoluble |
| Example 6 | ″ | 0.27 | Insoluble |
| Example 7 | ″ | 0.30 | Insoluble |
| Example 8 | ″ | 0.11 | Insoluble |
| Example 9 | ″ | 0.25 | Insoluble |
| Example 10 | 3.57 × 10²¹ | 0.21 | Insoluble |
| Example 11 | 3.25 × 10²¹ | 0.16 | Insoluble |
| Example 12 | 3.59 × 10²¹ | 0.15 | Insoluble |
| Example 13 | 3.68 × 10²¹ | 0.14 | Insoluble |
| Example 14 | 3.59 × 10²¹ | 0.23 | Insoluble |
| Example 15 | 3.52 × 10²¹ | 0.22 | Insoluble |
| Example 16 | 2.58 × 10²¹ | 0.42 | Insoluble |
| Comparative | 2.50 × 10²¹ | 0.20 | Insoluble |
| Example 1 | | | |
| Comparative | 3.18 × 10²¹ | 0.40 | Soluble |
| Example 2 | | | |
| Comparative | 3.72 × 10²¹ | 0.33 | Insoluble |
| Example 3 | | | |
| Comparative | 5.41 × 10²¹ | 0.21 | Insoluble |
| Example 4 | | | |
| Comparative | 1.37 × 10²¹ | Unformable | |
| Example 5 | | | |
| Comparative | 5.81 × 10²¹ | 0.03 | Insoluble |
| Example 6 | | | |
| Comparative | 4.29 × 10²¹ | 0.05 | Insoluble |
| Example 7 | | | |
| Comparative | 2.91 × 10²¹ | 1.20 | Soluble |
| Example 8 | | | |
| Comparative | 0 | 0.35 | Soluble |
| Example 9 | | | |
| Comparative | 3.84 × 10²¹ | 0.06 | Insoluble |
| Example 10 | | | |
| Comparative | 3.37 × 10²¹ | 0.08 | Insoluble |
| Example 11 | | | |
| Comparative | 7.55 × 10²¹ | 0.03 | Insoluble |
| Example 12 | | | |

The photoreceptors of the present invention, prepared in Examples 1 to 16 have 2.55×10²¹ or more radical polymerizing functional groups in 1 g of the solid contents in the crosslinked surface layer, and at the same time peel strength not less than 0.1 N/mm. Namely, the crosslinked surface layer is considered to have a dense three-dimensional network structure and good adhesiveness to the lower photosensitive layer. Any of the photoreceptors prepared in Examples has good hardenability. In Examples 2 to 4, when a solvent used in the crosslinked surface layer has a smaller saturated vapor pressure or higher boiling point, the peel strength thereof becomes larger. In Examples 5 to 7, when the solvent has a solubility parameter of from 8.5 to 11.0, and preferably from 9.0 to 9.7, the peel strength becomes large. Further, in Examples 1, 8 and 9, when the crosslinked surface layer coating liquid has less concentration of solid contents, the peel strength becomes larger. In Examples 15 and 16, even when polyfunctional monomers having 5 or more functional groups are hardened, the crosslinked surface layer has sufficient peel strength.

Meanwhile, the photoreceptor including a bifunctional monomer in the crosslinked surface layer in Comparative Example 2, the photoreceptor including only the charge transport compound having a radical polymerizing group in the crosslinked surface layer in Comparative Example 5, the photoreceptor including a low-molecular-weight charge transport material in the crosslinked surface layer in Comparative Example 8 and the photoreceptor not having a crosslinked surface layer in Comparative Example 9 are soluble in an organic solvent. The crosslinked surface layers in Comparative Examples 2, 5 and 8 are not sufficiently hardened. The photoreceptor in Comparative Example 1 has few radical polymerizing functional groups of 2.50×10²¹ in 1 g of the solid contents in the crosslinked surface layer and the photoreceptors in Comparative Examples 6, 7 and 10 to 12 have small peel strength although having sufficient radical polymerizing functional groups, and the surface layers thereof are considered to have insufficient adhesiveness to the lower photosensitive layers. The photoreceptors in Comparative Examples 3 and 4 have sufficient radical polymerizing functional groups, and good peel strength and hardenability. However, including too many bifunctional monomers, they initially have high surface potential of the irradiated part and image density deteriorates as shown in Table 5.

The durability test results of the photoreceptors prepared in Examples 1 to 16 and Comparative Examples 1, 3, 4, 6, 7, 9, 10 to 12 are shown in Table 5.

TABLE 5

| | | | | Initial | | | |
|---|---|---|---|---|---|---|---|
| | | | | Surface | | Surface | |
| | | | | Potential | | Potential | |
| | | | | (−V) | | After 30,000 | |
| | Abraded | | | | Irradi- | | Irradi- |
| | Amount (μm) | | | Dark | ated | Dark | ated |
| | 10,000 | 20,000 | 30,000 | space | part | space | part |
| Ex. 1 | 0.11 | 0.22 | 0.33 | 700 | 110 | 680 | 120 |
| Ex. 2 | 0.12 | 0.24 | 0.37 | 700 | 110 | 680 | 120 |
| Ex. 3 | 0.21 | 0.43 | 0.65 | 700 | 115 | 670 | 110 |
| Ex. 4 | 0.12 | 0.25 | 0.36 | 700 | 110 | 685 | 120 |
| Ex. 5 | 0.12 | 0.24 | 0.36 | 700 | 110 | 680 | 120 |
| Ex. 6 | 0.13 | 0.25 | 0.36 | 700 | 110 | 680 | 120 |
| Ex. 7 | 0.12 | 0.23 | 0.37 | 700 | 110 | 680 | 120 |
| Ex. 8 | 0.12 | 0.24 | 0.36 | 700 | 115 | 680 | 120 |
| Ex. 9 | 0.12 | 0.27 | 0.38 | 700 | 110 | 675 | 115 |
| Ex. 10 | 0.22 | 0.42 | 0.62 | 700 | 110 | 670 | 110 |
| Ex. 11 | 0.16 | 0.32 | 0.48 | 700 | 105 | 675 | 110 |
| Ex. 12 | 0.15 | 0.39 | 0.45 | 700 | 110 | 675 | 110 |
| Ex. 13 | 0.14 | 0.27 | 0.42 | 700 | 110 | 675 | 115 |
| Ex. 14 | 0.25 | 0.50 | 0.75 | 700 | 110 | 665 | 105 |
| Ex. 15 | 0.09 | 0.18 | 0.26 | 700 | 110 | 680 | 115 |
| Ex. 16 | 0.11 | 0.22 | 0.33 | 700 | 110 | 680 | 115 |
| Com. | 0.61 | 1.22 | 1.83 | 700 | 110 | 660 | 95 |
| Ex. 1 | | | | | | | |
| Com. | Image | density | initially | 700 | 355 | — | — |
| Ex. 3 | Lowered | test | stopped | | | | |
| Com. | Image | density | initially | 700 | 360 | — | — |
| Ex. 4 | Lowered | test | stopped | | | | |
| Com. | Image | density | initially | 700 | 350 | — | — |
| Ex. 6 | Lowered | test | stopped | | | | |
| Com. | 1.29 | 3.69 | 3.87 | 700 | 115 | — | — |
| Ex. 7 | | | | | | | |
| Com. | 1.88 | 3.76 | 5.65 | 700 | 80 | 655 | 60 |
| Ex. 9 | | | | | | | |
| Com. | 1.32 | 3.65 | — | 700 | 115 | — | — |
| Ex. 10 | | | | | | | |
| Com. | 1.25 | 3.60 | — | 700 | 115 | — | — |
| Ex. 11 | | | | | | | |
| Com. | 1.98 | — | — | 700 | 225 | — | — |
| Ex. 12 | | | | | | | |

The photoreceptors prepared in Examples 1 to 16 are abrades less and the abraded amounts thereof are stable. Further, the surface potential of the irradiated parts thereof before and after 30,000 images are produced varies less. In the present invention, the interface between the crosslinked surface layer and the lower photosensitive layer also maintains high durability. The photoreceptor in Comparative Example 1 having few radical polymerizing functional groups does not have sufficient abrasion resistance. Among Comparative Examples 6, 7, 10 to 12 having small peel strength, Comparative Example 6 not having a charge transport structure in the crosslinked surface layer initially has high potential of the irradiated part and Comparative Example 12 initially has high potential thereof as well because of having a crosslinked surface layer 5 μm thick. In addition, Comparative Example 12 has a large abraded amount, and the crosslinked surface layer thereof is thought not to have sufficient adhesiveness. Comparative Examples 7, 10 and 11 having small peel strength quickly decrease thickness of the crosslinked surface layers. Comparative Examples 3 and 4 not having a charge transport structure in the crosslinked surface layer initially has very high potential of the irradiated part. Comparative Example 9 proves the crosslinked surface layer of the present invention gives high abrasion resistance and stable electrical properties to an electrophotographic photoreceptor.

The crack test results of the photoreceptors prepared in Examples 1 to 16 are shown in 5 Table 6.

TABLE 6

| | Beginning | 3 days later |
|---|---|---|
| Example 1 | Glossy surface | Not cracked |
| Example 2 | Glossy surface | Not cracked |
| Example 3 | Glossy surface | Not cracked |
| Example 4 | Glossy surface | Not cracked |
| Example 5 | Glossy surface | Not cracked |
| Example 6 | Glossy surface | Not cracked |
| Example 7 | Glossy surface | Not cracked |
| Example 8 | Glossy surface | Not cracked |
| Example 9 | Glossy surface | Not cracked |
| Example 10 | Glossy surface | Not cracked |
| Example 11 | Glossy surface | Not cracked |
| Example 12 | Glossy surface | Not cracked |
| Example 13 | Glossy surface | Not cracked |
| Example 14 | Glossy surface | Not cracked |
| Example 15 | Glossy surface | Not cracked |
| Example 16 | Glossy surface | Not cracked |

The photoreceptors of the present invention are not cracked, which proves that the crosslinked surface layers thereof uniformly include compounds having charge transport structures.

### Synthesis Example 1

292 g of 1,3-diiminoisoindoline and 2,000 ml of sulfolane were mixed, and 204 g of titaniumtetrabutoxide were dropped into the mixture under a nitrogen gas stream. The mixture was gradually heated until the mixture had a temperature of 180° C. and stirred for 5 hrs while the reaction temperature was maintained from 170 to 180° C. After the mixture was cooled, a precipitated material (powder) was filtered and washed with chloroform until the powder became blue. Next, the powder was washed with methanol for several times, and further washed with hot water having a temperature of 80° C. for several times to prepare a crude titanylphthalocyanine pigment. The crude titanylphthalocyanine pigment was mixed in a concentrated sulfonic acid in an amount of 20 times as much as the crude titanylphthalocyanine pigment and stirred therein to dissolve the pigment therein, and the mixture was dropped in iced water in an amount of 100 times as much as the mixture while stirred, and a precipitated crystal was filtered. Then, the crystal was repeatedly washed with water until the water after washed became neutral to prepare a wet cake of a titanylphthalocyanine pigment. The wet cake was thoroughly washed with ion-exchanged water until xx ion was not detected from the ion-exchanged water after washed.

20 g of the wet cake was placed in 200 g of 1,2-dichloroethane and the mixture was stirred for 4 hrs. After 1,000 g of methanol was placed in the mixture and the mixture was stirred for 1 hr, the mixture was filtered and dried to prepare a titanylphthalocyanine pigment powder.

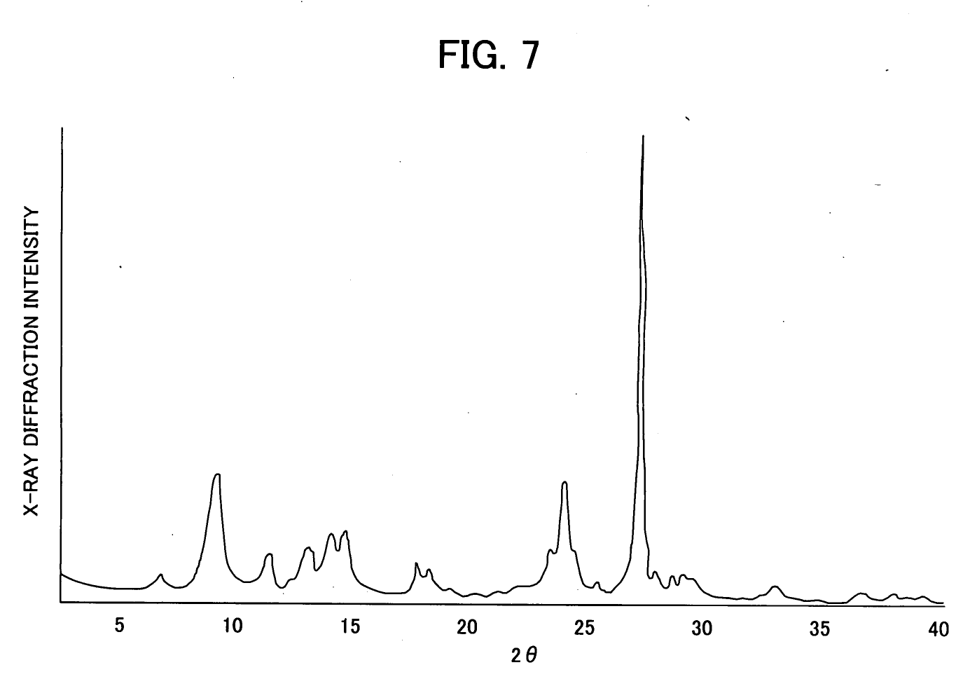

X-ray diffraction spectrum of the titanylphthalocyanine powder was measured by the following conditions to find that the titanylphthalocyanine powder at least has main peaks of Bragg (2θ) at 9.6±0.2°, 24.0±0.2° and 27.2±0.2° in the X-ray diffraction spectrum when irradiated with Cu-Kα ray as shown in FIG. 7.

X-ray tube: Cu

Voltage: 40 kV

Current: 20 mA

Scanning speed: 1°/min

Scanning range: 3 to 40°

Time constant: 2 sec

### Example 17

An undercoat coating liquid, a charge generation coating liquid and charge transport coating liquid, which have the following formulations, were coated and dried in this order on an aluminum cylinder having a diameter of 30 mm to form an undercoat layer 3.5 μm thick, a CGL 0.3 μm thick, a CTL 23 μm thick thereon.

The CTL was further coated with an adhesive layer coating liquid and a surface layer coating liquid having the following formulations by a spray coating method.

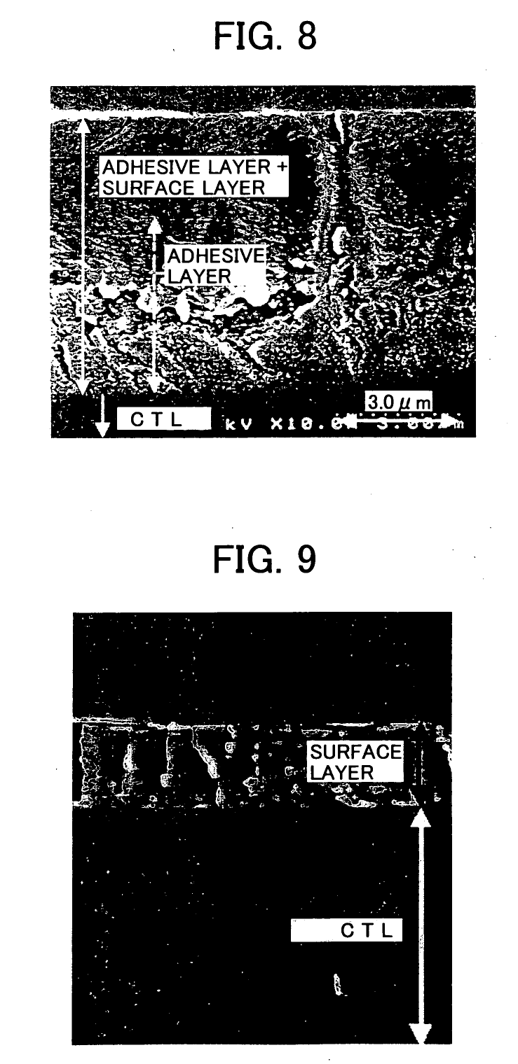

The coated adhesive layer coating liquid and surface layer coating liquid were irradiated by a metal halide lamp at 160 W/cm, an irradiation distance of 120 mm and an irradiation intensity of 500 mW/cm2 for 120 sec to be hardened, and further dried at 130° C. for 20 min to prepare an electrophotographic photoreceptor of the present invention, having an adhesive layer 0.5 μm thick and a surface layer 4 μm thick. A cross-sectional SEM photograph of the photoreceptor is shown in FIG. 8.

| Undercoat layer coating liqiuid | |
|---|---|
| Alkyd resin(BEKKOZOL 1307-60-EL from Dainippon Ink & Chemicals, Inc.) | 6 |
| Melamine resin(SUPER BEKKAMIN G-821-60 from Dainippon Ink & Chemicals, Inc.) | 4 |
| Titanium dioxide powder | 40 |
| Methyl ethyl ketone | 50 |
| CGL coating liquid | |
| Polyvinyl butyral(XYHL from Union Carbide Corp.) | 0.5 |
| Cyclohexanone200 | |
| Methyl ethyl ketone | 80 |
| Bisazo pigment having the following formula (I): | 2.5 |

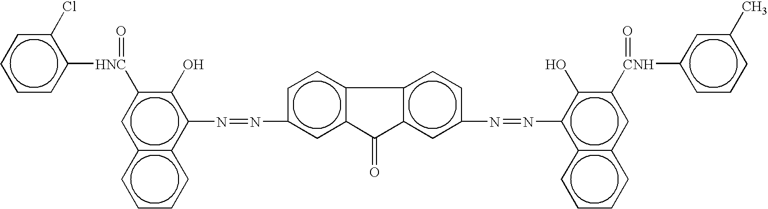

| | |
|---|---|
| CTL coating liquid | |
| Bisphenol Z Polycarbonate(Panlite TS-2050 from TEIJIN CHEMICALS LTD.) | 10 |
| Tetrahydrofuran | 100 |
| 1% tetrahydrofuran solution of silicone oil(KF50-100CS from Shin-Etsu Chemical Industry Co., Ltd.) | 1 |
| Charge transport material having the following formula (II): | 7 |

| | |
|---|---|
| | (II) |
| 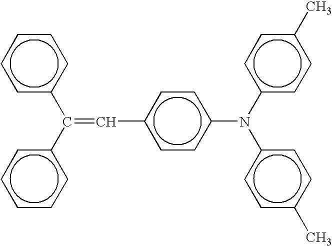 | |

| | |
|---|---|
| Adhesive layer coating liquid | |
| Polyarylate(U-polymer U-100 from Unitika Ltd.) | |
| Tri- or more functional radical polymerizing monomer having no charge transport structure | 9 |
| Trimethylolpropanetriacrylate having a molecular weight of 296 and molecular weight/functional | |
| groups of 99(KAYARAD TMPTA from NIPPON KAYAKU CO., LTD.) | |
| Monofunctional radical polymerizing compound having a charge transport structure(Exemplified compound No. 54) | 5 |
| Photo polymerization initiator 1-hydroxy-cyclohexyl-phenyl-ketone having a molecular weight of | 0.5 |
| 204 and no functional group(IRGACURE 184 from CIBA SPECIALTY CHEMICALS) | |
| Tetrahydrofuran | 400 |
| Surface layer coating liquid | |
| Tri- or more functional radical polymerizing monomer having no charge transport structure | 10 |
| Trimethylolpropanetriacrylate having a molecular weight of 296 and molecular weight/ | |
| functional groups of 99 (KAYARAD TMPTA from NIPPON KAYAKU CO., LTD.) | |
| Monofunctional radical polymerizing compound having a charge transport structure | 10 |
| (Exemplified compound No. 54)Photo polymerization initiator 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 100 |

### Example 18

The procedure for preparation of the electrophotographic photoreceptor in Example 17 was repeated to prepare an electrophotographic photoreceptor except for replacing the adhesive layer with an adhesive layer having the following formulation.

| | |
|---|---|
| Polyarylate | 3 |
| (U-polymer U-100 from Unitika Ltd.) | |
| Tri- or more functional | 7 |
| radical polymerizing monomer | |
| having no charge transport structure | |
| Trimethylolpropanetriacrylate | |
| having a molecular weight of 296 and molecular weight/ | |
| functional groups of 99 | |
| (KAYARAD TMPTA from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |

### Example 19

The procedure for preparation of the electrophotographic photoreceptor in Example 17 was repeated to prepare an electrophotographic photoreceptor except for replacing the adhesive layer with an adhesive layer having the following formulation.

| | |
|---|---|
| Polyarylate | 5 |
| (U-polymer U-100 from Unitika Ltd.) | |
| Tri- or more functional | 5 |
| radical polymerizing monomer | |
| having no charge transport structure | |
| Trimethylolpropanetriacrylate | |
| having a molecular weight of 296 and molecular weight/ | |
| functional groups of 99 | |
| (KAYARAD TMPTA from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |

### Example 20

The procedure for preparation of the electrophotographic photoreceptor in Example 17 was repeated to prepare an electrophotographic photoreceptor except for replacing the adhesive layer with an adhesive layer having the following formulation.

| | |
|---|---|
| Polyarylate | 7 |
| (U-polymer U-100 from Unitika Ltd.) | |
| Tri- or more functional | 3 |
| radical polymerizing monomer | |
| having no charge transport structure | |
| Trimethylolpropanetriacrylate | |
| having a molecular weight of 296 and molecular weight/ | |
| functional groups of 99 | |
| (KAYARAD TMPTA from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |

### Example 21

The procedure for preparation of the electrophotographic photoreceptor in Example 17 was repeated to prepare an electrophotographic photoreceptor except for replacing the adhesive layer with an adhesive layer having the following formulation.

| | |
|---|---|
| Polyarylate | 9 |
| (U-polymer U-100 from Unitika Ltd.) | |
| Tri- or more functional | 1 |
| radical polymerizing monomer | |
| having no charge transport structure | |
| Trimethylolpropanetriacrylate | |
| having a molecular weight of 296 and 99 functional groups | |
| (KAYARAD TMPTA from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |

### Example 22

An undercoat coating liquid, a charge generation coating liquid and charge transport coating liquid, which have the following formulations, were coated and dried in this order on an aluminum cylinder having a diameter of 30 mm to form an undercoat layer 1.5 μm thick, a CGL 0.3 μm thick, a CTL 23 μm thick thereon.

The CTL was further coated with an adhesive layer coating liquid and a surface layer coating liquid having the following formulations by a spray coating method.

The coated adhesive layer coating liquid and surface layer

coating liquid were irradiated by a metal halide lamp at 160 W/cm, an irradiation distance of 120 mm and an irradiation intensity of 500 mW/cm² for 120 sec to be hardened, and further dried at 130° C. for 20 min to prepare an electrophotographic photoreceptor of the present invention, having an adhesive layer 0.03 μm thick and a surface layer 4 μm thick.

| | |
|---|---|
| Undercoat layer coating liquid | |
| Titanium oxide | 40 |
| Alcohol-soluble nylon | 32 |
| Methanol | 400 |
| Isopropanol | 160 |
| CGL coating liquid | |
| Titanylphthalocyanine powder | 4 |
| Synthesized in Synthesis Example 1 | |
| Polyvinylbutyral | 2 |
| Methyl ethyl ketone | 150 |
| CTL coating liquid | |
| Bisphenol Z Polycarbonate | 10 |
| (Panlite TS-2050 from TEIJIN CHEMICALS LTD.) | |
| Tetrahydrofuran | 100 |
| 1% tetrahydrofuran solution | 1 |
| of silicone oil | |
| (KF50-100CS from Shin-Etsu Chemical Industry Co., Ltd.) | |
| Charge transport material | 7 |
| having the following formula (II): | |

| | |
|---|---|
| | (II) |
| 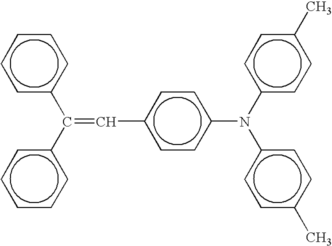 | |

| | |
|---|---|
| Adhesive layer coating liquid | |
| Bisphenol Z Polycarbonate | 5 |
| (Panlite TS-2050 from TEIJIN CHEMICALS LTD.) | |
| Tri- or more functional | 5 |
| radical polymerizing monomer | |
| having no charge transport structure | |
| Trimethylolpropanetriacrylate | |
| having a molecular weight of 536, 5.5 functional groups | |
| and 99 molecular weight/functional groups of 97 | |
| (KAYARAD DPHA from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |
| Surface layer coating liquid | |
| Tri- or more functional | 10 |
| radical polymerizing monomer | |
| having no charge transport structure | |
| Trimethylolpropanetriacrylate | |
| having a molecular weight of 536, 5.5 functional groups | |
| and 99 molecular weight/functional groups of 97 | |
| (KAYARAD DPHA from NIPPON KAYAKU CO., LTD.) | |
| Monofunctional radical polymerizing compound | 10 |
| having a charge transport structure | |
| (Exemplified compound No. 105) | |
| Photo polymerization initiator | 1 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 100 |

### Example 23

The procedure for preparation of the electrophotographic photoreceptor in Example 22 was repeated to prepare an electrophotographic photoreceptor except for changing the thickness of the adhesive layer to 0.06 μm.

### Example 24

The procedure for preparation of the electrophotographic photoreceptor in Example 22 was repeated to prepare an electrophotographic photoreceptor except for changing the thickness of the adhesive layer to 0.09 μm.

### Example 25

The procedure for preparation of the electrophotographic photoreceptor in Example 22 was repeated to prepare an electrophotographic photoreceptor except for changing the thickness of the adhesive layer to 0.12 μm.

### Example 26

The procedure for preparation of the electrophotographic photoreceptor in Example 22 was repeated to prepare an electrophotographic photoreceptor except for changing the thickness of the adhesive layer to 0.2 μm.

### Example 27

The procedure for preparation of the electrophotographic photoreceptor in Example 22 was repeated to prepare an electrophotographic photoreceptor except for changing the thickness of the adhesive layer to 0.5 μm.

### Example 28

The procedure for preparation of the electrophotographic photoreceptor in Example 22 was repeated to prepare an electrophotographic photoreceptor except for changing the thickness of the adhesive layer to 0.8 μm.

### Example 29

The procedure for preparation of the electrophotographic photoreceptor in Example 22 was repeated to prepare an electrophotographic photoreceptor except for changing the thickness of the adhesive layer to 1.2 μm.

### Example 30

The procedure for preparation of the electrophotographic photoreceptor in Example 22 was repeated to prepare an electrophotographic photoreceptor except for changing the thickness of the adhesive layer to 4 μm.

### Example 31

The procedure for preparation of the electrophotographic photoreceptor in Example 22 was repeated to prepare an electrophotographic photoreceptor except for changing the thickness of the adhesive layer to 7 μm.

### Example 32

The procedure for preparation of the electrophotographic photoreceptor in Example 19 was repeated to prepare an electrophotographic photoreceptor except for replacing the adhesive layer with an adhesive layer having the following formulation.

| | |
|---|---|
| Bisphenol Z Polycarbonate | 5 |
| (Panlite TS-2050 from TEIJIN CHEMICALS LTD.) | |
| Tri- or more functional | 5 |
| radical polymerizing monomer | |
| having no charge transport structure | |
| Trimethylolpropanetriacrylate | |
| having a molecular weight of 296 and molecular weight/functional | |
| groups of 99 (KAYARAD TMPTA from NIPPON | |
| KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |

### Comparative Example 13

The procedure for preparation of the electrophotographic photoreceptor in Example 17 was repeated to prepare an electrophotographic photoreceptor except for not coating the adhesive layer coating liquid.

A cross-sectional SEM photograph of the photoreceptor is shown in FIG. 9. In FIG. 9, the CTL and the surface layer are clearly separated without an adhesive layer. In FIG. 8, an adhesive layer is present therebetween without an interface.

Each of the photoreceptors prepared in Examples 17 to 32 and Comparative Example 13 was installed in imagio Neo 270 using a LD having a wavelength of 655 nm as a light irradiator including image information, and 100,000 S3 chart images were produced on A4-size My Paper from NBS Ricoh Co., Ltd. at an initial potential of −700 V. The abrasion property, inner potential and image quality were evaluated. The results are shown in Tables 7 to 9.

TABLE 7

Abraded Amount (μm)

| | 50,000 | 100,000 |
|---|---|---|
| Example 17 | 0.71 | 2.26 |
| Example 18 | 0.73 | 1.51 |
| Example 19 | 0.68 | 1.42 |
| Example 20 | 0.71 | 1.48 |
| Example 21 | 0.69 | 2.41 |
| Example 22 | 0.70 | 1.84 |
| Example 23 | 0.72 | 1.74 |
| Example 24 | 0.69 | 1.66 |
| Example 25 | 0.71 | 1.44 |
| Example 26 | 0.71 | 1.42 |
| Example 27 | 0.66 | 1.43 |
| Example 28 | 0.67 | 1.39 |
| Example 29 | 0.70 | 1.39 |
| Example 30 | 0.72 | 1.40 |
| Example 31 | 0.69 | 1.36 |
| Example 32 | 0.67 | 1.40 |
| Comparative Example 13 | 2.11 | 6.92 |

TABLE 8

| | Surface Potential | | | | | |
|---|---|---|---|---|---|---|
| | Initial (−V) | | 50,000 (−V) | | 100,000 (−V) | |
| | Dark | Irradiated | Dark | Irradiated | Dark | Irradiated |
| | space | part | space | part | space | part |
| Ex. 17 | 700 | 120 | 640 | 130 | 610 | 140 |
| Ex. 18 | 700 | 140 | 680 | 150 | 630 | 160 |
| Ex. 19 | 700 | 150 | 680 | 160 | 650 | 180 |
| Ex. 20 | 700 | 180 | 660 | 190 | 640 | 190 |
| Ex. 21 | 700 | 180 | 630 | 200 | 600 | 220 |
| Ex. 22 | 700 | 110 | 650 | 120 | 630 | 100 |
| Ex. 23 | 700 | 100 | 640 | 90 | 660 | 110 |
| Ex. 24 | 700 | 100 | 640 | 110 | 650 | 130 |
| Ex. 25 | 700 | 110 | 660 | 100 | 640 | 120 |
| Ex. 26 | 700 | 110 | 680 | 110 | 660 | 120 |
| Ex. 27 | 700 | 120 | 670 | 120 | 630 | 140 |
| Ex. 28 | 700 | 110 | 690 | 120 | 650 | 140 |
| Ex. 29 | 700 | 120 | 690 | 140 | 670 | 130 |
| Ex. 30 | 700 | 160 | 690 | 180 | 670 | 230 |
| Ex. 31 | 700 | 200 | 700 | 230 | 680 | 260 |
| Ex. 32 | 700 | 120 | 680 | 130 | 660 | 160 |
| Com. Ex. | 700 | 150 | 620 | 170 | 500 | 190 |
| 13 | | | | | | |

TABLE 9

| | Image quality | | |
|---|---|---|---|
| | Initial | 50,000 | 100,000 |
| Example 17 | ⊚ | ⊚ | Δ |
| Example 18 | ⊚ | ⊚ | ⊚ |
| Example 19 | ⊚ | ⊚ | ⊚ |
| Example 20 | ⊚ | ⊚ | ⊚ |
| Example 21 | ⊚ | ⊚ | Δ |
| Example 22 | ⊚ | ⊚ | ◯ |
| Example 23 | ⊚ | ⊚ | ◯ |
| Example 24 | ⊚ | ⊚ | ◯ |
| Example 25 | ⊚ | ⊚ | ⊚ |
| Example 26 | ⊚ | ⊚ | ⊚ |
| Example 27 | ⊚ | ⊚ | ⊚ |
| Example 28 | ⊚ | ⊚ | ⊚ |
| Example 29 | ⊚ | ⊚ | ⊚ |
| Example 30 | ⊚ | ⊚ | ⊚ |
| Example 31 | ⊚ | ⊚ | ⊚ |
| Example 32 | ⊚ | ⊚ | ⊚ |
| Comparative | ⊚ | X | X |
| Example 13 | | | |

⊚: very good
◯: good
Δ: stripe images are locally produced
X: stripe images are evenly produced

The photoreceptors prepared in Examples 17 to 32 had good abrasion resistance and produced quality images even after producing 100,000 images. However, the photoreceptor prepared in Comparative Example 13 was quickly abraded and produced images evenly having stripe images after producing 50,000 images.

### Example 33

An undercoat coating liquid, a charge generation coating liquid and charge transport coating liquid, which have the following formulations, were coated and dried in this order on an aluminum cylinder having a diameter of 30 mm to form an undercoat layer 3.5 μm thick, a CGL 0.3 μm thick, a CTL 23 μm thick thereon.

The CTL was further coated with an adhesive layer coating liquid and a surface layer coating liquid having the following formulations by a spray coating method.

The coated adhesive layer coating liquid and surface layer coating liquid were irradiated by a metal halide lamp at 160 W/cm, an irradiation distance of 120 mm and an irradiation intensity of 500 mW/cm² for 120 sec to be hardened, and further dried at 130° C. for 20 min to prepare an electrophotographic photoreceptor of the present invention, having an adhesive layer 0.5 μm thick and a surface layer 4 μm thick.

| Undercoat layer coating liquid | |
|---|---|
| Alkyd resin(BEKKOZOL 1307-60-EL from Dainippon Ink & Chemicals, Inc.) | 6 |
| Melamine resin(SUPER BEKKAMIN G-821-60 from Dainippon Ink & Chemicals, Inc.) | 4 |
| Titanium dioxide powder | 40 |
| Methyl ethyl ketone | 50 |
| CGL coating liquid | |
| Polyvinyl butyral(XYHL from Union Carbide Corp.) | 0.5 |
| Cyclohexanone | 200 |
| Methyl ethyl ketone | 80 |
| Bisazo pigment having the following formula (I): | 2.5 |

| | |
|---|---|
| | (I) |
| 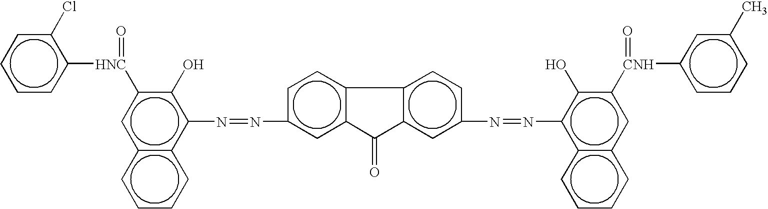 | |

| | |
|---|---|
| CTL coating liquid | |
| Bisphenol Z Polycarbonate(Panlite TS-2050 from TEIJIN CHEMICALS LTD.) | 10 |
| Tetrahydrofuran 1% tetrahydrofuran solution of silicone oil | 100 |
| (KF50-100CS from Shin-Etsu Chemical Industry Co., Ltd.) | |
| Charge transport material having the following formula (II): | 7 |

| | |
|---|---|
| | (II) |
| 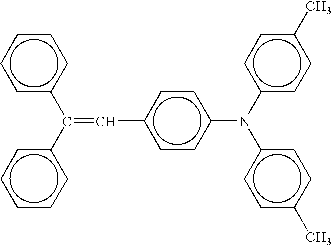 | |

| | |
|---|---|
| Adhesive layer coating liquid | |
| Bi- or more functional radical polymerizing monomer having no charge transport structure | 5 |
| 1,4-butanedioldiacrylate having 2 functional groups and a viscosity of 8 mPA · s at 25° C. | |
| (SR213 from NIPPON KAYAKU CO., LTD.) | |
| Monofunctional radical polymerizing compound having a charge transport structure | 5 |
| (Exemplified compound No. 54) | |
| Photo polymerization initiator 1-hydroxy-cyclohexyl-phenyl-ketone | 0.5 |
| having a molecular weight of 204 and no functional group | |
| (IRGACURE 184 from CIBA SPECIALTY CHEMICALS) | |
| Tetrahydrofuran | 400 |
| Surface layer coating liquid | |
| Tri- or more functional radical polymerizing monomer | 10 |
| having no charge transport structure Trimethylolpropanetriacrylate | |
| having a molecular weight of 296 and molecular weight/functional groups of 99 | |
| (KAYARAD TMPTA from NIPPON KAYAKU CO., LTD.) | |
| Monofunctional radical polymerizing compound having a charge transport structure | 10 |
| (Exemplified compound No. 54) | |
| Photo polymerization initiator 1-hydroxy-cyclohexyl-phenyl-ketone | 1 |
| having a molecular weight of 204 and no functional group | |
| (IRGACURE 184 from CIBA SPECIALTY CHEMICALS) | |
| Tetrahydrofuran | 100 |

### Example 34

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| Diethyleneglycoldiacrylate | |
| having 2 functional groups | |
| and a viscosity of 12 mPA · s at 25° C. | |
| (SR230 from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Example 35

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| Tetraethyleneglycoldiacrylate | |
| having 2 functional groups | |
| and a viscosity of 20 mPA · s at 25° C. | |
| (SR268 from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Example 36

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| Triethyleneglycoldiacrylate | |
| having 2 functional groups | |
| and a viscosity of 15 mPA · s at 25° C. | |
| (SR272 from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Example 37

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| Propoxylated neopentylglycoldiacrylate | |
| having 2 functional groups | |
| and a viscosity of 15 mPA · s at 25° C. | |
| (SR268 from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Example 38

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| n-butylacrylate having 2 functional groups | |
| and a viscosity of 0.81 mPA · s at 25° C. | |
| (from TOKYO KASEI KOGYO Co., Ltd.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Example 39

The procedure for preparation of the electrophotographic photoreceptor in Example 33 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| n-butylacrylate | |
| having 2 functional groups | |
| and a viscosity of 24 mPA · s at 25° C. | |
| (SR560 from NIPPON KAYAKU CO., LTD.) | |
| Monofunctional radical polymerizing compound | 5 |
| having a charge transport structure | |
| (Exemplified compound No. 54) | |
| Photo polymerization initiator | 0.5 |
| 1-hydroxy-cyclohexyl-phenyl-ketone | |
| having a molecular weight of 204 and no | |
| functional group (IRGACURE 184 from | |
| CIBA SPECIALTY CHEMICALS) | |
| Tetrahydrofuran | 400 |

### Comparative Example 14

The procedure for preparation of the electrophotographic photoreceptor in Example 33 was repeated to prepare an electrophotographic photoreceptor except for not coating the adhesive layer coating liquid.

Each of the photoreceptors prepared in Examples 33 to 39 and Comparative Example 14 was installed in imagio Neo 270 using a LD having a wavelength of 655 nm as a light irradiator including image information, and 100,000 S3 chart images were produced on A4-size My Paper from NBS Ricoh Co., Ltd. at an initial potential of −700 V. The abrasion property, inner potential and image quality were evaluated. The results are shown in Tables 10 to 12.

TABLE 10

Abraded Amount (μm)

| | 50,000 | 100,000 |
|---|---|---|
| Example 33 | 0.59 | 1.61 |
| Example 34 | 0.67 | 1.51 |
| Example 35 | 0.68 | 1.42 |
| Example 36 | 0.79 | 1.48 |
| Example 37 | 0.69 | 1.74 |
| Example 38 | 0.70 | 2.28 |
| Example 39 | 0.72 | 2.16 |
| Comparative Example 14 | 2.11 | 9.15 |

TABLE 11

| | Surface Potential | | | | | |
|---|---|---|---|---|---|---|
| | Initial (−V) | | 50,000 (−V) | | 100,000 (−V) | |
| | Dark | Irradiated | Dark | Irradiated | Dark | Irradiated |
| | space | part | space | part | space | part |
| Ex. 33 | 700 | 120 | 640 | 130 | 610 | 140 |
| Ex. 34 | 700 | 140 | 680 | 150 | 630 | 160 |
| Ex. 35 | 700 | 150 | 680 | 160 | 650 | 180 |
| Ex. 36 | 700 | 180 | 660 | 190 | 640 | 190 |
| Ex. 37 | 700 | 180 | 630 | 200 | 600 | 220 |
| Ex. 38 | 700 | 110 | 650 | 120 | 630 | 100 |
| Ex. 39 | 700 | 100 | 640 | 90 | 660 | 110 |
| Com. Ex. | 700 | 120 | 620 | 130 | 500 | 140 |
| 14 | | | | | | |

TABLE 12

| | Image quality | | |
|---|---|---|---|
| | Initial | 50,000 | 100,000 |
| Example 33 | ◯ | ◯ | X |
| Example 34 | ◯ | ◯ | ◯ |
| Example 35 | ◯ | ◯ | ◯ |
| Example 36 | ◯ | ◯ | ◯ |
| Example 37 | ◯ | ◯ | ◯ |
| Example 38 | ◯ | ◯ | X |
| Example 39 | ◯ | ◯ | X |
| Comparative | ◯ | X | X |
| Example 13 | | | |

⊚: very good
◯: good
Δ: stripe images are locally produced
X: stripe images are evenly produced

### Example 40

An undercoat coating liquid, a charge generation coating liquid and charge transport coating liquid, which have the following formulations, were coated and dried in this order on an aluminum cylinder having a diameter of 30 mm to form an undercoat layer 1.0 μm thick, a CGL 0.3 μm thick, a CTL 23 μm thick thereon.

The CTL was further coated with an adhesive layer coating liquid and a surface layer coating liquid having the following formulations by a spray coating method.

The coated adhesive layer coating liquid and surface layer coating liquid were irradiated by a metal halide lamp at 160 W/cm, an irradiation distance of 120 mm and an irradiation intensity of 500 mW/cm² for 120 sec to be hardened, and further dried at 130° C. for 20 min to prepare an electrophotographic photoreceptor of the present invention, having an adhesive layer 0.03 μm thick and a surface layer 4 μm thick.

| | |
|---|---|
| Undercoat layer coating liquid | |
| Titanium oxide | 40 |
| Alcohol-soluble nylon | 32 |
| Methanol | 400 |
| Isopropanol | 160 |
| CGL coating liquid | |
| Titanylphthalocyanine powder | 4 |
| Synthesized in Synthesis Example 1 | |
| Polyvinylbutyral (S-LEC BM-S from | 2 |
| Sekisui Chemical Co., Ltd.) | |
| Methyl ethyl ketone | 150 |
| CTL coating liquid | |
| Bisphenol Z Polycarbonate | 10 |
| (Panlite TS-2050 from TEIJIN CHEMICALS LTD.) | |
| Tetrahydrofuran | 100 |
| 1% tetrahydrofuran solution | |
| of silicone oil | |
| (KF50-100CS from Shin-Etsu Chemical Industry Co., Ltd.) | |
| Charge transport material | 7 |
| having the following formula (II): | |

| | |
|---|---|
| | (II) |
| 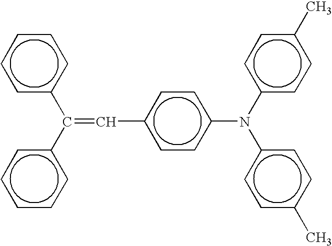 | |

| | |
|---|---|
| Adhesive layer coating liquid | |
| Bi- or more functional | 5 |
| radical polymerizing monomer | |
| having no charge transport structure | |
| 1,4-butanedioldimethacrylate | |
| having 2 functional groups | |
| and a viscosity of 7 mPA.s at 25° C. | |
| (SR214 from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 400 |
| Surface layer coating liquid | |
| Tri- or more functional | 10 |
| radical polymerizing monomer | |
| having no charge transport structure | |
| Trimethylolpropanetriacrylate | |
| having a molecular weight of 536, 5.5 functional | |
| groups and 99 molecular weight/ | |
| functional groups of 97 | |
| (KAYARAD DPHA from NIPPON KAYAKU CO., LTD.) | |
| Monofunctional radical polymerizing compound | 10 |
| having a charge transport structure | |
| (Exemplified compound No. 105) | |
| Photo polymerization initiator | 1 |
| 1-hydroxy-cyclohexyl-phenyl-ketone | |
| having a molecular weight of 204 and no functional group | |
| (IRGACURE 184 from CIBA SPECIALTY CHEMICALS) | |
| Tetrahydrofuran | 100 |

### Example 41

The procedure for preparation of the electrophotographic photoreceptor in Example 40 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| Diethyleneglycoldimethacrylate | |
| having 2 functional groups | |
| and a viscosity of 8 mPA · s at 25° C. | |
| (SR231E from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight of | |
| 204 and no functional group | |
| (IRGACURE 184 from CIBA | |
| SPECIALTY CHEMICALS) | |
| Tetrahydrofuran | 400 |

### Example 42

The procedure for preparation of the electrophotographic photoreceptor in Example 40 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| tetraethyleneglycoldimethacrylate | |
| having 2 functional groups | |
| and a viscosity of 14 mPA · s at 25° C. | |
| (SR209 from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight | |
| of 204 and no functional group | |
| (IRGACURE 184 from CIBA | |
| SPECIALTY CHEMICALS) | |
| Tetrahydrofuran | 400 |

### Example 43

The procedure for preparation of the electrophotographic photoreceptor in Example 40 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| triethyleneglycoldimethacrylate | |
| having 2 functional groups | |
| and a viscosity of 11 mPA · s at 25° C. | |
| (SR205 from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight | |
| of 204 and no functional group | |
| (IRGACURE 184 from CIBA | |
| SPECIALTY CHEMICALS) | |
| Tetrahydrofuran | 400 |

### Example 44

The procedure for preparation of the electrophotographic photoreceptor in Example 40 was repeated to prepare an electrophotographic photoreceptor except for replacing the adhesive layer with an adhesive layer having the following formulation.

| | |
|---|---|
| Bi- or more functional | 5 |
| radical polymerizing monomer | |
| having no charge transport structure | |
| neopentylglycoldimethacrylate | |
| having 2 functional groups | |
| and a viscosity of 8 mPA · s at 25° C. | |
| (SR248 from NIPPON KAYAKU CO., LTD.) | |
| Monofunctional radical polymerizing compound | 5 |
| having a charge transport structure | |
| (Exemplified compound No. 105) | |
| Photo polymerization initiator | 0.5 |
| 1-hydroxy-cyclohexyl-phenyl-ketone | |
| having a molecular weight | |
| of 204 and no functional group | |
| (IRGACURE 184 from CIBA | |
| SPECIALTY CHEMICALS) | |
| Tetrahydrofuran | 400 |

### Example 45

The procedure for preparation of the electrophotographic photoreceptor in Example 40 was repeated to prepare an electrophotographic photoreceptor except for changing the thickness of the adhesive layer to 0.05 μm.

### Example 46

The procedure for preparation of the electrophotographic photoreceptor in Example 40 was repeated to prepare an electrophotographic photoreceptor except for changing the thickness of the adhesive layer to 6 μm.

### Comparative Example 15

The procedure for preparation of the electrophotographic photoreceptor in Example 40 was repeated to prepare an electrophotographic photoreceptor except for not coating the adhesive layer coating liquid.

Each of the photoreceptors prepared in Examples 40 to 46 and Comparative Example 15 was installed in imagio Neo 270 using a LD having a wavelength of 655 nm as a light irradiator including image information, and 100,000 S3 chart images were produced on A4-size My Paper from NBS Ricoh Co., Ltd. at an initial potential of-700 V. The abrasion property, inner potential and image quality were evaluated. The results are shown in Tables 13 to 15.

TABLE 13

Abraded
Amount (μm)

| | 50,000 | 100,000 |
|---|---|---|
| Example 40 | 0.69 | 1.38 |
| Example 41 | 0.64 | 1.44 |
| Example 42 | 0.71 | 1.42 |
| Example 43 | 0.66 | 1.43 |
| Example 44 | 0.67 | 1.39 |
| Example 45 | 0.82 | 4.84 |
| Example 46 | 0.59 | 1.54 |
| Comparative Example 15 | 2.21 | 8.89 |

TABLE 14

| | Surface Potential | | | | | |
|---|---|---|---|---|---|---|
| | Initial (−V) | | 50,000 (−V) | | 100,000 (−V) | |
| | Dark | Irradiated | Dark | Irradiated | Dark | Irradiated |
| | space | part | space | part | space | Part |
| Ex. 40 | 700 | 100 | 640 | 110 | 650 | 130 |
| Ex. 41 | 700 | 110 | 660 | 100 | 640 | 120 |
| Ex. 42 | 700 | 110 | 680 | 110 | 660 | 120 |
| Ex. 43 | 700 | 120 | 670 | 120 | 630 | 140 |
| Ex. 44 | 700 | 110 | 690 | 120 | 650 | 140 |
| Ex. 45 | 700 | 110 | 680 | 110 | 670 | 130 |
| Ex. 46 | 700 | 150 | 680 | 160 | 670 | 180 |
| Com. Ex. | 700 | 110 | 620 | 120 | 520 | 140 |
| 15 | | | | | | |

TABLE 15

| | Image quality | | |
|---|---|---|---|
| | Initial | 50,000 | 100,000 |
| Example 40 | ◯ | ◯ | ◯ |
| Example 41 | ◯ | ◯ | ◯ |
| Example 42 | ◯ | ◯ | ◯ |
| Example 43 | ◯ | ◯ | ◯ |
| Example 44 | ◯ | ◯ | ◯ |
| Example 45 | ◯ | Δ | X |
| Example 46 | ◯ | ◯ | Δ |
| Comparative | ◯ | X | X |
| Example 15 | | | |

⊚: very good
◯: good
Δ: stripe images are locally produced
X: stripe images are evenly produced

The photoreceptors prepared in Examples 33 to 46 had good abrasion resistance and produced quality images even after producing 100,000 images. However, the photoreceptor prepared in Comparative Examples 14 and 15 were quickly abraded and produced images evenly having stripe images after producing 50,000 images.

This application claims priority and contains subject matter related to Japanese Patent Applications Nos. 2005-205998, 2005-198071 and 2005-198531, filed on Jul. 14, 2005, Jul. 6, 2005 and Jul. 7, 2005 respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

1. An electrophotographic photoreceptor, comprising:
an electroconductive substrate, and
a photosensitive layer comprising a tri- or more functional radical polymerizing monomer having no charge transport structure, and
a monofunctional radical polymerizing compound having a charge transport structure;
wherein the photosensitive layer comprises radical polymerizing functional groups in an amount of from 2.55×10²¹ to 7.50×10²¹ in 1 g of solid contents thereof, and has a peel strength not less than 0.1 N/mm when measured by the SAICAS method.

2. The electrophotographic photoreceptor of claim 1, wherein the charge transport structure is a member selected from the group consisting of triarylamine structures, hydrazone structures, pyrazoline structures, carbazole structures and combinations thereof.

3. The electrophotographic photoreceptor of claim 1, wherein the charge transport structure is a triarylamine structure.

4. The electrophotographic photoreceptor of claim 1, wherein the tri- or more functional radical polymerizing monomer having no charge transport structure has three or more functional groups which are members selected from the group consisting of acryloyloxy groups, methacryloyloxy groups and combinations thereof.

5. The electrophotographic photoreceptor of claim 1, further comprising:
a surface layer; and
an adhesive layer located between the photosensitive layer and the surface layer,
wherein the surface layer comprises
a tri- or more functional radical polymerizing
monomer having no charge transport structure, and
a monofunctional radical polymerizing compound having a charge transport structure.

6. The electrophotographic photoreceptor of claim 5, wherein the adhesive layer is present without an interface.

7. The electrophotographic photoreceptor of claim 5, wherein the adhesive layer comprises at least a tri- or more functional radical polymerizing monomer having no charge transport structure and a binder resin.

8. The electrophotographic photoreceptor of claim 7, wherein the tri- or more functional radical polymerizing monomer having no charge transport structure has a viscosity of from 1 to 20 mPa×s at 25° C.

9. The electrophotographic photoreceptor of claim 7, wherein the tri- or more functional radical polymerizing monomer having no charge transport structure may be bifunctional.

10. The electrophotographic photoreceptor of claim 5, wherein the adhesive layer further comprises a monofunctional radical polymerizing compound having a charge transport structure.

11. The electrophotographic photoreceptor of claim 5, wherein the photosensitive layer comprises a binder resin.

12. The electrophotographic photoreceptor of claim 5, wherein the binder resin comprises a polycarbonate resin.

13. The electrophotographic photoreceptor of claim 5, wherein the adhesive layer comprises the tri- or more functional radical polymerizing monomer having no charge transport structure and the monofunctional radical polymerizing compound having a charge transport structure in an amount of from 10 to 90% by weight based on total weight of the adhesive layer and the binder resin.

14. The electrophotographic photoreceptor of claim 5, wherein the adhesive layer has a thickness of from 0.05 to 5 μm.

15. The electrophotographic photoreceptor of claim 5,
wherein the adhesive layer has a thickness of from 0.1 to 5 μm.

16. The electrophotographic photoreceptor of claim 1, wherein the photosensitive layer further comprises titanylphthalocyanine as a charge generation material.

17. The electrophotographic photoreceptor of claim 16, wherein the titanylphthalocyanine comprises a crystal form having a Cu-Kα X-ray diffraction spectrum comprising plural diffraction peaks, and wherein main peaks are observed at a Bragg (2θ) angle of 9.6°, 24.0° and 27.2°, and wherein said angles may vary by ±0.2°.

18. The electrophotographic photoreceptor of claim 1, wherein the photosensitive layer is a single-layered photosensitive layer.

19. The electrophotographic photoreceptor of claim 1, wherein the photosensitive layer is a multilayered photosensitive layer comprising:
a charge generation layer; and
a charge transport layer located overlying the charge generation layer.

20. A method of preparing the electrophotographic photoreceptor according to claim 1, comprising:
dissolving at least the tri- or more functional radical polymerizing monomer having no charge transport structure, and the monofunctional radical polymerizing compound having a charge transport structure in a solvent having a saturated vapor pressure not higher than 100 mmHg/25° C. to prepare a coating liquid;
coating the coating liquid on the surface of the electrophotographic photoreceptor; and
polymerizing the coating liquid to form an outermost layer thereon.

21. The method of claim 20, wherein the solvent has a boiling point of from 60 to 150° C.

22. The method of claim 20, wherein the solvent has a solubility parameter of from 8.5 to 11.0.

23. The method of claim 20, wherein the solvent is a member selected from the group consisting of butylacetate, cyclohexanone and mixtures thereof.

24. The method of claim 20, further comprising:
coating an adhesive layer coating liquid on the outermost layer;
coating a surface layer coating liquid the adhesive layer; and
polymerizing the coating liquids to form the adhesive layer and the surface layer.

25. An image forming method, comprising:
charging the electrophotographic photoreceptor according to claim 1;
irradiating the electrophotographic photoreceptor to form an electrostatic latent image thereon;
developing the electrostatic latent image with a toner to form a toner image thereon; and
transferring the toner image onto a receiving material.

26. An electrophotographic image forming apparatus, comprising:
the electrophotographic photoreceptor according to claim 1;
a charger configured to charge the electrophotographic photoreceptor;
an irradiator configured to irradiate the electrophotographic photoreceptor with light to form an electrostatic latent image on the photoreceptor;
an image developer configured to develop the electrostatic latent image with a toner to form a toner image on the electrophotographic photoreceptor; and
receiving material.

27. A process cartridge detachable from an image forming apparatus, comprising:
the electrophotographic photoreceptor according to claim 1; and
at least one member selected from the group consisting of a charger, an image developer, a transferer, a cleaner and a discharger.
